(19) United States
(12) Patent Application Publication
(10) Pub. No.: US 2024/0370001 A1
(43) Pub. Date: Nov. 7, 2024

(54) SYSTEMS AND METHODS FOR BATCH SYNCHRONIZATION IN INDUSTRIAL BATCH ANALYTICS

(71) Applicant: ROCKWELL AUTOMATION TECHNOLOGIES, INC., Mayfield Heights, OH (US)

(72) Inventors: Meiling He, Shorewood, WI (US); Justice Darko, Greensboro, NC (US); Dennis J. Luo, Germantown, WI (US); Jay W. Schiele, Union Grove, WI (US); Fatime Ly Seymour, Mocksville, NC (US); Francisco P. Maturana, Lyndhurst, OH (US)

(21) Appl. No.: 18/457,466

(22) Filed: Aug. 29, 2023

Related U.S. Application Data
(63) Continuation-in-part of application No. 18/308,234, filed on Apr. 27, 2023.
(60) Provisional application No. 63/505,579, filed on Jun. 1, 2023.

(51) Int. Cl. G05B 19/418

(52) U.S. Cl. CPC G05B 19/41875; G05B 2219/32077

(57) ABSTRACT

An illustrative method includes a batch analytic system receiving batch data of a batch generated in an industrial process, wherein the batch data includes a set of samples associated with the batch, the batch is complete and has a first batch length, determining a reference batch based on a plurality of non-anomalous batches generated in the industrial process, wherein each non-anomalous batch has a same second batch length, generating a batch representation of the batch based on the batch data of the batch and the reference batch, wherein the batch representation of the batch aligns with the reference batch and has the second batch length associated with the reference batch, and performing an operation using the batch representation of the batch.

### CROSS-REFERENCE TO RELATED APPLICATIONS

This application is a continuation in part of, and claims priority to, U.S. patent application Ser. No. 18/308,234, filed on Apr. 27, 2023, and entitled “SYSTEMS AND METHODS FOR ANOMALY DETECTION IN INDUSTRIAL BATCH ANALYTICS,” which is incorporated by reference herein in its entirety.

This application also claims priority to U.S. Provisional Application Ser. No. 63/505,579, filed on Jun. 1, 2023, and entitled “SYSTEMS AND METHODS FOR BATCH SYNCHRONIZATION IN INDUSTRIAL BATCH ANALYTICS”, which is incorporated by reference herein in its entirety.

### BACKGROUND

The present disclosure relates to batch analytics. In a more particular example, the disclosure relates to technologies for synchronizing multiple batches in industrial batch analytics.

### BRIEF DESCRIPTION

The following presents a simplified summary in order to provide a basic understanding of some aspects described herein. This summary is not an extensive overview nor is intended to identify key/critical elements or to delineate the scope of the various aspects described herein. The sole purpose of this summary is to present some concepts in a simplified form as a prelude to the more detailed description that is presented later.

In some embodiments, a method is provided. The method comprises receiving, by a batch analytic system, batch data of a batch generated in an industrial process, wherein the batch data includes a set of samples associated with the batch, the batch is complete and has a first batch length; determining, by the batch analytic system, a reference batch based on a plurality of non-anomalous batches generated in the industrial process, wherein each non-anomalous batch has a same second batch length; generating, by the batch analytic system, a batch representation of the batch based on the batch data of the batch and the reference batch, wherein the batch representation of the batch aligns with the reference batch and has the second batch length associated with the reference batch; and performing, by the batch analytic system, an operation using the batch representation of the batch.

In some embodiments, a method is provided. The method comprises receiving, by a batch analytic system, batch data of a batch generated in an industrial process, wherein the batch is ongoing and has a first batch length at a sample point during the batch, the batch data includes a set of samples associated with the batch at the sample point; generating, by the batch analytic system based on the batch data of the batch and a reference batch that has a second batch length, a batch representation corresponding to the sample point of the batch using a first Dynamic Time Warping (DTW) matrix and a second DTW matrix, wherein the second DTW matrix is determined based on the first DTW matrix, and the batch representation corresponding to the sample point of the batch aligns with a batch portion of the reference batch and has a third batch length associated with the batch portion of the reference batch; and performing, by the batch analytic system, an operation using the batch representation corresponding to the sample point of the batch.

In some embodiments, a system is provided. The system comprises a memory storing instructions; and a processor communicatively coupled to the memory and configured to execute the instructions to: receive batch data of a batch generated in an industrial process, wherein the batch data includes a set of samples associated with the batch, the batch is complete and has a first batch length; determine a reference batch based on a plurality of non-anomalous batches generated in the industrial process, wherein each non-anomalous batch has a same second batch length; generate a batch representation of the batch based on the batch data of the batch and the reference batch, wherein the batch representation of the batch aligns with the reference batch and has the second batch length associated with the reference batch; and perform an operation using the batch representation of the batch.

To the accomplishment of the foregoing and related ends, certain illustrative aspects are described herein in connection with the following description and the accompanying drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an example system that manages industrial data.

FIG. 2 illustrates an example anomaly detection system.

FIG. 3 illustrates an example anomaly detection method.

FIG. 4 illustrates an example of non-anomalous batches, an input matrix associated with the non-anomalous batches, and an input matrix associated with the non-anomalous batches that corresponds to a sample point.

FIG. 5 illustrates an example principal component space of a principal component analysis (PCA) model.

FIG. 6 illustrates an example training system for training a machine learning model.

FIG. 7 illustrates an example method for training a machine learning model.

FIG. 8 illustrates an example user interface that provides a visual representation of an anomaly metric for a batch.

FIG. 9 illustrates an example batch analytic system.

FIG. 10 illustrates an example batch synchronization method for a batch that is complete.

FIG. 11 illustrates an example Dynamic Time Warping operation, an example DTW matrix, and an example warping path.

FIG. 12 illustrates an example of determining a batch representation of a batch.

FIG. 13 illustrates an example batch synchronization method for a batch that is ongoing.

FIG. 14 illustrates examples of various DTW matrices.

FIG. 15 illustrates another example batch synchronization method for a batch that is complete.

FIG. 16 illustrates other examples of determining a batch representation of a batch.

FIG. 17 illustrates an example computing environment.

FIG. 18 illustrates an example networking environment.

### DETAILED DESCRIPTION

The present disclosure is now described with reference to the drawings. In the following description, specific details may be set forth for purposes of explanation. It should be understood that the present disclosure may be implemented without these specific details.

As used herein, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities may be hardware, a combination of hardware and software, software, or software in execution. For example, a component may be, but is not limited to being, a process running on a processor, a processor, a hard disk drive, multiple storage drives (of optical or magnetic storage medium) including affixed (e.g., screwed or bolted) or removable affixed solid-state storage drives, an object, an executable object, a thread of execution, a computer-executable program, and/or a computer. By way of illustration, both an application running on a server and the server may be a component. One or more components may reside within a process and/or thread of execution, and a component may be localized on one computer and/or distributed between two or more computers.

In addition, components as described herein may execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component may be an apparatus with specific functionality provided by mechanical parts operated by electric or electronic circuitry which is operated by a software or a firmware application executed by a processor, wherein the processor may be internal or external to the apparatus and may execute at least a part of the software or firmware application. As yet another example, a component may be an apparatus that provides specific functionality through electronic components without mechanical parts, the electronic components may include a processor therein to execute software or firmware that provides at least in part the functionality of the electronic components. As yet another example, interface(s) may include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” generally refer to the process of reasoning about or inferring states of the system, environment, and/or user from a set of observations as captured via events and/or data. For example, inference may be used to identify a specific context or action, or may generate a probability distribution over states. The inference may be probabilistic, e.g., the inference may be the computation of a probability distribution over states of interest based on a consideration of data and events. Inference may also refer to techniques employed for composing higher-level events from a set of events and/or data. Such inference may result in the construction of new events or actions from a set of observed events and/or stored event data, regardless of whether or not the events are correlated in close temporal proximity, and whether the events and data come from one or several event and data sources.

Moreover, the term “or” is intended to mean an inclusive “or” rather than an exclusive “or.” In particular, unless clear from the context or specified otherwise, the phrase “X employs A or B” is intended to mean any of the natural inclusive permutations. Thus, the phrase “X employs A or B” is satisfied by any of the following instances: X employs A, X employs B, or X employs both A and B. In addition, the articles “a” and “an” as used in this present disclosure and the appended claims should generally be construed to mean “one or more” unless clear from the context or specified otherwise to be directed to a singular form.

Furthermore, the term “set” as used herein excludes the empty set, e.g., the set with no elements therein. Thus, a “set” in the present disclosure may include one or more elements or entities. For example, a set of controllers may include one or more controllers, a set of data resources may include one or more data resources, etc. Similarly, the term “group” as used herein refers to a collection of one or more entities. For example, a group of nodes refers to one or more nodes.

Various aspects or features will be presented in terms of systems that may include a number of devices, components, modules, and the like. It should be understood that various systems may include additional devices, components, modules, etc. and/or may not include all of the devices, components, modules, etc. that are discussed with reference to the figures. A combination of these approaches may also be used.

Systems and methods for anomaly detection in industrial batch analytics are described herein. In batch production, an industrial process such as a manufacturing process of a product may generate the product in multiple batches. For each batch generated in the industrial process, batch data may be collected and analyzed to determine whether the batch is anomalous. To determine whether the batch is anomalous, some systems may rely on one or more established metrics that are commonly used in anomaly detection. The systems may compute the established metrics for the batch based on the batch data, and determine whether the batch is anomalous based on the established metrics of the batch. However, determining whether the batch is anomalous based on the established metrics often results in a high number of detection results that are false positive or false negative. A detection result that is false positive where an anomaly is incorrectly detected may cause the industrial process to be stopped unnecessarily, thereby causing production loss. On the other hand, a detection result that is false negative where an anomaly goes unnoticed may result in products generated in the batch being unqualified and therefore unusable. Thus, the anomaly detection using the established metrics of the batch is generally unreliable due to its inconsistent accuracy.

Systems and methods described herein are capable of accurately performing anomaly detection for a batch using an anomaly metric that is determined based on a plurality of statistical metrics of the batch. For example, for a batch generated an industrial process, the systems and methods may determine a T²-statistic metric and a Q-statistic metric of the batch in a Principal Component Analysis (PCA) model associated with the industrial process. The systems and methods may then determine the anomaly metric of the batch based on both the T²-statistic metric and the Q-statistic metric of the batch in the PCA model. For example, the systems and methods may compute a normalized T²-statistic metric based on the T²-statistic metric of the batch, compute a normalized Q-statistic metric based on the Q-statistic metric of the batch, and determine the anomaly metric of the batch to be a highest value between the normalized T²-statistic metric and the normalized Q-statistic metric.

The systems and methods described herein may determine whether the batch is anomalous based on the anomaly metric of the batch. For example, the systems and methods may determine that the anomaly metric of the batch satisfies an anomaly detection threshold, and therefore determine that the batch is anomalous. In response to determining that the batch is anomalous, the systems and methods may perform a corresponding operation. For example, the systems and methods may present to a process operator of the industrial process a notification indicating that the batch is anomalous. Additionally or alternatively, the systems and methods may identify, from various process variables of the industrial process, one or more process variables that contribute significantly to the batch being anomalous, and present the one or more process variables and their contribution towards the batch performance to the process operator. Additionally or alternatively, the systems and methods may automatically adjust these process variables of the industrial process to address the anomaly of the batch. Other operations may also be performed in response to determining that the batch is anomalous.

Systems and methods described herein may be advantageous in a number of technical respects. For example, as described herein, the systems and methods may compute the normalized T²-statistic metric of the batch based on the T²-statistic metric of the batch and a confidence limit of the T²-statistic metric. The systems and methods may also compute the normalized Q-statistic metric of the batch based on the Q-statistic metric of the batch and a confidence limit of the Q-statistic metric. The normalization of the T²-statistic metric and the Q-statistic metric may result in the normalized T²-statistic metric and the normalized Q-statistic metric of the batch being in the same scale and therefore can be compared to one another. As described herein, the systems and methods may determine the anomaly metric of the batch to be the highest value between the normalized T²-statistic metric and the normalized Q-statistic metric. Thus, for each batch of the industrial process, the systems and methods may dynamically select a normalized statistical metric that better indicates a conformity level of the batch with the PCA model to be the anomaly metric of the batch. As described herein, the PCA model may be created based on one or more non-anomalous batches generated in the industrial process. Thus, by using the anomaly metric of the batch that better indicates the conformity level of the batch with the PCA model, the accuracy in detecting anomaly for the batch may be improved.

In addition, the systems and methods may determine whether the anomaly metric of the batch satisfies an anomaly detection threshold. If the anomaly metric of the batch satisfies the anomaly detection threshold (e.g., the anomaly metric exceeds the anomaly detection threshold), the systems and methods may determine that the batch is anomalous. As described herein, the systems and methods may determine the anomaly detection threshold using a machine learning model. For example, the systems and methods may apply the machine learning model to one or more batches of the industrial process to identify, among a plurality of candidate anomaly detection thresholds, a candidate anomaly detection threshold that results in a lowest false detection rate when being used to detect anomaly for the one or more batches. The systems and methods may then select the candidate anomaly detection threshold to be the anomaly detection threshold. Thus, by using the anomaly detection threshold that results in the lowest false detection rate in anomaly detection, the accuracy in detecting anomaly for a batch using the anomaly detection threshold may be improved.

Moreover, the systems and methods may detect anomaly not only for a batch that is already finished but also for a batch that is ongoing. As described herein, for a batch that is ongoing and not yet complete, the systems and methods may determine an anomaly metric corresponding to a sample point during the batch using a PCA model of the industrial process corresponding to the sample point. The anomaly metric of the batch that corresponds to the sample point may also be referred to as the anomaly metric of the batch at the sample point. As described herein, the systems and methods may determine whether the anomaly metric of the batch at the sample point satisfies the anomaly detection threshold. If the anomaly metric of the batch at the sample point satisfies the anomaly detection threshold (e.g., the anomaly metric exceeds the anomaly detection threshold), the systems and methods may determine that the batch is anomalous at the sample point. In other words, the systems and methods may determine that a portion of the batch that is generated from a start point of the batch up to the sample point during the batch is anomalous.

As described herein, the systems and methods may generate a visual presentation of the anomaly metric for the batch based on the anomaly metric of the batch at different sample points as the batch proceeds in real-time. The systems and methods may present the visual presentation of the anomaly metric for the batch to the process operator of the industrial process. This implementation is advantageous, because it facilitates the process operator in monitoring the anomaly metric of the batch while the batch is ongoing.

As described herein, the systems and methods may also determine one or more process variables of the industrial process that contribute significantly to the anomaly metric of the batch at a particular sample point, and present to the process operator the one or more process variables and their contribution to the anomaly metric of the batch at the particular sample point. Thus, when the systems and methods determine that the batch is anomalous at the particular sample point, the process operator may reference the one or more process variables and their contribution to the anomaly metric of the batch at the particular sample point and adjust the industrial process accordingly. For example, the process operator may adjust a process variable among the one or more process variables of the industrial process to address the anomaly of the batch. As described herein, for each process variable among the one or more process variables, the systems and methods may provide an average value of the process variable in one or more non-anomalous batches of the industrial process to the process operator, thereby facilitating the process operator in adjusting the process variable to address the anomaly of the batch. Additionally or alternatively, when determining that the batch is anomalous at the particular sample point, the systems and methods may provide a recommendation to terminate the particular batch in advance, for example, due to a long time window between a start point of the batch and the particular sample point. In this case, the process operator may consider the recommendation and decide to dispose of the batch. Accordingly, the process operator may terminate the batch before the batch is complete to avoid further wasting production resources on the batch that is not being used.

As described herein, the systems and methods may evaluate the one or more process variables and their contribution to the anomaly metric of the batch at the particular sample point and/or evaluate the time window between the start point of the batch and the particular sample point, and automatically address the anomaly of the batch or terminate the batch based on such evaluation. This implementation is advantageous, because it enables an automatic response to the batch being detected as anomalous without human intervention.

Various illustrative embodiments will now be described in detail with reference to the figures. It should be understood that the illustrative embodiments described below are provided as examples and that other examples not explicitly described herein may also be captured by the scope of the claims set forth below. The systems and methods described herein may provide any of the benefits mentioned above, as well as various additional and/or alternative benefits that will be described and/or made apparent below.

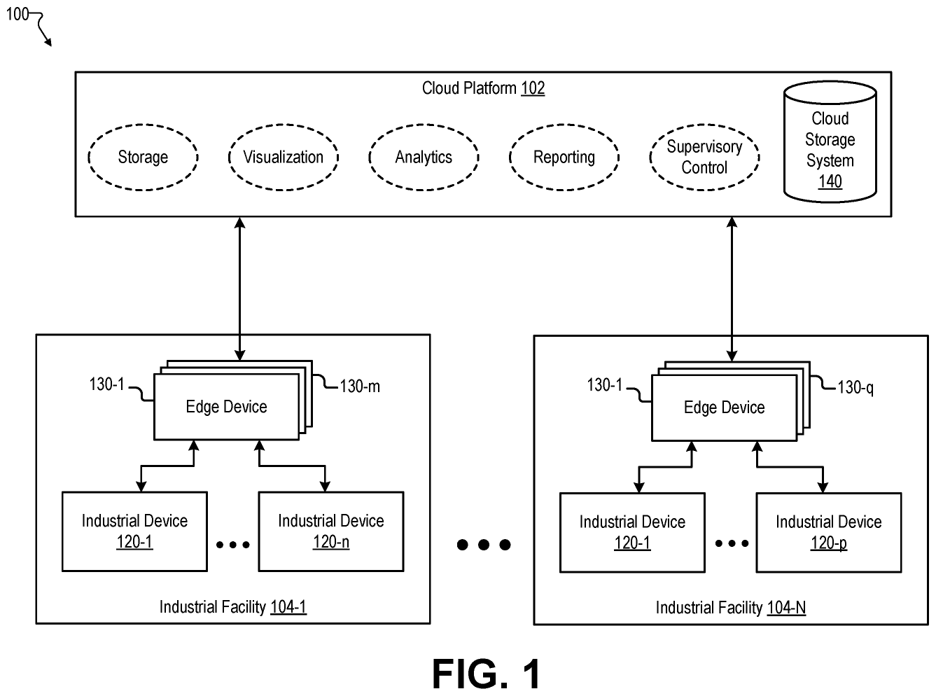

FIG. 1 illustrates an example system 100 for managing industrial data generated by one or more industrial automation systems. As depicted in FIG. 1, the system 100 may include a cloud platform 102 and one or more industrial facilities 104 of an industrial enterprise. The industrial facilities 104 may include one or more industrial devices 120 and one or more edge devices 130 as depicted in FIG. 1.

In some embodiments, the industrial devices 120 may perform various operations and/or functionalities within an industrial environment. Non-limiting examples of an industrial device 120 may include, but are not limited to, an industrial controller (e.g., programmable automation controller such as programmable logic controller (PLC), etc.), a field device (e.g., a sensor, a meter, an Internet of Things (IoT) device, etc.), a motion control device (e.g., a motor drive, etc.), an operator interface device (e.g., a human-machine interface device, an industrial monitor, a graphic terminal, a message display device, etc.), an industrial automated machine (e.g., an industrial robot, etc.), a lot control system (e.g., a barcode marker, a barcode reader, etc.), a vision system device (e.g., a vision camera, etc.), a safety relay, an optical safety system, and/or other types of industrial devices. In some embodiments, an industrial device 120 may be positioned at a fixed location within the industrial facility 104. Alternatively, the industrial device 120 may be part of a mobile control system such as a control system implemented in a truck or in a service vehicle.

In some embodiments, the industrial devices 120 in one or more industrial facilities 104 may form one or more industrial automation systems. Non-limiting examples of the industrial automation system may include, but are not limited to, a batch control system (e.g., a mixing system, etc.), a continuous control system (e.g., a proportional integral derivative (PID) control systems, etc.), a discrete control system, and/or other types of industrial automation systems. In some embodiments, the industrial automation system may perform one or more industrial processes that are related to product manufacturing, material handling, and/or other industrial operations within the industrial facilities 104.

In some embodiments, the industrial controllers in the industrial automation system may facilitate the monitoring and/or control of an industrial process performed by the industrial automation system. For example, the industrial controllers may communicate with the field devices using native hardwired I/O or via a plant network (e.g., Ethernet/IP, Data Highway Plus, ControlNet, DeviceNet, etc.) and receive digital and/or analog signals from the field devices. The received signals may indicate a current state of the field devices and/or a current state (e.g., a temperature, a position, a part presence or absence, a fluid level, etc.) of the industrial process performed by the industrial automation system. In some embodiments, the industrial controllers may execute a control program that performs automated decision-making for the industrial process based on the received signals. The industrial controllers may then output corresponding digital and/or analog control signals to the field devices in accordance with the decisions made by the control program. For example, the output signals may include a device actuation signal, a temperature control signal, a position control signal, an operational command to a machining or material handling robot, a mixer control signal, a motion control signal, and/or other types of output signals. In some embodiments, the control program may include any suitable type of code to process input signals provided to the industrial controller and to control output signals generated by the industrial controller. For example, the control program may include ladder logic, sequential function charts, function block diagrams, structured text, and/or other programming structures.

In some embodiments, the edge devices 130 may collect industrial data from the industrial devices 120 and/or from other data sources (e.g., a local data store, an on-premises processing system, etc.) and transmit the data to the cloud platform 102 for storage and/or processing. For example, the edge devices 130 may collect the data from the industrial devices 120 and/or from other data sources at a predefined interval (e.g., every 3 s) and transmit the collected data to the cloud platform 102. In some embodiments, an edge device 130 may be located within an industrial facility 104 as an on-premises device that facilitates data communication between the industrial devices 120 in the industrial facility 104 and the cloud platform 102.

In some embodiments, the cloud platform 102 may provide various cloud-based services for the industrial automation systems implemented in the industrial facilities 104 of the industrial enterprise. As depicted in FIG. 1, non-limiting examples of the cloud-based services may include, but are not limited to, data storage, visualization, data analytics, reporting, supervisory control, and/or other types of cloud-based services. In some embodiments, the cloud platform 102 may be a public cloud in which the cloud-based services are provided by a cloud service provider and accessible through a public network (e.g., the Internet) upon subscription to the cloud-based services. Alternatively, the cloud platform 102 may be a semi-private cloud in a shared cloud environment or in a corporate cloud environment. Alternatively, the cloud platform 102 may be a private cloud that is operated internally by the industrial enterprise. For example, the private cloud may include one or more computing devices (e.g., physical or virtual servers) that host the cloud-based services and reside within a corporate network protected by a firewall.

In some embodiments, the cloud platform 102 may implement one or more applications and/or storage systems to provide the cloud-based services. For example, the cloud platform 102 may implement a cloud storage system 140 to which data may be ingested for data storage and data analytics. As another example, the cloud platform 102 may implement a control application that performs remote decision-making for an industrial automation system. The control application may generate one or more control commands based on real-time data that is collected from the industrial automation system and transmitted to the cloud platform 102, and issue the control commands to the industrial automation system. As another example, the cloud platform 102 may implement a lot control application that tracks a product unit throughout various stages of production and collects production data (e.g., a barcode identifier, an abnormal flag, production statistics, quality test data, etc.) as the product unit passes through each stage. The cloud platform 102 may also implement a visualization application (e.g., a cloud-based Human Machine Interface (HMI)), a reporting application, an Enterprise Resource Planning (ERP) application, and/or other applications to provide corresponding cloud-based services to one or more industrial automation systems implemented by the industrial enterprise.

In some embodiments, the cloud-based services provided by the cloud platform 102 may facilitate various operations of the industrial automation systems implemented by the industrial enterprise. For example, the cloud-based storage provided by the cloud platform 102 may be dynamically scaled to accommodate a massive amount of data continuously generated by the industrial devices 120 of the industrial automation systems. As another example, the industrial facilities 104 that are located at different geographical locations may transmit data generated by their industrial automation systems to the cloud platform 102 for aggregation, collective analysis, visualization, and/or enterprise-level reporting without the need to establish one or more private networks between the industrial facilities 104. As another example, a diagnostic application implemented on the cloud platform 102 may monitor a working condition of various industrial automation systems and/or various industrial devices 120 included in the industrial automation systems across a particular industrial facility 104, or across multiple industrial facilities 104 of the industrial enterprise. In some embodiments, the cloud platform 102 may also provide software as a service, thereby alleviating the burden of software maintenance, software upgrade, and/or software backup for various software applications implemented in the industrial automation systems.

In some embodiments, an industrial automation system may perform an industrial process in an industrial facility 104 of the industrial enterprise. The industrial process may be a process that generates one or more batches of product. For example, the industrial process may be a manufacturing process of penicillin in a bioreactor. In some embodiments, the industrial process may be associated with one or more process variables. The process variables may indicate a manufacturing condition in which the batches are generated in the industrial process. For example, in the industrial process that manufactures penicillin, the process variables may include a substrate flow rate, a cooling water flow rate, a temperature, a pH level, an off-gas CO₂ level, an off-gas O₂ level, an aeration rate, an agitator rate, etc. Other examples of the industrial process and the process variables of the industrial process are also possible and contemplated.

In some embodiments, for each batch generated in the industrial process, the system 100 may collect batch data of the batch. The batch data may include one or more samples collected at a predefined interval (e.g., every 3 s) during the batch. Each sample may be collected at a sample point during the batch and may include values of various process variables of the industrial process at the sample point. In some embodiments, to collect a sample of the batch at a sample point, one or more edge devices 130 may obtain values of various process variables of the industrial process at the sample point from one or more industrial devices 120 (e.g., a sensor, a field device, an IoT device, etc.) included in the industrial process that generates the batch. The edge devices 130 may then aggregate the values of the process variables in a predefined order to form the sample of the batch, and transmit the sample of the batch to the cloud platform 102. Thus, the batch data may include one or more samples collected at one or more sample points during the batch. In some embodiments, the batch data may be analyzed by an anomaly detection system to determine whether the batch is anomalous. In some embodiments, the batch data may be collected and analyzed as the batch proceeds in real-time. Additionally or alternatively, the batch data may be collected as the batch proceeds in real-time and may be analyzed after the batch is complete (e.g., during an off-peak time window).

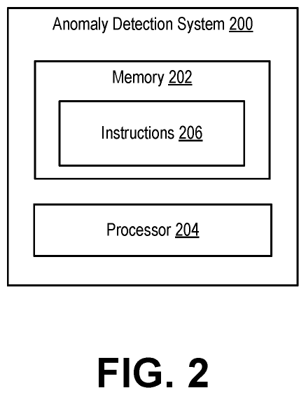

FIG. 2 illustrates an example anomaly detection system 200 for analyzing batch data of a batch generated in an industrial process and determining whether the batch is anomalous. In some embodiments, the anomaly detection system 200 may be implemented by computing resources such as servers, processors, memory devices, storage devices, communication interfaces, and/or other computing resources. In some embodiments, the anomaly detection system 200 may be implemented at the edge device 130, the cloud platform 102, and/or other components of the system 100. In some embodiments, various components of the system 100 may collaborate with one another to perform one or more functionalities of the anomaly detection system 200 described herein.

As depicted in FIG. 2, the anomaly detection system 200 may include, without limitation, a memory 202 and a processor 204 communicatively coupled to one another. The memory 202 and the processor 204 may each include or be implemented by computer hardware that is configured to store and/or execute computer software. Other components of computer hardware and/or software not explicitly shown in FIG. 2 may also be included within the anomaly detection system 200. In some embodiments, the memory 202 and the processor 204 may be distributed between multiple devices and/or multiple locations as may serve a particular implementation.

The memory 202 may store and/or otherwise maintain executable data used by the processor 204 to perform one or more functionalities of the anomaly detection system 200 described herein. For example, the memory 202 may store instructions 206 that may be executed by the processor 204. In some embodiments, the memory 202 may be implemented by one or more memory or storage devices, including any memory or storage devices described herein, that are configured to store data in a transitory or non-transitory manner. In some embodiments, the instructions 206 may be executed by the processor 204 to cause the anomaly detection system 200 to perform one or more functionalities described herein. The instructions 206 may be implemented by any suitable application, software, code, and/or other executable data instance. Additionally, the memory 202 may also maintain any other data accessed, managed, used, and/or transmitted by the processor 204 in a particular implementation.

The processor 204 may be implemented by one or more computer processing devices, including general purpose processors (e.g., central processing units (CPUs), graphics processing units (GPUs), microprocessors, etc.), special purpose processors (e.g., application specific integrated circuits (ASICs), field-programmable gate arrays (FPGAs), etc.), or the like. The anomaly detection system 200 may use the processor 204 (e.g., when the processor 204 is directed to perform operations represented by instructions 206 stored in the memory 202) and perform various functionalities associated with anomaly detection for a batch in any manner described herein or as may serve a particular implementation.

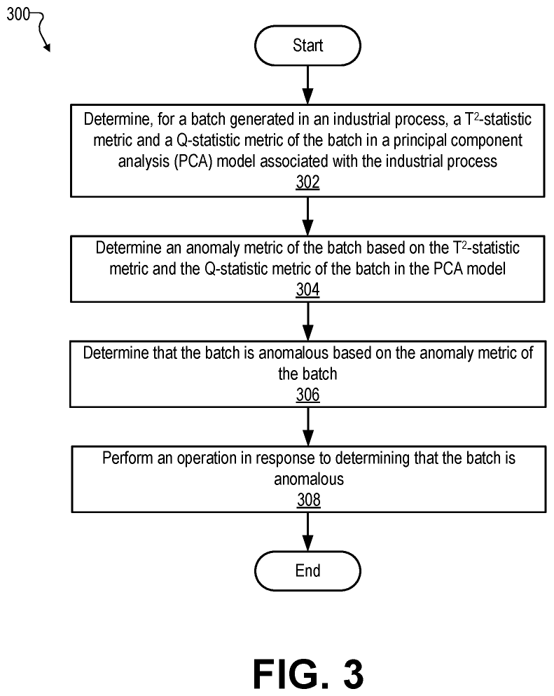

FIG. 3 illustrates an example anomaly detection method 300 (e.g., the method 300) for performing anomaly detection for a batch generated in an industrial process. While FIG. 3 shows illustrative operations according to one embodiment, other embodiments may omit, add to, reorder, and/or modify any of the operations shown in FIG. 3. In some examples, multiple operations shown in FIG. 3 or described in relation to FIG. 3 may be performed concurrently (e.g., in parallel) with one another, rather than being performed sequentially as illustrated and/or described. One or more of the operations shown in FIG. 3 may be performed by an anomaly detection system such as the anomaly detection system 200 and/or any implementation thereof.

At operation 302, the anomaly detection system 200 may determine, for a batch generated in an industrial process, a T²-statistic metric and a Q-statistic metric of the batch in a Principal Component Analysis (PCA) model associated with the industrial process. The PCA model may be created based on one or more non-anomalous batches generated in the industrial process in which each non-anomalous batch is verified to not include any anomaly throughout its batch duration. In some embodiments, if the batch is already complete, the anomaly detection system 200 may use a PCA model associated with the industrial process that corresponds to an entire batch. In some embodiments, if the batch is ongoing and not yet complete, the anomaly detection system 200 may use a PCA model associated with the industrial process that corresponds to a particular sample point in the batch duration.

At operation 304, the anomaly detection system 200 may determine an anomaly metric of the batch based on the T²-statistic metric and the Q-statistic metric of the batch in the PCA model. For example, the anomaly detection system 200 may compute a normalized T²-statistic metric of the batch based on the T²-statistic metric of the batch and a confidence limit of the T²-statistic metric. The anomaly detection system 200 may compute a normalized Q-statistic metric of the batch based on the Q-statistic metric of the batch and a confidence limit of the Q-statistic metric. The anomaly detection system 200 may then compare the normalized T²-statistic metric and the normalized Q-statistic metric of the batch, and determine the anomaly metric of the batch based on such comparison. For example, the anomaly detection system 200 may determine the anomaly metric of the batch to be a highest value between the normalized T²-statistic metric and the normalized Q-statistic metric of the batch.

At operation 306, the anomaly detection system 200 may determine that the batch is anomalous based on the anomaly metric of the batch. For example, the anomaly detection system 200 may determine that the anomaly metric of the batch satisfies an anomaly detection threshold (e.g., the anomaly metric exceeds the anomaly detection threshold), and therefore determine that the batch is anomalous. In some embodiments, the anomaly detection threshold may be a predefined threshold value (e.g., 1). Additionally or alternatively, the anomaly detection threshold may be determined using a machine learning model.

At operation 308, the anomaly detection system 200 may perform an operation in response to determining that the batch is anomalous. For example, the anomaly detection system 200 may present to a process operator of the industrial process a notification indicating that the batch is anomalous. As another example, the batch may be ongoing and the anomaly detection system 200 may identify, from various process variables of the industrial process, one or more process variables that contribute significantly to the batch being anomalous. The anomaly detection system 200 may then present the one or more process variables and their contribution towards the batch performance to the process operator to facilitate the process operator in addressing the anomaly of the batch. Additionally or alternatively, the anomaly detection system 200 may automatically adjust the one or more process variables based on their average value in one or more non-anomalous batches of the industrial process to address the anomaly of the batch. The anomaly detection system 200 may also perform other operations in response to determining that the batch is anomalous.

Thus, the anomaly detection system 200 may perform the anomaly detection for the batch generated in the industrial process. As described herein, the industrial process may generate one or more batches. In some embodiments, each batch may extend for a predefined batch duration from a start point of the batch to an end point of the batch. If the batch reached its end point, the industrial process may already generate the entire batch and the batch may be considered complete or finished. On the other hand, if the industrial process is still generating the batch and the batch has not reached its end point, the batch may be considered ongoing or in progress.

As described herein, the system 100 may collect multiple samples at a predefined interval (e.g., every 3 s) during the batch. Each sample may be collected at a sample point during the batch and may include values of various process variables of the industrial process at the sample point. In some embodiments, each sample point may be considered a reference point in the batch duration and may indicate a point in time at which a particular sample of a batch is collected relative to a start point of that batch. For example, the system 100 may collect K samples (e.g., 1150 samples) at the predefined interval (e.g., every 3 s) during each batch. Thus, the batch data of each batch may include K samples (e.g., 1150 samples) respectively collected at K sample points (e.g., 1150 sample points) within the batch duration of that batch. Accordingly, at a sample point k during a first batch, a sample k^{th} of the first batch may be collected. Similarly, at the sample point k during a second batch, a sample k^{th} of the second batch may be collected. A time distance between the sample point k during the first batch and the start point of the first batch may be equal to a time distance between the sample point k during the second batch and the start point of the second batch.

As described herein, the anomaly detection system 200 may perform anomaly detection for the batch using a PCA model associated with the industrial process. In some embodiments, the industrial process may have multiple PCA models, each PCA model may correspond to a sample point within the batch duration. Thus, for the industrial process in which K samples (e.g., 1150 samples) are respectively collected at K sample points for each batch, the anomaly detection system 200 may generate K PCA models (e.g., 1150 PCA models) corresponding to K sample points. Among K PCA models, a PCA model corresponding to sample point K may be considered the PCA model corresponding to entire batch, because the sample point K is the last sample point in the batch duration by which all K samples of a batch are collected. In some embodiments, to evaluate the anomaly for a batch that is complete, the anomaly detection system 200 may use the PCA model corresponding to entire batch among K PCA models (e.g., 1150 PCA models) of the industrial process. On the other hand, to evaluate the anomaly for an ongoing batch at a sample point k during the batch, the anomaly detection system 200 may use a PCA model corresponding to sample point k among K PCA models (e.g., 1150 PCA models) of the industrial process. In some embodiments, the anomaly detection system 200 may generate K PCA models (e.g., 1150 PCA models) for the industrial process in advance, and store these PCA models in a data storage (e.g., a local data storage and/or the cloud storage system 140).

As described herein, the anomaly detection system 200 may generate the PCA models for the industrial process based on one or more non-anomalous batches of the industrial process in which each non-anomalous batch is verified to not include any anomaly throughout its batch duration. In some embodiments, to create a PCA model, the anomaly detection system 200 may generate an input matrix corresponding to the PCA model from one or more samples in each non-anomalous batch, and create the PCA model based on the input matrix.

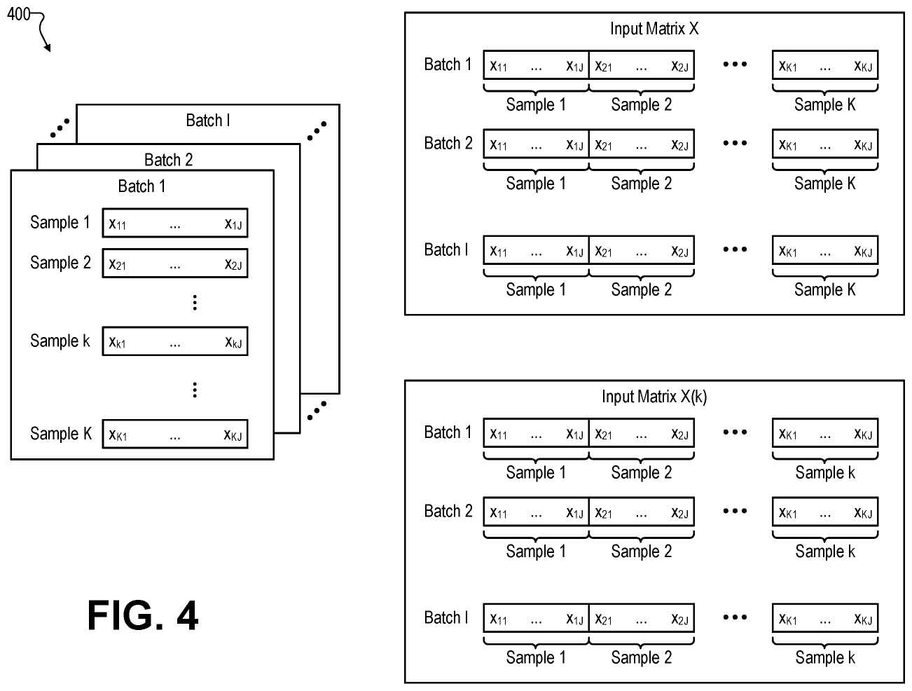

To illustrate, FIG. 4 shows a diagram 400 illustrating non-anomalous batches, an input matrix X corresponding to an entire batch, and an input matrix X(k) corresponding to a sample point k in the batch duration. As depicted in FIG. 4, the anomaly detection system 200 may use I non-anomalous batches (e.g., batch 1 to batch I) to generate the PCA models for the industrial process. Each non-anomalous batch may include K samples (e.g., sample 1 to sample K) that are respectively collected at K sample points (e.g., sample point 1 to sample point K, not shown) during the non-anomalous batch. Each sample in the non-anomalous batch may be collected at a sample point during the non-anomalous batch and may include J values of J process variables of the industrial process that are obtained at the sample point.

In some embodiments, the anomaly detection system 200 may generate the input matrix X corresponding to an entire batch and use the input matrix X to create the PCA model corresponding to entire batch for the industrial process. To generate the input matrix X, for each non-anomalous batch in I non-anomalous batches, the anomaly detection system 200 may aggregate K samples of the non-anomalous batch in a chronological order of their sample points to form one row of the input matrix X as depicted in FIG. 4. Accordingly, each row in the input matrix X may represent an entire non-anomalous batch and may include all K samples collected during the non-anomalous batch. As described herein, each sample of the non-anomalous batch may include J values of J process variables of the industrial process. Thus, the input matrix X may have the following dimensions:

$$X ∈ {M}_{I \times ( J * K )}$$

In some embodiments, the input matrix X may be subjected to an autoscaling operation (e.g., standardization transformation). The autoscaling operation may be performed for each column of the input matrix X and may move a center of a data cloud representing the elements in the column of the input matrix X to their mean value and normalize the elements in the column of the input matrix X. As a result of the autoscaling operation, for each column of the input matrix X, the elements in the column may center around their mean value and may have a unit variance (e.g., the standard deviation of 1). Accordingly, the dominance impact of the elements in the column of the input matrix X that are in large value ranges and the impact of non-linear trend in the input data when creating the PCA model may be mitigated.

As describe above, the input matrix X may be used to create the PCA model corresponding to entire batch. As described herein, the PCA model corresponding to entire batch may be the PCA model corresponding to sample point K among K PCA models of the industrial process. In some embodiments, the PCA model corresponding to entire batch may include one or more principal components, each principal component may be a linear combination of (J*K) initial variables corresponding to (J*K) columns of the input matrix X. These principal components may be uncorrelated to one another and may represent directions of the data in the input matrix X that indicate a maximal amount of variance. Accordingly, these principal components may be perpendicular to one another and may capture most variance (most information) of the data in the input matrix X. Thus, these principal components may form a principal component space in which the differences (the variance) between the data points representing the data in the input matrix X are better indicated as compared to an original space formed by (J*K) initial variables corresponding to (J*K) columns of the input matrix X. In the original space formed by (J*K) initial variables and in the principal component space formed by the principal components of the PCA model corresponding to entire batch, each data point may correspond to a particular row of the input matrix X and may represent a non-anomalous batch at its end point with all K samples of the non-anomalous batch being included in the particular row of the input matrix X.

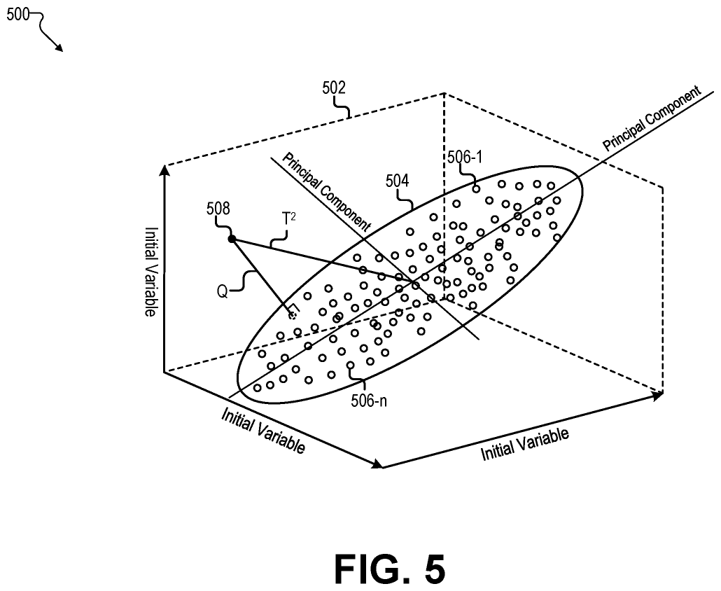

An example of an original space and a principal component space of a PCA model is illustrated in diagram 500 of FIG. 5. As depicted in FIG. 5, an original space 502 may be formed by the initial variables corresponding to the columns of an input matrix and a principal component space 504 may be formed by the principal components of a PCA model generated from the input matrix. Data in the input matrix may be represented by a plurality of data points 506 as depicted in FIG. 5. In case of the PCA model corresponding to entire batch that is generated from the input matrix X, each data point 506 may correspond to a particular row of the input matrix X and may represent a non-anomalous batch at its end point with all samples collected during the non-anomalous batch being included in the input matrix X as described above. In this case, the principal component space 504 may represent the principal component space of the PCA model corresponding to entire batch and the original space 502 may represent the original space formed by (J*K) initial variables corresponding to (J*K) columns of the input matrix X. As depicted in FIG. 5, the principal component space 504 may provide a different perspective from which the differences (the variance) between the data points 506 are better indicated as compared to the original space 502. It should be understood that the original space 502 and the principal component space 504 depicted in FIG. 5 are merely an example. The original space 502 may be formed by a different number of initial variables than the number of initial variables depicted in FIG. 5, and the principal component space 504 may be formed by a different number of principal components than the number of principal components depicted in FIG. 5.

As described above, the anomaly detection system 200 may generate the PCA model corresponding to entire batch based on the input matrix X. To generate the PCA model corresponding to entire batch, the anomaly detection system 200 may compute a covariance matrix C from the input matrix X as follows:

$$C = \frac{1}{I - 1} {X}^{T} X ∈ {M}_{( J * K ) \times ( J * K )} \qquad ( Equation 1 )$$

In Equation 1, I is the number of non-anomalous batches that are used to generate the PCA model corresponding to entire batch and other PCA models of the industrial process. The anomaly detection system 200 may then compute eigenvectors of the covariance matrix C and an eigenvalue of each eigenvector. The covariance matrix C may have (J*K) eigenvectors and (J*K) eigenvalues corresponding to (J*K) eigenvectors. The eigenvectors may represent the directions where there is the most variance of the data in the input matrix X, and therefore the eigenvectors may be used as the principal components of the PCA model corresponding to entire batch. Each eigenvector may have an eigenvalue and the eigenvalue may indicate the amount of variance carried in that eigenvector. Accordingly, the eigenvalue of each eigenvector may be referred to as the eigenvalue of the principal component that corresponds to the eigenvector and may indicate the amount of variance carried in that principal component. As the covariance matrix C has (J*K) eigenvectors, the PCA model corresponding to entire batch may have a maximum of (J*K) principal components.

In some embodiments, for each principal component among (J*K) principal components, the anomaly detection system 200 may compute a percentage between the eigenvalue of the principal component and a sum of the eigenvalues of (J*K) principal components. The percentage of the eigenvalue of the principal component may indicate a percentage of the variance of the data in the input matrix X that is carried by the principal component and may be referred to as the percentage of variance carried by the principal component. In some embodiments, the anomaly detection system 200 may select one or more principal components that carry the highest percentages of variance among (J*K) principal components. For example, the anomaly detection system 200 may select a total of A principal components that carry the highest percentages of variance among (J*K) principal components and have the total percentage of variance collectively carried by A principal components satisfying a predefined percentage threshold (e.g., >95%). The principal components being selected may be referred to as the retained principal components of the PCA model corresponding to entire batch. Other principal components may be omitted and may not be used in creating the PCA model corresponding to entire batch.

In some embodiments, the anomaly detection system 200 may form a loading matrix P of the PCA model corresponding to entire batch based on the retained principal components of the PCA model corresponding to entire batch. Each retained principal component may form a column of the loading matrix P. Thus, the loading matrix P may represent the principal component space of the PCA model corresponding to entire batch and may have the following dimensions:

$$P ∈ {M}_{( J * K ) \times A}$$

In some embodiments, the anomaly detection system 200 may compute a score matrix T based on the input matrix X and the loading matrix P of the PCA model corresponding to entire batch. The score matrix T may indicate the projection of the input data, which is represented by the input matrix X, onto the principal component space of the PCA model corresponding to entire batch, which is represented by the loading matrix P. In some embodiments, the anomaly detection system 200 may compute the score matrix T as follows:

$$T = XP ∈ {M}_{I \times A} \qquad ( Equation 2 )$$

Thus, the loading matrix P∈M_{(J*K)×A} and the score matrix T∈M_{I×A} may represent the PCA model corresponding to entire batch and may be generated from the input matrix X∈M_{I×(J*K)} that represents all K samples in the entire batch for each non-anomalous batch being used to generate the PCA models for the industrial process. In some embodiments, the loading matrix P and the score matrix T of the PCA model corresponding to entire batch may be generated in advance and may be stored in a data storage (e.g., a local data storage and/or the cloud storage system 140). In some embodiments, the anomaly detection system 200 may re-compute the loading matrix P and the score matrix T of the PCA model corresponding to entire batch periodically (e.g., every 2 months) using the non-anomalous batches that are generated most recently in the industrial process.

In some embodiments, in addition to the PCA model corresponding to entire batch, the anomaly detection system 200 may also create a PCA model for each sample point in the batch duration. For example, for a sample point k in the batch duration, the anomaly detection system 200 may create a PCA model corresponding to sample point k. The PCA model corresponding to sample point k may be created in a manner similar to the manner in which the PCA model corresponding to entire batch is created as described above. However, instead of using the input matrix X corresponding to an entire batch when generating the PCA model corresponding to entire batch, the anomaly detection system 200 may use an input matrix X(k) corresponding to the sample point k when creating the PCA model corresponding to sample point k.

To generate the input matrix X(k), for each non-anomalous batch in I non-anomalous batches, the anomaly detection system 200 may identify k samples that are collected between a start point of the non-anomalous batch and the sample point k during the non-anomalous batch. The anomaly detection system 200 may then aggregate k samples in a chronological order of their sample points to form one row of the input matrix X(k) as depicted in FIG. 4. Accordingly, each row in the input matrix X(k) may represent a portion of a non-anomalous batch that includes k samples collected from the beginning of the non-anomalous batch up to the sample point k during the non-anomalous batch. As described herein, each sample of the non-anomalous batch may include J values of J process variables of the industrial process. Thus, the input matrix X(k) may have the following dimensions:

$$X ( k ) ∈ {M}_{I \times ( J * k )}$$

In some embodiments, similar to the input matrix X, the input matrix X(k) may be subjected to the autoscaling operation (e.g., standardization transformation). The autoscaling operation may be performed for each column of the input matrix X(k) and may move a center of a data cloud representing the elements in the column of the input matrix X(k) to their mean value and normalize the elements in the column of the input matrix X(k). As a result of the autoscaling operation, for each column of the input matrix X(k), the elements in the column may center around their mean value and may have a unit variance (e.g., the standard deviation of 1). Accordingly, the dominance impact of the elements in the column of the input matrix X(k) that are in large value ranges and the impact of non-linear trend in the input data when creating the PCA model may be mitigated.

As describe above, the input matrix X(k) may be used to create the PCA model corresponding to sample point k. In some embodiments, the PCA model corresponding to sample point k may include one or more principal components, each principal component may be a linear combination of (J*k) initial variables corresponding to (J*k) columns of the input matrix X(k). These principal components may be uncorrelated to one another and may represent directions of the data in the input matrix X(k) that indicate a maximal amount of variance. Accordingly, these principal components may be perpendicular to one another and may capture most variance (most information) of the data in the input matrix X(k). Thus, these principal components may form a principal component space in which the differences (the variance) between the data points representing the data in the input matrix X(k) are better indicated as compared to an original space formed by (J*k) initial variables corresponding to (J*k) columns of the input matrix X(k). In the original space formed by (J*k) initial variables and in the principal component space formed by the principal components of the PCA model corresponding to sample point k, each data point may correspond to a particular row of the input matrix X(k) and may represent a non-anomalous batch at the sample point k with k samples that are collected from the start point of the non-anomalous batch up to the sample point k during the non-anomalous batch being included in the particular row of the input matrix X(k).

Considering the illustration in FIG. 5 in case of the PCA model corresponding to sample point k that is generated from the input matrix X(k), each data point 506 may correspond to a particular row of the input matrix X(k) and may represent a non-anomalous batch at the sample point k with k samples collected from the start point up to the sample point k of the non-anomalous batch being included in the input matrix X(k) as described above. In this case, the principal component space 504 may represent the principal component space of the PCA model corresponding to sample point k and the original space 502 may represent the original space formed by (J*k) initial variables corresponding to (J*k) columns of the input matrix X(k). As described herein with reference to FIG. 5, the principal component space 504 may provide a different perspective from which the differences (the variance) between the data points 506 are better indicated as compared to the original space 502.

As described above, the anomaly detection system 200 may generate the PCA model corresponding to sample point k from the input matrix X(k). Similar to generating the PCA model corresponding to entire batch, to generate the PCA model corresponding to sample point k, the anomaly detection system 200 may compute a covariance matrix C(k) from the input matrix X(k) as follows:

$$C ( k ) = \frac{1}{I - 1} {X ( k )}^{T} X ( k ) ∈ {M}_{( J * k ) \times ( J * k )} \qquad ( Equation 3 )$$

In Equation 3, I is the number of non-anomalous batches that are used to generate the PCA model corresponding to entire batch and other PCA models of the industrial process. The anomaly detection system 200 may then compute eigenvectors of the covariance matrix C(k) and an eigenvalue of each eigenvector. The covariance matrix C(k) may have (J*k) eigenvectors and (J*k) eigenvalues corresponding to (J*k) eigenvectors. The eigenvectors may represent the directions where there is the most variance of the data in the input matrix X(k), and therefore may be used as the principal components of the PCA model corresponding to sample point k. Each eigenvector may have an eigenvalue and the eigenvalue may indicate the amount of variance carried in that eigenvector. Accordingly, the eigenvalue of each eigenvector may be referred to as the eigenvalue of the principal component that corresponds to the eigenvector and may indicate the amount of variance carried in that principal component. As the covariance matrix C(k) has (J*k) eigenvectors, the PCA model corresponding to sample point k may have a maximum of (J*k) principal components.

In some embodiments, for each principal component among (J*k) principal components, the anomaly detection system 200 may compute a percentage between the eigenvalue of the principal component and a sum of the eigenvalues of (J*k) principal components. The percentage of the eigenvalue of the principal component may indicate a percentage of the variance of the data in the input matrix X(k) that is carried by the principal component and may be referred to as the percentage of variance carried by the principal component. In some embodiments, the anomaly detection system 200 may select one or more principal components that carry the highest percentages of variance among (J*k) principal components. For example, the anomaly detection system 200 may select a total of A principal components that carry the highest percentages of variance among (J*k) principal components and have the total percentage of variance collectively carried by A principal components satisfying a predefined percentage threshold (e.g., >95%). The principal components being selected may be referred to as the retained principal components of the PCA model corresponding to sample point k. Other principal components may be omitted and may not be used in creating the PCA model corresponding to sample point k.

It should be understood that the total number of retained principal components (e.g., A) in the PCA model corresponding to sample point k may be the same as or may be different from the total number of retained principal components in other PCA models of the industrial process (such as the PCA model corresponding to entire batch and/or the PCA model corresponding to another sample point).

In some embodiments, the anomaly detection system 200 may form a loading matrix P(k) of the PCA model corresponding to sample point k based on the retained principal components of the PCA model corresponding to sample point k. Each retained principal component may form a column of the loading matrix P(k). Thus, the loading matrix P(k) may represent the principal component space of the PCA model corresponding to sample point k and may have the following dimensions:

$$P ( k ) ∈ {M}_{( J * k ) \times A}$$

In some embodiments, the anomaly detection system 200 may compute a score matrix T(k) based on the input matrix X(k) and the loading matrix P(k) of the PCA model corresponding to sample point k. The score matrix T(k) may indicate the projection of the input data, which is represented by the input matrix X(k), onto the principal component space of the PCA model corresponding to sample point k, which is represented by the loading matrix P(k). In some embodiments, the anomaly detection system 200 may compute the score matrix T(k) as follows:

$$T ( k ) = X ( k ) P ( k ) ∈ {M}_{I \times A} \qquad ( Equation 4 )$$

Thus, the loading matrix P(k)∈M_{(J*k)×A} and the score matrix T(k)∈M_{I×A} may represent the PCA model corresponding to sample point k and may be generated from the input matrix X(k)∈M_{I×(J*k)}. As described herein, the input matrix X(k) may represent k samples that are collected from the start point up to the sample point k in the batch duration for each non-anomalous batch being used to generate the PCA models for the industrial process. Similar to the PCA model corresponding to entire batch, the loading matrix P(k) and the score matrix T(k) of the PCA model corresponding to sample point k may be generated in advance and may be stored in a data storage (e.g., a local data storage and/or the cloud storage system 140). In some embodiments, the anomaly detection system 200 may re-compute the loading matrix P(k) and the score matrix T(k) of the PCA model corresponding to sample point k periodically (e.g., every 2 months) using the non-anomalous batches that are generated most recently in the industrial process.

Thus, as described above, each PCA model (e.g., the PCA model corresponding to entire batch, the PCA model corresponding to sample point k) may be generated from the non-anomalous batches of the industrial process and may represent a principal component space in which each non-anomalous batch is represented as a data point and the variance between the data points (the differences between the non-anomalous batches) are better indicated in the principal component space of the PCA model as compared to the original space formed by the initial variables corresponding to the sample data of the non-anomalous batches. As described herein, for the PCA model corresponding to entire batch, each data point may represent an entire non-anomalous batch, and therefore may reflect all K samples collected during the non-anomalous batch. For the PCA model corresponding to sample point k, each data point may represent a portion of a non-anomalous batch up to the sample point k, and therefore may reflect k samples collected from the start point up to the sample point k during the non-anomalous batch.

In some embodiments, the anomaly detection system 200 may use the PCA models to determine whether a batch generated in the industrial process is anomalous. As described herein, to determine whether a complete batch is anomalous, the anomaly detection system 200 may use the PCA model corresponding to entire batch. To determine whether an ongoing batch is anomalous at a sample point k during the ongoing batch, the anomaly detection system 200 may use the PCA model corresponding to sample point k.

To illustrate, to perform the anomaly detection for a particular batch that is complete or finished, the anomaly detection system 200 may determine a T²-statistic metric and a Q-statistic metric of the particular batch in the PCA model corresponding to entire batch using the loading matrix P and the score matrix T of the PCA model corresponding to entire batch.

For example, the anomaly detection system 200 may generate an input vector x representing the particular batch. Because the particular batch is complete, the particular batch may include all K samples of the particular batch, each sample may be collected at a sample point during the particular batch and may include J values of J process variables of the industrial process that are obtained at the sample point. To generate the input vector x for the particular batch, the anomaly detection system 200 may unfold K samples of the particular batch into the input vector x. For example, the anomaly detection system 200 may aggregate K samples of the particular batch in a chronological order of their sample points to form the only row of the input vector x. Thus, the input vector x representing the particular batch may have the following dimensions:

$$x ∈ {M}_{1 \times ( J * K )}$$

In some embodiments, the anomaly detection system 200 may compute a score t for the particular batch based on the input vector x and the loading matrix P of the PCA model corresponding to entire batch. The score t of the particular batch may indicate a projection of the data point corresponding to the particular batch, which is represented by the input vector x, onto the principal component space of the PCA model corresponding to entire batch, which is represented by the loading matrix P. In some embodiments, the anomaly detection system 200 may compute the score t of the particular batch as follows:

$$t = x {P ( {P}^{T} P )}^{- 1} ∈ {M}_{1 \times A} \qquad ( Equation 5 )$$

In some embodiments, the anomaly detection system 200 may compute the T²-statistic metric of the particular batch based on the score t of the particular batch and the score matrix T of the PCA model corresponding to entire batch. The T²-statistic metric of the particular batch may indicate the variance of the data point corresponding to the particular batch within the PCA model corresponding to entire batch. In some embodiments, the anomaly detection system 200 may compute the T²-statistic metric of the particular batch as follows:

$${T}^{2} = {t ( \frac{{T}^{T} T}{( I - 1 )} )}^{- 1} {t}^{T} ∈ {R}_{1 \times 1} \qquad ( Equation 6 )$$

In Equation 6, I is the number of non-anomalous batches that are used to generate the PCA model corresponding to entire batch and other PCA models of the industrial process as described herein.

In some embodiments, the anomaly detection system 200 may compute a residual error e for the particular batch based on the input vector x, the score t, and the loading matrix P of the PCA model corresponding to entire batch. The residual error e of the particular batch may indicate the difference of the data point corresponding to the particular batch and the projection of that data point back to the original space of the initial variables after that data point is projected onto the principal component space of the PCA model corresponding to entire batch. In some embodiments, the anomaly detection system 200 may compute the residual error e of the particular batch as follows:

$$e = x - t {P}^{T} ∈ {M}_{1 \times ( J * K )} \qquad ( Equation 7 )$$

In some embodiments, the anomaly detection system 200 may compute the Q-statistic metric of the particular batch based on the residual error e of the particular batch. The Q-statistic metric of the particular batch may indicate the difference (the residual) of the data point corresponding to the particular batch and the projection of that data point onto the PCA model corresponding to entire batch. In some embodiments, the anomaly detection system 200 may compute the Q-statistic metric of the particular batch as follows:

$$Q = e {e}^{T} ∈ {R}_{1 \times 1} \qquad ( Equation 8 )$$

Thus, the T²-statistic metric and the Q-statistic metric of the particular batch may indicate a conformity level of the particular batch with the PCA model corresponding to entire batch that is created based on the non-anomalous batches generated in the industrial process. As described above, the T²-statistic metric of the particular batch may indicate the variance of the data point corresponding to the particular batch within the PCA model corresponding to entire batch. In other words, the T²-statistic metric may indicate the distance between the data point corresponding to the particular batch and the origin of the model plane in the PCA model corresponding to entire batch. Thus, the T²-statistic metric may indicate the deviation of the particular batch from its desired state within the PCA model corresponding to entire batch. On the other hand, the Q-statistic metric of the particular batch may indicate the difference of the data point corresponding to the particular batch and the projection of that data point onto the PCA model corresponding to entire batch. In other words, the Q-statistic metric may indicate the residual or the squared distance between the data point representing the particular batch and the model plane of the PCA model corresponding to entire batch. Thus, the T²-statistic metric and the Q-statistic metric may indicate 2 types of variance of the data point corresponding to the particular batch in the PCA model corresponding to entire batch. In FIG. 5, the particular batch may be represented by a data point 508 and the distances represented by the T²-statistic metric and the Q-statistic metric of the particular batch are also depicted in FIG. 5.

In some embodiments, to evaluate the anomaly of the particular batch, the anomaly detection system 200 may not use the T²-statistic metric and the Q-statistic metric of the particular batch, but instead using a normalized T²-statistic metric and a normalized Q-statistic metric of the particular batch.

In some embodiments, the anomaly detection system 200 may compute the normalized T²-statistic metric of the particular batch based on the T²-statistic metric of the particular batch and a confidence limit T_{α}² of the T²-statistic metric. The confidence limit T_{α}² of the T²-statistic metric may be an upper limit of a confidence interval of the T²-statistic metric that is associated with a predefined α level (e.g., α=5%). In some embodiments, the predefined α level may correspond to a confidence level, and the confidence level may be equal to (1−α)*100%. For example, an a level of 5% may correspond to a confidence level of 95%. In some embodiments, the confidence interval of the T²-statistic metric that is associated with the predefined α level or with the confidence level corresponding to the predefined α level may be a value range where the T²-statistic metrics of the non-anomalous batches lie within with the confidence level. For example, a confidence interval of the T²-statistic metric that is associated with the confidence level of 95% may be the value range where the T²-statistic metrics of the non-anomalous batches lie within 95% of the time, and the confidence limit T_{α}² of the T²-statistic metric may be the upper limit of that confidence interval.

In some embodiments, the anomaly detection system 200 may compute the confidence limit T_{α}² of the T²-statistic metric based on the PCA model corresponding to entire batch. In some embodiments, the anomaly detection system 200 may compute the confidence limit T_{α}² of the T²-statistic metric as follows:

$${T}_{α}^{2} = \frac{A ( I - 1 )}{I - A} {F}_{A , I - A , α} \qquad ( Equation 9 )$$

In Equation 9, I is the number of non-anomalous batches that are used to generate the PCA model corresponding to entire batch and other PCA models of the industrial process. A is the number of retained principal components of the PCA model corresponding to entire batch. F_{A,I-A,α} is the F-distribution under an assumption of the predefined α level, with the PCA model being generated from I batches and including A retained principal components.

In some embodiments, the anomaly detection system 200 may compute the normalized T²-statistic metric (Tₙₒᵣₘ²) of the particular batch based on the T²-statistic metric of the particular batch and the confidence limit T_{α}² of the T²-statistic metric as follows:

$${T}_{n o r m}^{2} = \frac{{T}^{2}}{{T}_{α}^{2}} \qquad ( Equation 10 )$$

Similarly, the anomaly detection system 200 may compute the normalized Q-statistic metric of the particular batch based on the Q-statistic metric of the particular batch and a confidence limit Q_{α} of the Q-statistic metric. The confidence limit Q_{α} of the Q-statistic metric may be an upper limit of a confidence interval of the Q-statistic metric that is associated with a predefined α level. In some embodiments, the confidence interval of the Q-statistic metric that is associated with the predefined α level or with the confidence level corresponding to the predefined α level may be a value range where the Q-statistic metrics of the non-anomalous batches lie within with the confidence level. For example, a confidence interval of the Q-statistic metric that is associated with the confidence level of 95% may be the value range where the Q-statistic metrics of the non-anomalous batches lie within 95% of the time, and the confidence limit Q_{α} of the Q-statistic metric may be the upper limit of that confidence interval.

In some embodiments, the anomaly detection system 200 may compute the confidence limit Q_{α} of the Q-statistic metric based on the PCA model corresponding to entire batch. In some embodiments, the anomaly detection system 200 may compute the confidence limit Q_{α} of the Q-statistic metric as follows:

$${Q}_{α} = {{θ}_{1} ( \frac{{{z}_{α} ( 2 {θ}_{2} {h}_{0}^{2} )}^{0.5}}{{θ}_{1}} + 1 + \frac{{θ}_{2} {h}_{0} ( {h}_{0} - 1 )}{{θ}_{1}^{2}} )}^{\frac{1}{{h}_{0}}} \qquad ( Equation 11 )$$

In Equation 11, z_{α} is the standardized normal variable corresponding to the predefined α level. To compute other components in Equation 11, the anomaly detection system 200 may compute a residual matrix E of the PCA model corresponding to entire batch as follows:

$$E = X - T {P}^{T} ∈ {M}_{I \times ( J * K )} \qquad ( Equation 12 )$$

The anomaly detection system 200 may then compute a covariance matrix V of the residual matrix E as follows:

$$V = \frac{E {E}^{T}}{I - 1} ∈ {M}_{I \times I} \qquad ( Equation 13 )$$

In Equation 13, I is the number of non-anomalous batches that are used to generate the PCA model corresponding to entire batch and other PCA models of the industrial process as described herein.

The anomaly detection system 200 may then compute θ₁, θ₂, and θ₃ based on the covariance matrix V as follows:

$${θ}_{i} = trace ( {V}^{i} ) for i = 1 , 2 , 3 \qquad ( Equation 14 )$$

Thus, θ₁ is the sum of the diagonal elements in the covariance matrix V, θ₂ is the sum of the diagonal elements in the covariance matrix V squared, and θ₃ is the sum of the diagonal elements in the covariance matrix V cubed.

The anomaly detection system 200 may then compute ho as follows:

$${h}_{0} = 1 - \frac{2 {θ}_{1} {θ}_{3}}{3 {θ}_{2}} \qquad ( Equation 15 )$$

In some embodiments, after computing the components based on Equations 12-15 as described above, the anomaly detection system 200 may use these components in Equation 11 to compute the confidence limit Q_{α} of the Q-statistic metric. The anomaly detection system 200 may then compute the normalized Q-statistic metric (Qₙₒᵣₘ) of the particular batch based on the Q-statistic metric of the particular batch and the confidence limit Q_{α} of the Q-statistic metric as follows:

$${Q}_{n o r m} = \frac{Q}{{Q}_{α}} \qquad ( Equation 16 )$$

Thus, according to Equation 10, to compute the normalized T²-statistic metric of the particular batch, the anomaly detection system 200 may divide the T²-statistic metric of the particular batch by the upper limit T_{α}² of the confidence interval of the T²-statistic metric where the T²-statistic metrics of the non-anomalous batches lie within most of the time (e.g., 95% of the time, if the confidence level is 95%). Similarly, according to Equation 16, to compute the normalized Q-statistic metric of the particular batch, the anomaly detection system 200 may divide the Q-statistic metric of the particular batch by the upper limit Q_{α} of the confidence interval of the Q-statistic metric where the Q-statistic metrics of the non-anomalous batches lie within most of the time (e.g., 95% of the time, if the confidence level is 95%). Thus, due to this normalization, the normalized T²-statistic metric of the particular batch and the normalized Q-statistic metric of the particular batch may be brought to the same scale.

To illustrate, assuming that the particular batch is not anomalous. In this case, the T²-statistic metric of the particular batch may likely (e.g., 95% likely, if the confidence level is 95%) lie within the confidence interval of the T²-statistic metric for the non-anomalous batches, and therefore the normalized T²-statistic metric of the particular batch may likely (e.g., 95% likely) fall within [0, 1] according to Equation 10. Similarly, when the particular batch is not anomalous, the Q-statistic metric of the particular batch may likely (e.g., 95% likely, if the confidence level is 95%) lie within the confidence interval of the Q-statistic metric for the non-anomalous batches, and therefore the normalized Q-statistic metric of the particular batch may likely (e.g., 95% likely) fall within [0, 1] according to Equation 16. Thus, in this case, the normalized T²-statistic metric of the particular batch and the normalized Q-statistic metric of the particular batch may both likely be in the value range [0, 1] even though the T²-statistic metric of the particular batch and the Q-statistic metric of the particular batch may be in very different value ranges prior to normalization. Because the normalization brings the normalized T²-statistic metric of the particular batch and the normalized Q-statistic metric of the particular batch to the same scale, the normalized T²-statistic metric of the particular batch and the normalized Q-statistic metric of the particular batch can be compared to one another.

In some embodiments, the anomaly detection system 200 may compare the normalized T²-statistic metric of the particular batch and the normalized Q-statistic metric of the particular batch, and determine an anomaly metric of the particular batch based on such comparison. For example, the anomaly detection system 200 may determine the anomaly metric of the particular batch to be the highest value between the normalized T²-statistic metric of the particular batch and the normalized Q-statistic metric of the particular batch. Accordingly, the anomaly detection system 200 may determine the anomaly metric of the particular batch as follows:

$$Anomaly metric = max ( {T}_{n o r m}^{2} , {Q}_{n o r m} ) \qquad ( Equation 17 )$$

Determining the anomaly metric of the particular batch using Equation 17 is advantageous. As described herein, the T²-statistic metric and the Q-statistic metric of the particular batch may indicate 2 types of variance of the data point corresponding to the particular batch in the PCA model corresponding to entire batch (also referred to in this paragraph as the PCA model for simplification). Thus, according to Equation 17, the anomaly detection system 200 may select, between the normalized T²-statistic metric and the normalized Q-statistic metric of the particular batch, the normalized metric that indicates the larger amount of variation to be the anomaly metric of the particular batch. In other words, the normalized metric that better indicates the variance between the data point corresponding to the particular batch and the data points corresponding to the non-anomalous batches in the PCA model, and therefore better indicates the inconformity of the particular batch with the PCA model, may be selected as the anomaly metric of the particular batch. As a result, the accuracy in detecting anomaly for the particular batch based on the anomaly metric of the particular batch may be improved.

Due to the flexibility in selecting which normalized metric to be the anomaly metric for a batch, the anomaly metric of the particular batch may be the normalized T²-statistic metric of the particular batch, while the anomaly metric of a different batch may be the normalized Q-statistic metric of the different batch. Alternatively, the anomaly metric of the particular batch may be the normalized Q-statistic metric of the particular batch, while the anomaly metric of the different batch may be the normalized T²-statistic metric of the different batch.

In some embodiments, the anomaly detection system 200 may determine whether the anomaly metric of the particular batch satisfies an anomaly detection threshold. If the anomaly metric of the particular batch satisfies the anomaly detection threshold (e.g., the anomaly metric exceeds the anomaly detection threshold), the anomaly detection system 200 may determine that the particular batch is anomalous.

In some embodiments, the anomaly detection threshold may be a predefined threshold value. For example, the anomaly detection threshold may be equal to 1. In this case, if the anomaly metric of the particular batch is the normalized T²-statistic metric of the particular batch and the anomaly metric of the particular batch exceeds the anomaly detection threshold (e.g.,

$${T}_{n o r m}^{2} = \frac{{T}^{2}}{{T}_{α}^{2}} > 1 ) ,$$

the anomaly detection system 200 may determine that the T²-statistic metric of the particular batch is higher than the upper limit T_{α}² of the confidence interval of the T²-statistic metric. Thus, the anomaly detection system 200 may determine that the T²-statistic metric of the particular batch falls outside the confidence interval where the T²-statistic metrics of the non-anomalous batches lie within most of the time (e.g., 95% of the time, if the confidence level is 95%). Accordingly, the anomaly detection system 200 may determine that the particular batch is anomalous.

Similarly, if the anomaly metric of the particular batch is the normalized Q-statistic metric of the particular batch and the anomaly metric of the particular batch exceeds the anomaly detection threshold (e.g.,

$${Q}_{n o r m} = \frac{Q}{{Q}_{α}} > 1 ) ,$$

the anomaly detection system 200 may determine that the Q-statistic metric of the particular batch is higher than the upper limit Q_{α} of the confidence interval of the Q-statistic metric. Thus, the anomaly detection system 200 may determine that the Q-statistic metric of the particular batch falls outside the confidence interval where the Q-statistic metrics of the non-anomalous batches lie within most of the time (e.g., 95% of the time, if the confidence level is 95%). Accordingly, the anomaly detection system 200 may determine that the particular batch is anomalous.

However, using a predefined threshold value (e.g., 1) as the anomaly detection threshold may result in false positives and/or false negatives in anomaly detection. As an example, because the confidence interval corresponds to a confidence level that is below 100%, there is a possibility that the T²-statistic metric (or the Q-statistic metric) of the particular batch may fall outside the confidence interval where the T²-statistic metrics (or the Q-statistic metrics) of the non-anomalous batches lie within most of the time (e.g., 95% of the time, if the confidence level is 95%) but the particular batch is actually non-anomalous. In this case, the anomaly detection result for the particular batch may be a false positive.

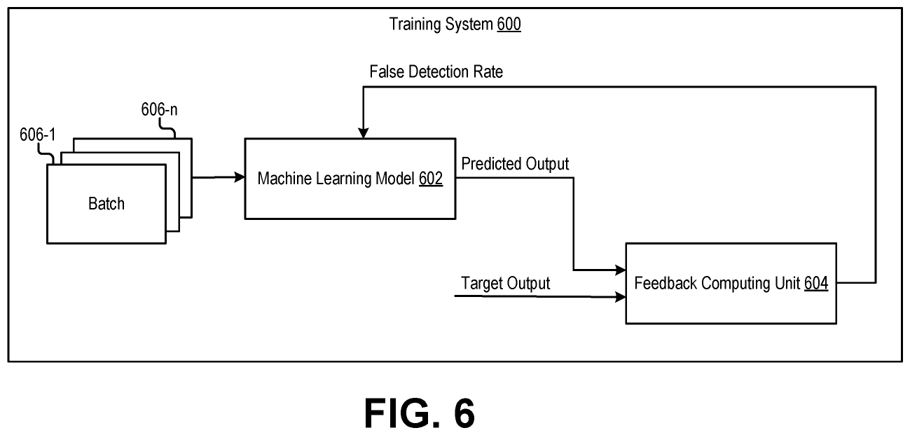

In some embodiments, to reduce the false positives and the false negatives in anomaly detection, instead of or in addition to using a predefined threshold value as the anomaly detection threshold as described above, the anomaly detection system 200 may determine the anomaly detection threshold using a machine learning model. In some embodiments, the machine learning model may be trained by a training system. An example training system 600 is illustrated in FIG. 6. The training system 600 may be implemented at the edge device 130, the cloud platform 102, and/or other components of the system 100. In some embodiments, various components of the system 100 may collaborate with one another to perform one or more functionalities of the training system 600 described herein.

As depicted in FIG. 6, the training system 600 may include a machine learning model 602 and a feedback computing unit 604. In some embodiments, the machine learning model 602 may be implemented using one or more supervised and/or unsupervised learning algorithms. For example, the machine learning model 602 may be implemented in the form of a linear regression model, a logistic regression model, a Support Vector Machine (SVM) model, and/or other learning models. Additionally or alternatively, the machine learning model 602 may be implemented in the form of a neural network including an input layer, one or more hidden layers, and an output layer. Non-limiting examples of the neural network include, but are not limited to, Convolutional Neural Network (CNN), Recurrent Neural Network (RNN), Long Short-Term Memory (LSTM) neural network, etc. Other system architectures for implementing the machine learning model 602 are also possible and contemplated.

As depicted in FIG. 6, the machine learning model 602 may be trained with a one or more batches 606. The batches 606 may include one or more anomalous batches and/or one or more non-anomalous batches generated by the industrial process that are already finished. During the training process, the training system 600 may input the batches 606 into the machine learning model 602, and determine one or more candidate anomaly detection thresholds using the machine learning model 602.

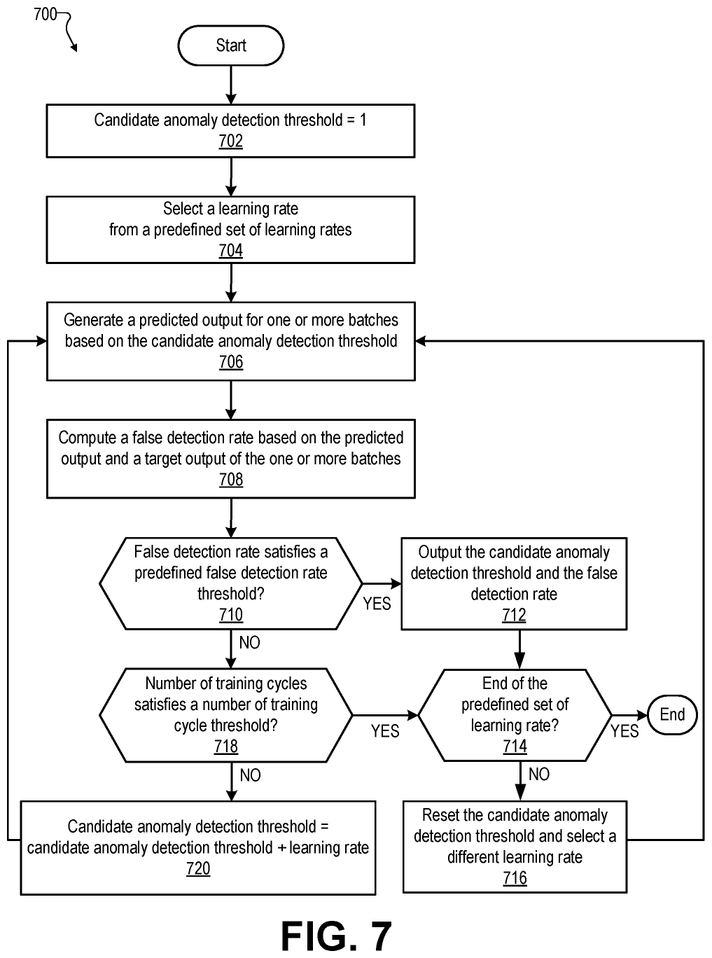

An example method 700 for determining the candidate anomaly detection thresholds using the machine learning model 602 is illustrated in FIG. 7. While FIG. 7 shows illustrative operations according to one embodiment, other embodiments may omit, add to, reorder, and/or modify any of the operations shown in FIG. 7. In some examples, multiple operations shown in FIG. 7 or described in relation to FIG. 7 may be performed concurrently (e.g., in parallel) with one another, rather than being performed sequentially as illustrated and/or described. One or more of the operations shown in FIG. 7 may be performed by a training system such as the training system 600 and/or any implementation thereof. For example, the operations in FIG. 7 may be performed by the machine learning model 602 and the feedback computing unit 604 of the training system 600 depicted in FIG. 6.

At operation 702, the machine learning model 602 may assign the candidate anomaly detection threshold an initial value. For example, the machine learning model 602 may set the initial value of the candidate anomaly detection threshold to be 1.

At operation 704, the machine learning model 602 may select a learning rate from a predefined set of learning rate. The predefined set of learning rate may include one or more learning rates. A learning rate may be positive (e.g., 0.01) or may be negative (e.g., −0.01).

At operation 706, the machine learning model 602 may generate a predicted output for the one or more batches 606 based on the candidate anomaly detection threshold. For each batch 606 among the one or more batches 606, the predicted output may indicate whether the batch 606 is predicted to be anomalous.

In some embodiments, to generate the predicted output, the machine learning model 602 may determine the anomaly metric for each batch 606 among the one or more batches 606. As described herein, the anomaly metric of the batch 606 may be the normalized T²-statistic metric or the normalized Q-statistic metric of the batch 606 that are computed using the PCA model corresponding to entire batch. In some embodiments, the machine learning model 602 may compare the anomaly metric of the batch 606 to the candidate anomaly detection threshold. If the anomaly metric of the batch 606 exceeds the candidate anomaly detection threshold, the machine learning model 602 may determine the predicted output for the batch 606 to be anomalous. If the anomaly metric of the batch 606 does not exceed the candidate anomaly detection threshold, the machine learning model 602 may determine the predicted output for the batch 606 to be non-anomalous. Thus, the predicted output of the one or more batches 606 may indicate whether each batch among the one or more batches 606 is predicted to be anomalous based on the candidate anomaly detection threshold. In some embodiments, the machine learning model 602 may provide the predicted output of the one or more batches 606 to the feedback computing unit 604 as depicted in FIG. 6.

At operation 708, the feedback computing unit 604 may determine a false detection rate based on the predicted output of the one or more batches 606 and a target output of the one or more batches 606. The target output of the one or more batches 606 may indicate whether each batch in the one or more batches 606 is actually anomalous. In some embodiments, to determine the false detection rate based on the predicted output and the target output, the feedback computing unit 604 may determine a number of false positive results where a batch 606 is predicted to be anomalous as indicated in the predicted output generated by the machine learning model 602, but is actually non-anomalous as indicated in the target output of the one or more batches 606. The feedback computing unit 604 may also determine a number of false negative results where a batch 606 is predicted to be non-anomalous as indicated in the predicted output generated by the machine learning model 602, but is actually anomalous as indicated in the target output of the one or more batches 606. The feedback computing unit 604 may then calculate a sum value of the number of false positive results and the number of false negative results, and determine the false detection rate to be a ratio between the sum value and a total number of the batches 606. Thus, the false detection rate may indicate a rate at which the anomaly detection performed for the batches 606 using the candidate anomaly detection threshold is inaccurate.

In some embodiments, the feedback computing unit 604 may provide the false detection rate back to the machine learning model 602. For example, the feedback computing unit 604 may back-propagate the false detection rate to the machine learning model 602 as depicted in FIG. 6. It should be understood that the false detection rate may be determined by the machine learning model 602 instead of the feedback computing unit 604.

At operation 710, the machine learning model 602 may determine whether the false detection rate satisfies a predefined false detection rate threshold (e.g., less than 5%). If the false detection rate satisfies the predefined false detection rate threshold, the machine learning model 602 may determine that the anomaly detection using the candidate anomaly detection threshold is sufficiently accurate. In this case, the method 700 may proceed to operation 712. At operation 712, the machine learning model 602 may output the candidate anomaly detection threshold and the false detection rate associated with the candidate anomaly detection threshold.

At operation 714, the machine learning model 602 may determine whether the machine learning model 602 reaches the end of the predefined set of learning rate. If the end of the predefined set of learning rate is reached, the machine learning model 602 may determine that the machine learning model 602 is already trained with all learning rates included in the predefined set of learning rate, and thus the method 700 may end. On the other hand, if the end of the predefined set of learning rate is not reached, at operation 716, the machine learning model 602 may reset the candidate anomaly detection threshold to 1 and select a different learning rate in the predefined set of learning rate. The method 700 may then return to operation 706 to continue training the machine learning model 602 but with the different learning rate.

If at operation 710, the machine learning model 602 determines that the false detection rate does not satisfy the predefined false detection rate threshold (e.g., less than 5%), the machine learning model 602 may determine that the anomaly detection using the candidate anomaly detection threshold is not sufficiently accurate. In this case, the method 700 may proceed to operation 718.

At operation 718, the machine learning model 602 may determine whether the number of training cycles performed by the machine learning model 602 satisfies a number of training cycle threshold (e.g., equal to or greater than 500 training cycles). If the number of training cycles performed by the machine learning model 602 does not satisfy the number of training cycle threshold, the machine learning model 602 may determine that the machine learning model 602 is not sufficiently trained with the learning rate. In this case, the method 700 may proceed to operation 720.

At operation 720, the machine learning model 602 may adjust the candidate anomaly detection threshold to perform another training cycle with the learning rate. For example, the machine learning model 602 may increase the candidate anomaly detection threshold by an amount equal to the learning rate. The method 700 may then return to operation 706 to perform another training cycle of the machine learning model 602 with the learning rate using the adjusted candidate anomaly detection threshold.

If at operation 718, the machine learning model 602 determines that the number of training cycles performed by the machine learning model 602 satisfies the number of training cycle threshold, the machine learning model 602 may determine that the machine learning model 602 is subjected to a sufficient number of training cycles with the learning rate but does not find a candidate anomaly detection threshold that results in a false detection rate satisfying the predefined false detection rate threshold in these training cycles. In this case, the method 700 may return to operation 714 to determine whether there is a different learning rate to continue training the machine learning model 602 as described above.

Thus, as described in FIG. 7, the machine learning model 602 may be trained with all learning rates in the predefined set of learning rate. For each learning rate, the machine learning model 602 may be trained until a candidate anomaly detection threshold in a training cycle results in a false detection rate satisfying the predefined false detection rate threshold (e.g., less than 5%) or until the machine learning model 602 is subjected to a threshold number of training cycles (e.g., 500 training cycles), whichever occurs first. As a result of the training, the machine learning model 602 may output one or more candidate anomaly detection thresholds that result in one or more false detection rates satisfying the predefined false detection rate threshold (e.g., less than 5%) when these candidate anomaly detection thresholds are used to detect anomaly for the batches 606. In some embodiments, the training system 600 may determine a lowest false detection rate among the one or more false detection rates that satisfy the predefined false detection rate threshold, and identify one or more candidate anomaly detection thresholds that result in the lowest false detection rate. Among the candidate anomaly detection thresholds that result in the lowest false detection rate, the training system 600 may select the lowest candidate anomaly detection threshold to be the anomaly detection threshold.

As described herein, the anomaly detection threshold may be used to determine whether a particular batch is anomalous. For example, if the anomaly metric of the particular batch satisfies the anomaly detection threshold (e.g., the anomaly metric exceeds the anomaly detection threshold), the anomaly detection system 200 may determine that the particular batch is anomalous. In some embodiments, in response to determining that the particular batch is anomalous, the anomaly detection system 200 may display to a process operator (e.g., a human operator) of the industrial process a notification indicating that the particular batch is anomalous. In some embodiments, the anomaly detection system 200 may perform the anomaly detection for multiple complete batches in group. The anomaly detection system 200 may then generate an anomaly detection report including an anomaly detection result for each batch among the multiple complete batches, and provide the anomaly detection report to the process operator. In some embodiments, the anomaly detection system 200 may perform the anomaly detection for multiple complete batches during an off-peak time window.

In some embodiments, the anomaly detection system 200 may not only determine whether a complete batch is anomalous but also determine whether an ongoing batch is anomalous at one or more sample points during the ongoing batch. For example, during a particular batch that is ongoing and not yet finished, when a sample k is collected at a sample point k during the particular batch, the anomaly detection system 200 may determine whether the particular batch is anomalous at the sample point k using the PCA model corresponding to sample point k.

In some embodiments, to determine whether the particular batch is anomalous at the sample point k while the particular batch is ongoing, the anomaly detection system 200 may determine an anomaly metric corresponding to the sample point k during the particular batch. The anomaly metric corresponding to the sample point k during the particular batch may also be referred to as the anomaly metric corresponding to sample point k of the particular batch, the anomaly metric at sample point k of the particular batch, or the anomaly metric of the particular batch at sample point k. As described herein, the anomaly metric of the particular batch at sample point k may be determined using the PCA model corresponding to sample point k.

As described herein, the PCA model corresponding to sample point k may be generated from the non-anomalous batches of the industrial process and may represent a principal component space in which each data point corresponds to a non-anomalous batch and the variance between the data points (the differences between the non-anomalous batches) are better indicated in the principal component space of the PCA model corresponding to sample point k as compared to the original space formed by the initial variables corresponding to the sample data of the non-anomalous batches. In the PCA model corresponding to sample point k, a data point corresponding to a non-anomalous batch may represent a portion of the non-anomalous batch up to the sample point k, and therefore may reflect k samples collected from the start point of the non-anomalous batch up to the sample point k during the non-anomalous batch. As described herein, the PCA model corresponding to sample point k may have the loading matrix P(k)∈M_{(J*k)×A} and the score matrix T(k)∈M_{I×A}.

In some embodiments, the anomaly detection system 200 may determine the anomaly metric corresponding to sample point k of the particular batch using the loading matrix P(k) and the score matrix T(k) of the PCA model corresponding to sample point k. In some embodiments, the anomaly detection system 200 may generate an input vector x(k) representing the particular batch at the sample point k. The particular batch at the sample point k may include k samples of the particular batch that are collected from the start point of the particular batch up to the sample point k during the particular batch. Each sample may be collected at a sample point between the start point and the sample point k during the particular batch and may include J values of J process variables of the industrial process that are obtained at the sample point. In some embodiments, to generate the input vector x(k) representing the particular batch at the sample point k, the anomaly detection system 200 may identify k samples of the particular batch that are collected from the beginning of the particular batch up to the sample point k during the particular batch, and aggregate k samples in a chronological order of their sample points to form the only row of the input vector x(k). Thus, the input vector x(k) representing the particular batch at the sample point k may have the following dimensions:

$$x ( k ) ∈ {M}_{1 \times ( J * k )}$$

In some embodiments, the anomaly detection system 200 may determine the anomaly metric corresponding to sample point k of the particular batch that is ongoing in a manner similar to determining the anomaly metric of a batch that is complete as described above. In particular, the anomaly detection system 200 may determine a score t(k), a T²-statistic metric T²(k), a residual error e(k), a Q-statistic metric Q(k), a confidence limit T_{α}²(k), a normalized T²-statistic metric Tₙₒᵣₘ²(k), a confidence limit Q_{α}(k), a normalized Q-statistic metric Qₙₒᵣₘ(k), and the anomaly metric of the particular batch that correspond to sample point k using Equations 5-17. However, when determining these components corresponding to sample point k for the particular batch, the anomaly detection system 200 may not use the input vector x representing the batch that is complete and may not use the loading matrix P and the score matrix T of the PCA model corresponding to entire batch in Equations 5-17. Instead, the anomaly detection system 200 may use the input vector x(k) representing the particular batch at the sample point k and use the loading matrix P(k) and the score matrix T(k) of the PCA model corresponding to sample point k in Equations 5-17 to determine the anomaly metric corresponding to sample point k of the particular batch.

Accordingly, when determining a first anomaly metric corresponding a first sample point that is at a first time t₁ for the particular batch, the anomaly detection system 200 may use a first PCA model corresponding to the first sample point. As described herein, the first PCA model corresponding to the first sample point may be created based on a first batch portion of one or more non-anomalous batches in the industrial process, in which the first batch portion of each non-anomalous batch is generated between a start point of the non-anomalous batch and the first sample point during the non-anomalous batch. On the other hand, when determining a second anomaly metric corresponding a second sample point that is at a second time t₂ for the particular batch, the anomaly detection system 200 may use a second PCA model corresponding to the second sample point. As described herein, the second PCA model corresponding to the second sample point may be created based on a second batch portion of the non-anomalous batches in the industrial process, in which the second batch portion of each non-anomalous batch is generated between the start point of the non-anomalous batch and the second sample point during the non-anomalous batch. If the second sample point is subsequent the first sample point in the batch duration, the second batch portion of each non-anomalous batch may include the first batch portion of the non-anomalous batch and also include one or more samples that are generated between the first sample point and the second sample point during the non-anomalous batch.

According to Equation 17, when determining the anomaly metric corresponding to sample point k of the particular batch in which the particular batch is ongoing, the anomaly detection system 200 may select the highest value between the normalized T²-statistic metric corresponding to sample point k (Tₙₒᵣₘ²(k)) of the particular batch and the normalized Q-statistic metric corresponding to sample point k (Qₙₒᵣₘ(k)) of the particular batch to be the anomaly metric of the particular batch at sample point k. Similar to the T²-statistic metric and the Q-statistic metric of a batch that is complete, the T²-statistic metric corresponding to sample point k (T²(k)) and the Q-statistic metric corresponding to sample point k (Q(k)) of the particular batch that is ongoing may indicate 2 types of variance of the data point corresponding to the particular batch in the PCA model (in this case, such variance is the variance of the data point corresponding to the particular batch at sample point k in the PCA model corresponding to sample point k). Thus, according to Equation 17, the anomaly detection system 200 may select, between the normalized T²-statistic metric corresponding to sample point k (Tₙₒᵣₘ²(k)) of the particular batch and the normalized Q-statistic metric corresponding to sample point k (Qₙₒᵣₘ(k)) of the particular batch, the normalized metric that indicates the larger amount of variation to be the anomaly metric corresponding to sample point k of the particular batch. In other words, the normalized metric that better indicates the variance between the data point corresponding to the particular batch at sample point k and the data points corresponding to the non-anomalous batches at sample point k in the PCA model corresponding to sample point k, and therefore better indicates the inconformity of the particular batch at sample point k with the PCA model corresponding to sample point k, may be selected as the anomaly metric corresponding to sample point k the particular batch or the anomaly metric of the particular batch at sample point k.

Thus, due to the flexibility in selecting which normalized metric to be the anomaly metric of the particular batch at a sample point, the first anomaly metric of the particular batch at the first sample point may be the normalized T²-statistic metric corresponding to the first sample point of the particular batch, while the second anomaly metric of the particular batch at the second sample point may be the normalized Q-statistic metric corresponding to the second sample point of the particular batch. Alternatively, the first anomaly metric of the particular batch at the first sample point may be the normalized Q-statistic metric corresponding to the first sample point of the particular batch, while the second anomaly metric of the particular batch at the second sample point may be the normalized T²-statistic metric corresponding to the second sample point of the particular batch. The normalized T²-statistic metric corresponding to a sample point of the particular batch may be referred to as the normalized T²-statistic metric of the particular batch at the sample point. Similarly, the normalized Q-statistic metric corresponding to the sample point of the particular batch may be referred to as the normalized Q-statistic metric of the particular batch at the sample point.

In some embodiments, the anomaly detection system 200 may generate a visual representation of the anomaly metric for the particular batch based on the anomaly metric of the particular batch at different sample points. For example, when a sample k is collected at a sample point k while the particular batch is ongoing, the sample k may be considered the most recent sample collected for the particular batch. As described herein, the anomaly detection system 200 may determine the anomaly metric of the particular batch at sample point k. The anomaly detection system 200 may then generate or update the visual representation of the anomaly metric of the particular batch to illustrate the anomaly metric of the particular batch from the start point of the particular batch up to the sample point k. The visual representation of the anomaly metric of the particular batch may indicate the anomaly metric of the particular batch at various sample points between the start point of the particular batch and the sample point k at which the sample k is collected. Accordingly, the visual representation of the anomaly metric of the particular batch may indicate a real-time (or substantially real-time or near real-time) trajectory of the anomaly metric of the particular batch while the batch is being generated by the industrial process.

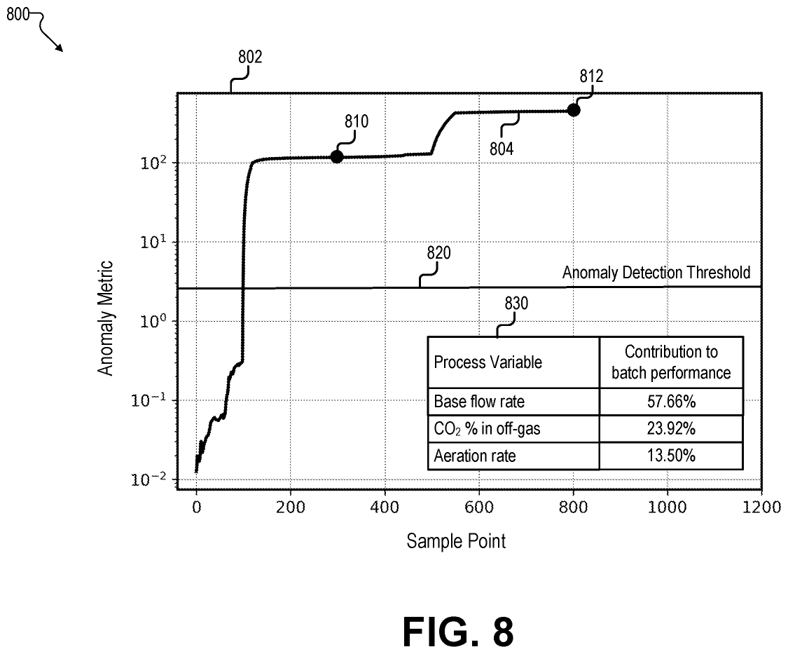

FIG. 8 shows an example user interface 800 including a graph 802 that depicts a visual representation 804 of the anomaly metric of the particular batch. As depicted in FIG. 8, the visual representation 804 may be a line graph illustrating the anomaly metric of the particular batch at various sample points since the start point of the particular batch up to the sample point at which the most recent sample of the particular batch is collected. Thus, the visual representation 804 may indicate the trajectory of the anomaly metric of the particular batch in real-time or near real-time (e.g., due to a relatively low amount of delay caused by data collection and processing). As described above, the anomaly metric of the particular batch at a specific sample point may be flexibly selected between the normalized T²-statistic metric of the particular batch at the sample point and the normalized Q-statistic metric of the particular batch at the sample point. Thus, as depicted in FIG. 8, an anomaly metric 810 of the particular batch at the sample point 300 when the sample 300^{th} of the particular batch is collected may be the normalized T²-statistic metric of the particular batch at the sample point 300, while an anomaly metric 812 of the particular batch at the sample point 800 when the sample 800^{th} of the particular batch is collected may be the normalized Q-statistic metric of the particular batch at the sample point 800. Alternatively, the anomaly metric 810 of the particular batch at the sample point 300 may be the normalized Q-statistic metric of the particular batch at the sample point 300, while the anomaly metric 812 of the particular batch at the sample point 800 may be the normalized T²-statistic metric of the particular batch at the sample point 800.

As depicted in FIG. 8, the graph 802 may also include a threshold line 820 indicating the anomaly detection threshold. As described herein, the anomaly detection threshold may be a predefined threshold value or may be determined based on the machine learning model as described herein with reference to FIGS. 6 and 7. When the visual representation 804 that illustrates the anomaly metric of the particular batch is above the threshold line 820 that indicates the anomaly detection threshold, the anomaly metric of the particular batch may exceed the anomaly detection threshold at one or more sample points in the batch duration, and thus the particular batch may be considered anomalous at these sample points. Thus, the graph 802 that includes the visual representation 804 of the anomaly metric of the particular batch and the threshold line 820 indicating the anomaly detection threshold may facilitate the process operator of the industrial process in monitoring the anomaly of the particular batch in real-time or substantially real-time while the particular batch is being generated by the industrial process.

Accordingly, as described above, when the sample k is collected at the sample point k while the particular batch is ongoing, the anomaly detection system 200 may determine the anomaly metric of the particular batch at sample point k, and determine whether the anomaly metric of the particular batch at sample point k satisfies the anomaly detection threshold. If the anomaly metric of the particular batch at sample point k satisfies the anomaly detection threshold (e.g., the anomaly metric exceeds the anomaly detection threshold), the anomaly detection system 200 may determine that the particular batch at the sample point k, which includes k samples collected from the start point up to the sample point k of the particular batch, does not conform with the PCA model corresponding to sample point k. As described herein, the PCA model corresponding to sample point k may be generated based on a portion of one or more non-anomalous batches, in which the portion of each non-anomalous batch includes k samples collected from the start point up to the sample point k of the non-anomalous batch. As the particular batch at the sample point k does not conform with the PCA model corresponding to sample point k, the anomaly detection system 200 may determine that the particular batch at the sample point k is anomalous or the particular batch is anomalous at the sample point k.

In some embodiments, in response to determining that the particular batch is anomalous at the sample point k, the anomaly detection system 200 may present to the process operator of the industrial process a notification indicating that the particular batch is anomalous at the sample point k. The notification may be an alert notification displayed on the user interface 800 that shows the real-time or near real-time trajectory of the anomaly metric of the particular batch as depicted in FIG. 8. Additionally or alternatively, the notification may be an electronic message being sent to an email address of the process operator, an audio alert that is repeated periodically (e.g., every 2 s) until being manually turned off, and/or other types of notification.

In some embodiments, in response to determining that the particular batch is anomalous at the sample point k, the anomaly detection system 200 may determine a contribution of each process variable of the industrial process to the performance of the particular batch at the sample point k, thereby facilitating the process operator in addressing the anomaly of the particular batch as the particular batch is still ongoing. In some embodiments, to determine the contribution of each process variable to the performance of the particular batch at the sample point k, for each process variable j among J process variables of the industrial process, the anomaly detection system 200 may determine a variable contribution of the process variable j towards the anomaly metric of the particular batch at sample point k. In some embodiments, the variable contribution of the process variable j towards the anomaly metric of the particular batch at sample point k may be the variable contribution of the process variable j towards the pre-normalized anomaly metric (the T²-statistic metric or the Q-statistic metric) of the particular batch at sample point k and may be determined as follows:

$$C ( j , k ) = b * {C}_{{T}^{2}} ( j , k ) + ( 1 - b ) * {C}_{Q} ( j , k ) \qquad ( Equation 18 )$$

$$\{ \begin{matrix}b = 1 & if anomaly metric = {T}_{norm}^{2} ( k ) \\ b = 0 & if anomaly metric = {Q}_{norm} ( k )\end{matrix}$$

Thus, according to Equation 18, if the anomaly metric of the particular batch at sample point k is the normalized T²-statistic metric of the particular batch at sample point k (Tₙₒᵣₘ²(k)), the variable contribution of the process variable j towards the anomaly metric of the particular batch at sample point k may be the variable contribution of the process variable j towards the T²-statistic metric of the particular batch at sample point k (C_{T}_{²}(j, k)). On the other hand, if the anomaly metric of the particular batch at sample point k is the normalized Q-statistic metric of the particular batch at sample point k (Qₙₒᵣₘ(k)), the variable contribution of the process variable j towards the anomaly metric of the particular batch at sample point k may be the variable contribution of the process variable j towards the Q-statistic metric of the particular batch at sample point k (C_{Q}(j, k)).

In some embodiments, the anomaly detection system 200 may determine the variable contribution of the process variable j towards the T²-statistic metric of the particular batch at sample point k as follows:

$${C}_{{T}^{2}} ( j , k ) = {\sum }_{a = 1}^{A} ( {S}_{k , a a}^{- 1} * {t ( k )}_{a} * {x}_{jk} * {P ( k )}_{jk , a} ) ∈ {R}_{1 \times 1} \qquad ( Equation 19 )$$

In Equation 19, A is the number of retained principal components of the PCA model corresponding to sample point k. S⁻¹_{k,aa} is the diagonal element a^{th} in the inverse matrix of the covariance matrix S of the score matrix T(k). The covariance matrix S of the score matrix T(k) may be computed as follows:

$$S = \frac{{T ( k )}^{T} * T ( k )}{I - 1} ∈ {M}_{A \times A} \qquad ( Equation 20 )$$

In Equation 20, I is the number of non-anomalous batches that are used to generate the PCA model corresponding to sample point k and other PCA models of the industrial process as described herein.

Back to Equation 19, t(k)ₐ is the element a^{th} of the score t(k). As described herein, the score t(k) may be computed based on the Equation 5 and may have the following dimensions t(k)∈M_{I×A}. In Equation 19, xⱼₖ is process variable j among J process variables of the sample k. As described herein, the sample k may be collected at the sample point k during the particular batch and may include J process variables of the industrial process that are obtained at the sample point k. In Equation 19, P(k)_{jk,a} is an element of the loading matrix P(k) that is located at the column a and the row (J*(k−1)+j), which corresponds to the process variable j of the sample k in the column a. As described herein, the loading matrix P(k) may represent the PCA model corresponding to sample point k and may have the following dimensions P(k)∈M_{(J*k)×A}. In some embodiments, the anomaly detection system 200 may determine these components and use these components in Equation 19 to compute the variable contribution of the process variable j towards the T²-statistic metric of the particular batch at sample point k.

In some embodiments, the anomaly detection system 200 may determine the variable contribution of the process variable j towards the Q-statistic metric of the particular batch at sample point k as follows:

$${C}_{Q} ( j , k ) = {\sum }_{j = 1}^{J} {e ( k )}_{jk}^{2} ∈ {R}_{1 \times 1} \qquad ( Equation 21 )$$

In Equation 21, J is the number of process variables of the industrial process, and e(k) is the residual error corresponding to sample point k of the particular batch. As described herein, the residual error e(k) may be computed based on the Equation 7 and may have the following dimensions e(k)∈M_{1×jk}. In Equation 21, e(k)ⱼₖ is an element located at column (J*(k−1)+j) of the residual error e(k), which corresponds to the process variable j of the sample k in the residual error e(k). In some embodiments, the anomaly detection system 200 may determine e(k)ⱼₖ and use this component in Equation 21 to compute the variable contribution of the process variable j towards the Q-statistic metric of the particular batch at sample point k.

Thus, the anomaly detection system 200 may use one or more equations among Equations 18-21 to determine the variable contribution of each process variable of the industrial process towards the anomaly metric of the particular batch at sample point k, depending on whether the anomaly metric of the particular batch at sample point k is the normalized T²-statistic metric of the particular batch at sample point k (Tₙₒᵣₘ²(k)) or the normalized Q-statistic metric of the particular batch at sample point k (Qₙₒᵣₘ(k)).

In some embodiments, once the variable contribution of each process variable towards the anomaly metric of the particular batch at sample point k is determined, the anomaly detection system 200 may select one or more particular process variables of the industrial process based on their variable contribution. For example, for each process variable of the industrial process, the anomaly detection system 200 may compute a percentage (or other types of ratio) between the variable contribution of the process variable towards the anomaly metric of the particular batch at sample point k and a sum of the variable contributions of all process variables towards the anomaly metric of the particular batch at sample point k. This percentage may be referred to as the contribution percentage of the process variable towards the anomaly of the particular batch at sample point k.

In some embodiments, the anomaly detection system 200 may select the one or more particular process variables that have their contribution percentage towards the anomaly of the particular batch at sample point k satisfying a contribution percentage threshold (e.g., more than 35%). Additionally or alternatively, the anomaly detection system 200 may select a predefined number of particular process variables (e.g., 5 process variables) that have the highest contribution percentage towards the anomaly of the particular batch at sample point k among various process variables of the industrial process. These particular process variables may have a significant contribution towards the pre-normalized anomaly metric (the T²-statistic metric or the Q-statistic metric) of the particular batch at sample point k and therefore may be a potential cause for the particular batch being anomalous at the sample point k.

In some embodiments, the anomaly detection system 200 may present, to the process operator of the industrial process, the particular process variables of the industrial process as the potential cause of the particular batch being anomalous at the sample point k. For example, as depicted in FIG. 8, the user interface 800 may include a table 830 indicating the process variables that have the highest contribution towards the particular batch being anomalous at the sample point k. The table 830 may also indicate the contribution percentage of each process variable as depicted in FIG. 8. Accordingly, the process operator may reference the table 830 and identify the process variables that can be adjusted to address the anomaly of the particular batch at the sample point k. As a result, the diagnose and the handling of the anomaly of the particular batch at the sample point k may be facilitated.

In some embodiments, to further facilitate the process operator in addressing the anomaly of the particular batch at the sample point k, for each process variable that is determined to be the potential cause of the anomaly of the particular batch at the sample point k, the anomaly detection system 200 may compute an average value of the process variable in one or more non-anomalous batches of the industrial process. The average value of the process variable in the non-anomalous batches may be the average of one or more values of the process variable that are used when the non-anomalous batches are generated. In some embodiments, the anomaly detection system 200 may present to the process operator a recommendation to adjust the industrial process based on the average value of the process variables in the non-anomalous batches. For example, the anomaly detection system 200 may provide to the process operator the average value of the process variable in the non-anomalous batches, and the process operator may adjust the process variable of the industrial process towards the average value. Additionally or alternatively, the anomaly detection system 200 may compute a difference value between a current value of the process variable that is being used to generate the particular batch and the average value of the process variable in the non-anomalous batches. The anomaly detection system 200 may display to the process operator the difference value, and the process operator may adjust the process variable of the industrial process by a delta amount equal to the difference value. [001%] In some embodiments, instead of or in addition to the recommendation to adjust one or more process variables of the industrial process as described above, the anomaly detection system 200 may provide to the process operator a recommendation to terminate the particular batch before the particular batch is complete. For example, when the anomaly detection system 200 determines that the particular batch is anomalous at the sample point k, the anomaly detection system 200 may determine a time distance between the start point of the particular batch and the sample point k, and calculate a percentage (or other types of ratio) between the time distance and the batch duration. This percentage may be referred to as an anomalous time percentage of the particular batch. In some embodiments, the anomaly detection system 200 may determine whether the anomalous time percentage of the particular batch satisfies a time percentage threshold (e.g., more than 75%). If the anomalous time percentage of the particular batch satisfies the time percentage threshold, the anomaly detection system 200 may determine that the time window between the start point of the particular batch and the sample point k accounts for a significant portion of the particular batch and the particular batch at the sample point k, which includes the samples collected during this time window, is determined to be anomalous. Accordingly, the anomaly detection system 200 may determine that a significant portion of the particular batch is likely unusable due to the anomaly of the particular batch at the sample point k. In this case, the anomaly detection system 200 may generate a recommendation to terminate the particular batch prematurely before the particular batch reaches its end point to avoid further wasting production resources on the particular batch. The anomaly detection system 200 may then provide the recommendation to terminate the particular batch to the process operator for consideration.

In some embodiments, instead of providing the recommendation to address the anomaly of the particular batch or to prematurely terminate the particular batch to the process operator, the anomaly detection system 200 may itself address the anomaly of the particular batch or prematurely terminate the particular batch without human intervention. As an example, to address the anomaly of the particular batch, for each process variable that is determined to be the potential cause of the anomaly of the particular batch at the sample point k, the anomaly detection system 200 may automatically adjust the process variable of the industrial process based on the average value of the process variable in the non-anomalous batches. For example, the anomaly detection system 200 may adjust the process variable of the industrial process to be the average value of the process variable in the non-anomalous batches. As another example, when the anomaly detection system 200 determines that the anomalous time percentage of the particular batch satisfies the time percentage threshold (e.g., more than 75%), the anomaly detection system 200 may automatically terminate the particular batch without waiting for the particular batch to finish at its end point. The anomaly detection system 200 may also perform other operations to address the anomaly of the particular batch or to terminate the particular batch in response to determining that the particular batch is anomalous at a sample point while the particular batch is ongoing.

In addition to the systems and methods for anomaly detection in industrial batch analytics described above, the present disclosure also describes systems and methods for synchronizing multiple batches in industrial batch analytics.

As described herein, the industrial process may generate multiple batches. For each batch generated in the industrial process, multiple samples may be collected during the batch at a predefined interval (e.g., every 3 s). As batch durations of the batches may vary, the number of samples collected during the batch may be different between batches.

As an example, when a process operator sets up operations for the industrial process, the process operator may specify a batch termination condition at which a batch may be terminated. For example, the process operator may specify that the batch may be terminated when an amount of product generated during the batch reaches a predefined amount (e.g., 5 kg). Additionally or alternatively, the process operator may specify that the batch may be terminated when a particular parameter associated with the batch satisfies a predefined threshold (e.g., the acid flow rate is higher than 3 gpm). Due to various factors that impact the industrial process (e.g., material quality, unstable speed of chemical reaction, etc.), different batches may satisfy the batch termination condition at different time since their start point and therefore different batches may have different batch durations. As the batches have different batch durations and the samples are collected for each batch at the predefined interval (e.g., every 3 s), the batches may include one or more batches that have a different number of samples in each batch.

However, batch analytic operations such as the anomaly detection operations described herein may only be performed using the batches generated by the industrial process that include the same number of samples in each batch. Similarly, machine learning models that are trained and used to perform anomaly detection and/or other batch analytics may operate only with the batches generated by the industrial process that include the same number of samples in each batch. Using the batches that include one or more batches having a different number of samples in each batch to perform the batch analytic operations may result in excessive focus on long batches as compared to short batches in the analytic results, and therefore the analytic results may be inaccurate. Similarly, using the batches that include one or more batches having a different number of samples in each batch to train a machine learning model may result in overweighting of the long batches as compared to the short batches in adjusting the model parameters of the machine learning model. As a result, the machine learning model may be bias and therefore an analytic result generated by the machine learning model for an input batch may be inaccurate, especially when the number of samples in the input batch is significantly higher than or significantly lower than the number of samples in the batches that are used to train the machine learning model.

To avoid the negative impacts when the batches that include one or more batches having a different number of samples in each batch are used to train the machine learning model, some systems may train the machine learning model with only batches that include the same number of samples in each batch. In this case, an informative batch that does not include this number of samples but include a different number of samples in the batch may not be used to train the machine learning model. As a result, the machine learning model may not be optimally trained and therefore the analytic results generated by the machine learning model may be inaccurate or unreliable.

The systems and methods described herein are capable of synchronizing multiple batches generated by an industrial process. In particular, the systems and methods may generate a plurality of batch representations for a plurality of batches such that the batch representations of the batches may have the same size even though the plurality of batches may include one or more batches that have a different number of samples in each batch and therefore have different batch lengths. In some embodiments, for a batch that is complete or finished, a batch length of the batch may equal to a number of samples collected during the entire batch. For a batch that is ongoing and not yet finished, a batch length of the batch at a sample point k during the batch may equal to a number of samples collected from a start point of the batch up to the sample point k during the batch. In some embodiments, the systems and methods may generate a batch representation of a batch in the form of a batch vector that includes one row and multiple columns, and the batch vectors generated for different batches may have the same dimensions regardless of the batch lengths of these batches. In some embodiments, the batch representations of the batches generated by the systems and methods may be used in the operations of an anomaly detection system and/or a machine learning model that are implemented by a batch analytic system to detect anomaly and/or to perform other batch analytics for the batches.

In some embodiments, the systems and methods described herein may generate a batch representation for a batch using a Dynamic Time Warping (DTW) technique. For example, to generate a batch representation for a batch generated in the industrial process that is already complete, the systems and methods may receive batch data of the batch. The batch data of the batch may include a set of samples associated with the batch and the batch may have a first batch length. As the batch is already complete, the first batch length may equal to a number of samples collected during the entire batch.

In some embodiments, the systems and methods may determine a reference batch based on a plurality of non-anomalous batches generated in the industrial process. Each non-anomalous batch may be verified as not including an anomaly throughout a batch duration of the non-anomalous batch and may have a same second batch length. The second batch length may equal to a number of samples collected during each non-anomalous batch.

In some embodiments, the systems and methods may generate a batch representation of the batch based on the batch data of the batch and the reference batch. For example, the systems and methods may determine a Dynamic Time Warping (DTW) matrix between a first sequence including a set of samples associated with the batch and a second sequence including a set of samples associated with the reference batch, and determine the batch representation of the batch based on the DTW matrix in which the batch representation of the batch may align with the reference batch and may have the second batch length associated with the reference batch. Thus, the systems and methods may synchronize the batch with the reference batch, thereby generating the batch representation of the batch that is align with the reference batch and has the same second batch length as the reference batch.

In some embodiments, the systems and methods may perform an operation using the batch representation of the batch. For example, the systems and methods may generate one or more principal component analysis (PCA) models of the industrial process using the batch representation of the batch and/or train one or more machine learning models using the batch representation of the batch. Additionally or alternatively, the systems and methods may determine an anomaly metric of the batch using the batch representation of the batch and a PCA model of the industrial process and/or provide the batch representation of the batch to a machine learning model as an input. The systems and methods may also use the batch representation of the batch to perform other operations.

The systems and methods described herein may be advantageous in a number of technical respects. For example, as described herein, the systems and methods may synchronize the batch with the reference batch, thereby generating the batch representation of the batch that aligns with the reference batch and has the same second batch length as the reference batch. As described herein, the systems and methods may determine the reference batch based on the plurality of non-anomalous batches generated in the industrial process. For example, the systems and methods may determine the reference batch to be an average batch of the plurality of non-anomalous batches. Additionally or alternatively, the systems and methods may select the reference batch from the plurality of non-anomalous batches based on batch scores of the plurality of non-anomalous batches that indicate quality of the plurality of non-anomalous batches. As described herein, the systems and methods may also re-determine the reference batch when additional non-anomalous batches generated in the industrial process are identified. Thus, the systems and methods may determine the reference batch that is indicative of the non-anomalous batches generated in the industrial process and may re-determine the reference batch as the industrial process continues.

Accordingly, as the systems and methods synchronize one or more batches generated in the industrial process with the reference batch, the systems and methods may obtain one or more batch representations of the one or more batches that have the same second batch length as the reference batch. The systems and methods may then use the batch representations of the one or more batches in performing batch analytic operations for the one or more batches, thereby eliminating the negative impacts caused by a different number of samples included in different batches on the analytic results of the batch analytic operations. In addition, as the batch representations of the one or more batches align with the reference batch that is indicative of non-anomalous batches recently generated in the industrial process, the accuracy of the batch analytic operations (e.g., the anomaly detection operations) performed for the one or more batches using the batch representations of the one or more batches may increase.

As described herein, in addition to or instead of generating a batch representation for a batch that is already complete, the systems and methods described herein may generate a batch representation for a batch that is ongoing using the DTW technique. To generate a batch representation for a batch generated in the industrial process that is ongoing, the systems and methods may receive batch data of the batch. The batch data of the batch may include a set of samples associated with the batch at a sample point during the batch and the batch may have a first batch length at the sample point. As the batch is ongoing, the first batch length may equal to a number of samples collected from a start point of the batch up to the sample point during the batch.

In some embodiments, the systems and methods may generate a batch representation corresponding to the sample point of the batch based on the batch data of the batch and the reference batch. As described above, the reference batch may be determined based on the plurality of non-anomalous batches generated in the industrial process and may have the second batch length. To generate the batch representation corresponding to the sample point of the batch, the systems and methods may use a first DTW matrix and a second DTW matrix in which the second DTW matrix may be determined based on the first DTW matrix. For example, the systems and methods may determine the first DTW matrix between a first sequence including the set of samples associated with the batch at the sample point and a second sequence including a set of samples associated with the reference batch. The systems and methods may also determine the second DTW matrix between the first sequence including the set of samples associated with the batch at the sample point and a third sequence including a set of samples associated with a batch portion of the reference batch. The second DTW matrix may be a portion of the first DTW matrix.

In some embodiments, the systems and methods may determine the batch representation corresponding to the sample point of the batch based on the second DTW matrix in which the batch representation corresponding to the sample point of the batch may align with the batch portion of the reference batch and may have a third batch length associated with the batch portion of the reference batch. Thus, the systems and methods may synchronize the batch with the batch portion of the reference batch, thereby generating the batch representation corresponding to the sample point of the batch that aligns with the batch portion of the reference batch and has the same third batch length as the batch portion of the reference batch.

In some embodiments, the systems and methods may perform an operation using the batch representation corresponding to the sample point of the batch. For example, the systems and methods may determine an anomaly metric corresponding to the sample point of the batch using the batch representation corresponding to the sample point of the batch. The systems and methods may also use the batch representation of the batch to perform other operations.

The systems and methods described herein may be advantageous in a number of technical respects. For example, the systems and methods may determine the second DTW matrix based on the first DTW matrix, and the second DTW matrix may then be used to determine the batch representation corresponding to the sample point of the batch as described above. In some embodiments, to determine the second DTW matrix, the systems and methods may determine a reference sample point during the reference batch in which the batch at the sample point has the lowest distance or the lowest level of difference with the reference batch at the reference sample point as compared to the reference batch at other sample points during the reference batch. The systems and methods may then identify a portion of the first DTW matrix that corresponds to the reference sample point, and determine the second DTW matrix to be the identified portion of the first DTW matrix. Thus, the systems and methods may determine the second DTW matrix based on the first DTW matrix without computing each element of the second DTW matrix. As a result, the amount of computation to determine the second DTW matrix may be significantly reduced, and therefore the efficiency in determining the batch representation corresponding to the sample point of the batch may be improved.

In addition, the systems and methods may determine the first DTW matrix based on a different DTW matrix that is previously computed for the batch. For example, to determine the first DTW matrix between the first sequence including the set of samples associated with the batch at the sample point and the second sequence including the set of samples associated with the reference batch, the systems and methods may use a different DTW matrix between a different sequence including a set of samples associated with the batch at a previous sample point prior to the sample point and the second sequence including the set of samples associated with the reference batch. In particular, the systems and methods may include the different DTW matrix as a portion of the first DTW matrix. The systems and methods may identify one or more samples of the batch that are not included in the set of samples associated with the batch at the previous sample point prior to the sample point but are included in the set of samples associated with the batch at the sample point. For each identified sample of the batch, the systems and methods may compute one or more elements of the first DTW matrix that correspond to the identified sample of the batch based on the identified sample of the batch, the set of samples associated with the reference batch, and the portion of the first DTW matrix matching the different DTW matrix. The systems and methods may update the first DTW matrix to include the one or more elements corresponding to the identified sample of the batch in the first DTW matrix.

Thus, the systems and methods may determine the first DTW matrix based on the different DTW matrix without computing each element of the first DTW matrix. Instead, the systems and methods may only compute the elements of the first DTW matrix that correspond to the samples included in the set of samples associated with the batch at the sample point but not included in the set of samples associated with the batch at the previous sample point prior to the sample point. As a result, the amount of computation in determining the first DTW matrix may be significantly reduced, and therefore the efficiency in determining the batch representation corresponding to the sample point of the batch may be improved.

As described herein, instead of or in addition to the DTW technique described above, the systems and methods described herein may use other techniques to generate a batch representations for a batch such that the batch representations of a plurality of batches may have the same size even though the plurality of batches may include one or more batches that have different number of samples in each batch. For example, the systems and methods may use one or more feature functions (also referred to herein as functions) to generate a batch representation of a batch that is already complete. To generate a batch representation of a batch generated in the industrial process that is already complete, the systems and methods may receive batch data of the batch. The batch data of the batch may include K samples collected during the batch and each sample may include J values corresponding to J process variables of the industrial process.

In some embodiments, the systems and methods may generate the batch representation of the batch using a first function. For example, for each process variable among J process variables of the industrial process, the systems and methods may apply the first function to K values of the process variable in K samples of the batch to determine a first feature value of the process variable for the batch. The systems and methods may then aggregate J first feature values corresponding to J process variables that are determined for the batch using the first function to form the batch representation of the batch.

Additionally or alternatively, the systems and methods may generate the batch representation of the batch using multiple functions. For example, for each process variable among J process variables of the industrial process, the systems and methods may apply a second function that is different from the first function to K values of the process variable in K samples of the batch to determine a second feature value of the process variable for the batch. The systems and methods may then aggregate J first feature values corresponding to J process variables that are determined for the batch using the first function and J second feature values corresponding to J process variables that are determined for the batch using the second function to form the batch representation of the batch.

In some embodiments, the systems and methods may perform an operation using the batch representation of the batch. For example, the systems and methods may generate one or more principal component analysis (PCA) models of the industrial process using the batch representation of the batch and/or train one or more machine learning models using the batch representation of the batch. Additionally or alternatively, the systems and methods may determine an anomaly metric of the batch using the batch representation of the batch and a PCA model of the industrial process and/or provide the batch representation of the batch to a machine learning model as an input. The systems and methods may also use the batch representation of the batch to perform other operations.

The systems and methods described herein may be advantageous in a number of technical respects. For example, as described herein, the systems and methods may use multiple functions (e.g., Z functions) to generate the batch representation of the batch. For each function among Z functions and for each process variable among J process variables of the industrial process, the systems and methods may apply the function to K values of the process variable in K samples of the batch to determine a feature value of the process variable for the batch using the function as described above. Accordingly, regardless of the number of samples included in the batch, the values of the process variable in all samples of the batch may be used to determine one feature value of the process variable for the batch using the function. Thus, for each function among Z functions, the systems and methods may determine J feature values corresponding to J process variables for the batch using the function. As these feature values may be aggregated to form the batch representation of the batch, the batch representation of the batch may include Z sets of feature values respectively determined for the batch using Z functions, in which each set of feature values may include J feature values corresponding to J process variables that are determined for the batch using a function among Z functions. As a result, the batch representation of the batch may be a batch vector that has the dimensions of M_{1×ZJ}.

Thus, regardless of the number of samples in the batch, the batch may be represented by the batch vector that includes one row and Z*J columns, in which Z is the number of functions being used to determine different feature values of each process variable for the batch, and J is the number of process variables associated with the industrial process and equals to the number of values in each sample. Accordingly, the batch representations generated for different batches may have the same size (e.g., M_{1×ZJ}) even though these batches may include one or more batches that have a different number of samples in each batch. In other words, the different batches may be synchronized.

In addition, the systems and methods may selectively identify one or more functions to be included in Z functions being used to generate a batch representation of a batch. The one or more functions may be selected based on nature of a process variable in the industrial process. For example, the systems and methods may determine the variable trajectories of the process variable in a plurality of batches generated in the industrial process. The variable trajectory of the process variable in a batch may be determined based on the values of the process variable in the samples collected during the batch and may be generated in the form of a line graph that indicates the pattern or the course in which the values of the process variable change over time during the batch. The systems and methods may determine that even though the plurality of batches include a different number of samples in each batch, the variable trajectories of the process variable in the plurality of batches have the same shape. Accordingly, the systems and methods may determine a variable pattern of the process variable based on the same shape of the variable trajectories of the process variable. For example, the systems and methods may determine that the variable trajectories of the process variable have a bell shape of Gaussian distribution both in long batches and in short batches, and therefore determine that the variable pattern of the process variable is the Gaussian distribution. The systems and methods may select one or more functions that determine one or more attributes associated with the variable pattern of the process variable (e.g., the mean function, the standard deviation function, the skewness function, etc. that determine attributes associated with Gaussian distribution may be selected) and include the one or more functions in Z functions being applied to the batch data of the batch when determining the batch representation of the batch. Thus, the systems and methods may flexibly select one or more functions being used to determine the batch representation of the batch based on characteristics of the process variable, and therefore the elements corresponding to the one or more functions and the process variable in the batch representation of the batch may provide descriptive information about the values of the process variable in the batch.

In some embodiments, the systems and methods may indicate the elements corresponding to the one or more functions and the process variable in the batch representation of the batch as anomaly detection features associated with the process variable in the batch representation of the batch. The systems and methods may determine an anomaly of the batch based on these anomaly detection features. For example, the systems and methods may compare the anomaly detection features associated with the process variable in the batch representation of the batch and in the batch representations of non-anomalous batches. Based on such comparison, the systems and methods may evaluate the difference between the variable trajectory of the process variable in the batch that follows the variable pattern (e.g., the Gaussian distribution) and the variable trajectories of the process variable in the non-anomalous batches that also follow the variable pattern (e.g., the Gaussian distribution) and determine whether the batch is anomalous accordingly.

Additionally or alternatively, the systems and methods may implement a machine learning mode to perform a batch analytic operation such as an anomaly detection operation for the batches generated in the industrial process. The systems and methods may configure the machine learning model to assign higher weight values to the elements that correspond to the one or more functions and the process variable as compared to other elements in a batch representation of each batch. Accordingly, the machine learning model may consider these elements with higher weight values when determining whether a batch is anomalous using the batch representation of the batch, thereby improving the accuracy of the machine learning model in anomaly detection. Thus, by considering the elements corresponding to the process variable and the one or more functions that are selected based on the characteristics of the process variable, the systems and methods may effectively determine an anomaly of a batch with a high level of accuracy.

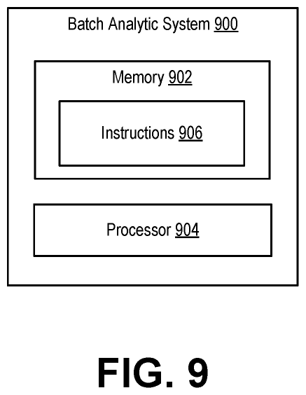

The systems and methods for synchronizing multiple batches generated in an industrial process as described herein may be implemented by a batch analytic system. An example batch analytic system 900 is illustrated in FIG. 9. In some embodiments, the batch analytic system 900 may be implemented by computing resources such as servers, processors, memory devices, storage devices, communication interfaces, and/or other computing resources. In some embodiments, the batch analytic system 900 may be implemented at the edge device 130, the cloud platform 102, and/or other components of the system 100. In some embodiments, various components of the system 100 may collaborate with one another to perform one or more functionalities of the batch analytic system 900.

In some embodiments, the batch analytic system 900 may include the anomaly detection system 200 described herein. For example, the anomaly detection system 200 may be integrated into the batch analytic system 900 and may operate as part of the batch analytic system 900. Additionally or alternatively, the batch analytic system 900 may be configured to perform one or more operations of the anomaly detection system 200 described herein. Accordingly, the batch analytic system 900 may be capable of performing not only the batch synchronization operations described herein to generate a batch representation of a batch but also capable of performing the anomaly detection operations described herein to determine whether the batch is anomalous. The batch analytic system 900 may also be configured to perform other batch analytic operations and/or other functionalities described herein.

As depicted in FIG. 9, the batch analytic system 900 may include, without limitation, a memory 902 and a processor 904 communicatively coupled to one another. The memory 902 and the processor 904 may each include or be implemented by computer hardware that is configured to store and/or execute computer software. Other components of computer hardware and/or software not explicitly shown in FIG. 9 may also be included within the batch analytic system 900. In some embodiments, the memory 902 and the processor 904 may be distributed between multiple devices and/or multiple locations as may serve a particular implementation.

The memory 902 may store and/or otherwise maintain executable data used by the processor 904 to perform one or more functionalities of the batch analytic system 900 described herein. For example, the memory 902 may store instructions 906 that may be executed by the processor 904. In some embodiments, the memory 902 may be implemented by one or more memory or storage devices, including any memory or storage devices described herein, that are configured to store data in a transitory or non-transitory manner. In some embodiments, the instructions 906 may be executed by the processor 904 to cause the batch analytic system 900 to perform one or more functionalities described herein. The instructions 906 may be implemented by any suitable application, software, code, and/or other executable data instance. Additionally, the memory 902 may also maintain any other data accessed, managed, used, and/or transmitted by the processor 904 in a particular implementation.

The processor 904 may be implemented by one or more computer processing devices, including general purpose processors (e.g., central processing units (CPUs), graphics processing units (GPUs), microprocessors, etc.), special purpose processors (e.g., application specific integrated circuits (ASICs), field-programmable gate arrays (FPGAs), etc.), or the like. The batch analytic system 900 may use the processor 904 (e.g., when the processor 904 is directed to perform operations represented by instructions 906 stored in the memory 902) and perform various functionalities associated with batch synchronization and/or anomaly detection for a batch in any manner described herein or as may serve a particular implementation.

In some embodiments, the batch analytic system 900 may generate a batch representation for a particular batch using a Dynamic Time Warping (DTW) technique. For example, for a particular batch that is already complete or finished, the batch analytic system 900 may apply the DTW technique to synchronize the particular batch with a reference batch, thereby generating a batch representation of the particular batch that aligns with the reference batch and has the same batch length as the reference batch. As another example, for a particular batch that is ongoing and not yet finished, the batch analytic system 900 may apply the DTW technique to synchronize the particular batch at a sample point during the batch with a portion of the reference batch, thereby generating a batch representation corresponding to the sample point of the particular batch that aligns with the portion of the reference batch and has the same batch length as the portion of the reference batch.

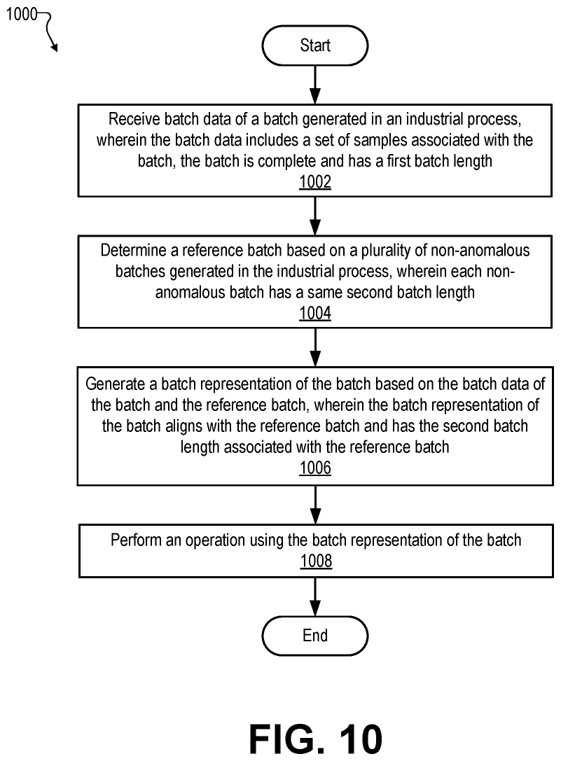

FIG. 10 illustrates an example batch synchronization method 1000 (e.g., the method 1000) for performing batch synchronization using the DTW technique to generate a batch representation for a particular batch that is already complete. While FIG. 10 shows illustrative operations according to one embodiment, other embodiments may omit, add to, reorder, and/or modify any of the operations shown in FIG. 10. In some examples, multiple operations shown in FIG. 10 or described in relation to FIG. 10 may be performed concurrently (e.g., in parallel) with one another, rather than being performed sequentially as illustrated and/or described. One or more of the operations shown in FIG. 10 may be performed by a batch analytic system such as the batch analytic system 900 and/or any implementation thereof.

At operation 1002, the batch analytic system 900 may receive batch data of a particular batch generated in an industrial process. The batch data may include a set of samples associated with the particular batch. The particular batch may be complete or finished and may have a first batch length. In some embodiments, the first batch length may equal to a number of samples (e.g., N samples) in the set of samples associated with the particular batch. As the particular batch is already complete, the set of samples associated with the particular batch may include all samples generated during the entire particular batch.

At operation 1004, the batch analytic system 900 may determine a reference batch based on a plurality of non-anomalous batches generated in the industrial process. Each non-anomalous batch may be complete or finished and may be verified as not including an anomaly throughout a batch duration of the non-anomalous batch. In some embodiments, the batch analytic system 900 may identify the plurality of non-anomalous batches generated in the industrial process in which each non-anomalous batch may include the same number of samples (e.g., M samples). Thus, each non-anomalous batch may have a same second batch length that is equal to the number of samples (e.g., M samples) collected during each non-anomalous batch. In some embodiments, the reference batch determined based on the plurality of non-anomalous batches may include the same number of samples (e.g., M samples) as each non-anomalous batch in the plurality of non-anomalous batches, and therefore the reference batch may also have the second batch length.

At operation 1006, the batch analytic system 900 may generate a batch representation of the particular batch based on the batch data of the particular batch and the reference batch in which the batch representation of the particular batch may align with the reference batch and may have the second batch length associated with the reference batch. In some embodiments, the batch representation of the particular batch may include the same number of samples (e.g., M samples) as the reference batch, and therefore the batch representation of the particular batch may have the same second batch length as the reference batch. In some embodiments, the batch representation of the particular batch may not only have the same batch length as the reference batch but also align with the reference batch. The batch representation of the particular batch may be considered aligning with the reference batch when the shape of each variable trajectory corresponding to each process variable of the particular batch is substantially preserved (e.g., the shape of a variable trajectory of a process variable generated based on the samples collected during the particular batch and the shape of a variable trajectory of the process variable generated based on the samples in the batch representation of the particular batch are substantially similar) and the landmarks (e.g., the local maximum points, the local minimum points, the trend reverse points, etc.) in each variable trajectory generated based on the samples in the batch representation of the particular batch coincide or align with the corresponding landmarks in a corresponding variable trajectory generated based on the samples in the reference batch.

At operation 1008, the batch analytic system 900 may perform an operation using the batch representation of the particular batch. For example, the batch analytic system 900 may generate one or more PCA models of the industrial process using the batch representation of the particular batch and/or train one or more machine learning models using the batch representation of the particular batch as a training example. Additionally or alternatively, the batch analytic system 900 may determine an anomaly metric of the particular batch using the batch representation of the particular batch and a PCA model of the industrial process and/or provide the batch representation of the particular batch to a machine learning model as an input. The batch analytic system 900 may also use the batch representation of the particular batch to perform other operations.

Thus, as described above, the batch analytic system 900 may generate the batch representation of the particular batch based on the batch data of the particular batch and the reference batch. The batch analytic system 900 may determine the reference batch based on the plurality of non-anomalous batches generated in the industrial process in which each non-anomalous batch may include the same number of samples and have the same second batch length. In some embodiments, the samples in each non-anomalous batch may be respectively collected at one or more sample points. As described herein, each sample point may be considered a reference point in the batch duration and may indicate a point in time at which a particular sample of a batch is collected relative to a start point of that batch. For example, the samples of each batch may be collected at the predefined interval (e.g., every 3 seconds). At a sample point k during a first batch, a sample k^{th} of the first batch may be collected. Similarly, at the sample point k during a second batch, a sample k^{th} of the second batch may be collected. A time distance between the sample point k during the first batch and the start point of the first batch (e.g., 3*k seconds) may equal to a time distance between the sample point k during the second batch and the start point of the second batch (e.g., 3*k seconds). In some embodiments, the sample of the first batch that is collected at the sample point k during the first batch may be considered the sample corresponding to the sample point k in the first batch, the sample of the second batch that is collected at the sample point k during the second batch may be considered the sample corresponding to the sample point k in the second batch, and these samples may be considered corresponding to one another.

In some embodiments, each non-anomalous batch among the plurality of non-anomalous batches that are used to determine the reference batch may include the same number samples and have the same second batch length as described above. Accordingly, for each sample point in the batch duration of these non-anomalous batches, each non-anomalous batch may include a sample being collected at the sample point during the non-anomalous batch and that sample may be considered the sample corresponding to the sample point in the non-anomalous batch as described above. In some embodiments, for each sample point at which a sample in a non-anomalous batch is collected, the reference batch may include a sample corresponding to the sample point. Accordingly, the reference batch may include one or more samples corresponding to one or more sample points at which the samples of a non-anomalous batch are respectively collected. Thus, the reference batch may include the same number of samples as each non-anomalous batch and may have the same second batch length as each non-anomalous batch. In some embodiments, the sample corresponding to the sample point k in the reference batch and the sample corresponding to the sample point k in each non-anomalous batch may be considered corresponding to one another.

In some embodiments, to determine the reference batch, for each sample point k at which a sample of a non-anomalous batch is collected, the batch analytic system 900 may identify a plurality of samples corresponding to the sample point k in the plurality of non-anomalous batches, and determine a sample corresponding to the sample point k for the reference batch based on the plurality of samples corresponding to the sample point k in the plurality of non-anomalous batches.

In some embodiments, to determine the sample corresponding to the sample point k in the reference batch, for each process variable of the industrial process, the batch analytic system 900 may determine an average value of the process variable in the plurality of samples corresponding to the sample point k in the plurality of non-anomalous batches. For example, the batch analytic system 900 may obtain a value of the process variable in the sample corresponding to the sample point k of each non-anomalous batch, and compute an average value of these values of the process variable. The batch analytic system 900 may then determine the value of the process variable in the sample corresponding to the sample point k of the reference batch to be the computed average value. Thus, in this case, the sample corresponding to the sample point k in the reference batch may be considered an average sample of the samples corresponding to the sample point k in the plurality of non-anomalous batches. Accordingly, the reference batch may be considered an average batch of the plurality of non-anomalous batches.

Additionally or alternatively, to determine the reference batch, the batch analytic system 900 may determine one or more batch parameters of each non-anomalous batch among the plurality of non-anomalous batches. In some embodiments, the batch parameters of a non-anomalous batch may include one or more parameters that can be used to evaluate the quality of the non-anomalous batch. For example, the batch parameters of the non-anomalous batch may include an average value of a particular process variable (e.g., an acid flow rate) in the non-anomalous batch. To determine the average value of the particular process variable in the non-anomalous batch, the batch analytic system 900 may obtain a value of the particular process variable in each sample of the non-anomalous batch, and compute an average value of these values of the particular process variable. The batch analytic system 900 may then determine the average value of the particular process variable in the non-anomalous batch to be the computed average value.

In some embodiments, the batch parameters of the non-anomalous batch may also include a production rate of the non-anomalous batch. The production rate of the non-anomalous batch may indicate a speed at which the products are generated during the non-anomalous batch. In some embodiments, to determine the production rate of the non-anomalous batch, the batch analytic system 900 may compute a ratio between a total amount of products generated during the non-anomalous batch and a batch duration of the non-anomalous batch, and determine the production rate of the non-anomalous batch to be the ratio. Other batch parameters of the non-anomalous batch are also possible and contemplated. In some embodiments, each batch parameter of the non-anomalous batch may be assigned a predefined weight value.

In some embodiments, the batch analytic system 900 may compute a batch score of each non-anomalous batch based on the batch parameters of the non-anomalous batch and the weight values of the batch parameters. For example, the batch analytic system 900 may compute a product value of each batch parameter and its weight value, and compute a sum value of these product values to be the batch score of the non-anomalous batch. In some embodiments, the batch analytic system 900 may select the reference batch from the plurality of non-anomalous batches based on the batch scores of the plurality of non-anomalous batches. For example, the batch analytic system 900 may select the non-anomalous batch that has the highest batch score among the plurality of non-anomalous batches to be the reference batch. Thus, in this case, the non-anomalous batch that has the highest quality among the plurality of non-anomalous batches may be selected to be the reference batch. Other implementations for determining the reference batch based on the plurality of non-anomalous batches are also possible and contemplated.

In some embodiments, as the industrial process continues and generates more batches, the batch analytic system 900 may identify one or more additional non-anomalous batches that are generated subsequent to the plurality of non-anomalous batches in the industrial process, and re-determine the reference batch based at least on the additional non-anomalous batches in the manner described above. In some embodiments, the batch analytic system 900 may re-determine the reference batch using only the additional non-anomalous batches. In this case, each additional non-anomalous batch in the one or more additional non-anomalous batches may have the same number of samples as one another, and the number of samples in each additional non-anomalous batch may or may not equal to the number of samples in each non-anomalous batch among the plurality of non-anomalous batches previously used to determine the reference batch. Additionally or alternatively, the batch analytic system 900 may re-determine the reference batch using the additional non-anomalous batches and one or more non-anomalous batches in the plurality of non-anomalous batches previously used to determine the reference batch. In this case, each additional non-anomalous batch in the one or more additional non-anomalous batches may have the same number of samples as one another, and the number of samples in each additional non-anomalous batch may equal to the number of samples in each non-anomalous batch among the plurality of non-anomalous batches previously used to determine the reference batch. In some embodiments, the batch analytic system 900 may re-determine the reference batch at a predefined interval (e.g., every 4 days).

In some embodiments, once the reference batch is determined, the batch analytic system 900 may perform a batch synchronization operation to synchronize the particular batch with the reference batch using the DTW technique. As described herein, the particular batch may include N samples collected at N sample points and have the first batch length, while the reference batch may include M samples corresponding to M sample points and have the second batch length. As a result of the batch synchronization operation, the batch analytic system 900 may generate a batch representation for the particular batch based on N samples of the particular batch such that the batch representation of the particular batch may include M samples corresponding to M sample points and have the second batch length. The batch representation of the particular batch may also align with the reference batch. In some embodiments, each sample in the particular batch and each sample in the reference batch may include J values corresponding to J process variables of the industrial process.

In some embodiments, to synchronize the particular batch and the reference batch, the batch analytic system 900 may perform a scaling operation on the particular batch and the reference batch. For example, for each process variable of the industrial process, the batch analytic system 900 may determine an average length of value range associated with the process variable based on the plurality of non-anomalous batches that are used to generate the reference batch. In particular, for each non-anomalous batch in the plurality of non-anomalous batches, the batch analytic system 900 may determine a maximum value and a minimum value of the process variable in the samples of the non-anomalous batch, and determine a length of value range associated with the process variable in the non-anomalous batch to be the difference between the maximum value and the minimum value. The batch analytic system 900 may then compute an average value of these lengths of value range determined for the process variable in the plurality of non-anomalous batches, and determine the average length of value range associated with the process variable to be the computed average value.

In some embodiments, for each sample in the particular batch and for each sample in the reference batch, the batch analytic system 900 may divide the value of each process variable in the sample by the corresponding average length of value range associated with the process variable. Due to this scaling operation, the batch analytic system 900 may eliminate different variable units of the process variables (e.g., variable unit “° C.” of the process variable “temperature,” variable unit “Pa” of the process variable “pressure,” etc.) and also eliminate impacts caused by different value ranges of the process variables on DTW operations.

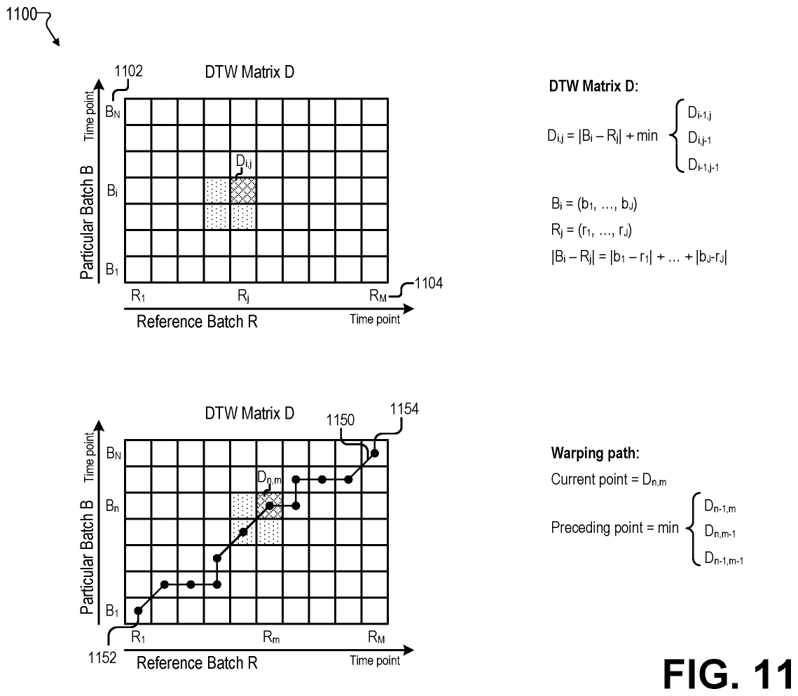

In some embodiments, after the particular batch and the reference batch are subjected to the scaling operation, the batch analytic system 900 may perform a DTW operation for the particular batch and the reference batch. An example DTW operation performed for the particular batch and the reference batch is illustrated in diagram 1100 of FIG. 11. As depicted in FIG. 11, the batch analytic system 900 may generate a first sequence 1102 including the set of samples associated with the particular batch. Thus, the first sequence 1102 may represent the particular batch and may include N samples (e.g., a sample B₁ to a sample B_{N}) of the particular batch that are arranged in a chronological order of their sample points. Similarly, the batch analytic system 900 may generate a second sequence 1104 including the set of samples associated with the reference batch. Thus, the second sequence 1104 may represent the reference batch and may include M samples (e.g., a sample R₁ to a sample R_{M}) of the reference batch that are arranged in a chronological order of their sample points. Accordingly, the first sequence 1102 may have the first batch length of the particular batch (e.g., N samples) and the second sequence 1104 may have the second batch length of the reference batch (e.g., M samples).

In some embodiments, the batch analytic system 900 may determine a DTW matrix D between the first sequence 1102 associated with the particular batch and the second sequence 1104 associated with the reference batch. The DTW matrix D may also be referred to as the DTW matrix between the particular batch and the reference batch. As depicted in FIG. 11, an element D_{i,j} of the DTW matrix D may correspond to a sample B; of the particular batch and a sample Rⱼ of the reference batch. The sample Bᵢ may correspond to the sample point i and may be collected at the sample point i during the particular batch. The sample Rⱼ may correspond to the sample point j and may be collected at the sample point j during the reference batch or may be determined using the samples corresponding to the sample point j in the plurality of non-anomalous batches as described herein. In some embodiments, the batch analytic system 900 may determine the element D_{i,j} of the DTW matrix D based on the sample Bᵢ of the particular batch and the sample Rⱼ of the reference batch as follows:

$${D}_{iji} = \vert {B}_{i} - {R}_{j} \vert + min \{ \begin{matrix}{D}_{i - 1 , j} \\ {D}_{i , j - 1} \\ {D}_{i - 1 , j - 1}\end{matrix} \qquad ( Equation 22 )$$

In Equation 22, the sample Bᵢ of the particular batch and the sample Rⱼ the reference batch may each include J values corresponding to J process variables of the industrial process as described herein. Thus, the sample Bᵢ of the particular batch and the sample Rⱼ the reference batch may have the following dimensions:

$${B}_{i} = ( {b}_{1} , … , {b}_{J} ) ∈ {M}_{1 \times J}$$

$${R}_{j} = ( {r}_{1} , … , {r}_{J} ) ∈ {M}_{1 \times J}$$

In Equation 22, the component |Bᵢ−Rⱼ| may be computed as follows:

$$\vert {B}_{i} - {R}_{j} \vert = {\sum }_{a = 1}^{J} \vert {b}_{a} - {r}_{a} \vert \qquad ( Equation 23 )$$

Thus, according to Equations 22 and 23, the element D_{i,j} of the DTW matrix D may indicate the cumulative distance between B_{[1:i]}, which includes i samples of the particular batch at the sample point i and represents the particular batch at the sample point i, and R_{[1:j]}, which includes j samples of the reference batch at the sample point j and represents the reference batch at the sample point j, with the highest level of alignment between B_{[1:i]} and R_{[1:j]}. In some embodiments, the particular batch at the sample point i may include i samples (e.g., the sample Bᵢ to the sample Bᵢ) of the particular batch that correspond to i sample points from the start point of the particular batch up to the sample point i during the particular batch. Similarly, the reference batch at the sample point j may include j samples (e.g., the sample R₁ to the sample Rⱼ) of the reference batch that correspond to j sample points from the start point of the reference batch up to the sample point j during the reference batch. In some embodiments, as the DTW matrix D is generated based on the first sequence 1102 that has the first batch length of the particular batch (e.g., N samples) and the second sequence 1104 that has the second batch length of the reference batch (e.g., M samples), the DTW matrix D may have the following dimensions:

$$D ∈ {M}_{N \times M}$$

In some embodiments, the batch analytic system 900 may determine a warping path between the first sequence 1102 associated with the particular batch and the second sequence 1104 associated with the reference batch based on the DTW matrix D. An example warping path 1150 determined based on the DTW matrix D is illustrated in FIG. 11. As depicted in FIG. 11, the warping path 1150 may map each sample of the particular batch in the first sequence 1102 to one or more samples of the reference batch in the second sequence 1104, and map each sample of the reference batch in the second sequence 1104 to one or more samples of the particular batch in the first sequence 1102. The warping path 1150 may have a start point 1152 located at the element D_{1,1} at the bottom left corner of the DTW matrix D and an end point 1154 located at the element D_{N,M} at the top right corner of the DTW matrix D.

In some embodiments, to determine the warping path 1150, the batch analytic system 900 may start from the end point 1154 of the warping path 1150 at the element D_{N,M} of the DTW matrix D, and sequentially determine various points of the warping path 1150 in a backtracking manner until the start point 1152 of the warping path 1150 at the element D_{1,1} of the DTW matrix D is reached. As depicted in FIG. 11, for a particular point of the warping path 1150 that is located at the element D_{n,m} of the DTW matrix D, the batch analytic system 900 may determine a preceding point in the warping path 1150 that sequentially precedes the particular point in the direction from the start point 1152 of the warping path 1150 to the end point 1154 of the warping path 1150 as follows:

$$Preceding point = min \{ \begin{matrix}{D}_{n - 1 , m} \\ {D}_{n , m - 1} \\ {D}_{n - 1 , m - 1}\end{matrix} \qquad ( Equation 24 )$$

Thus, according to Equation 24, the points in the warping path 1150 may form the optimal warping path that has the lowest total distance (e.g., lowest total cost) among all possible warping paths between the start point 1152 at the element D_{1,1} of the DTW matrix D and the end point 1154 at the element D_{N,M} of the DTW matrix D. Accordingly, the warping path 1150 may indicate the overall optimal alignment between the samples of the particular batch in the first sequence 1102 and the samples of the reference batch in the second sequence 1104 that are used to determine the DTW matrix D. As depicted in FIG. 11, each point in the warping path 1150 may map one sample of the particular batch in the first sequence 1102 and one sample of the reference batch in the second sequence 1104 to one another.

In some embodiments, the batch analytic system 900 may determine one or more representation samples for the batch representation of the particular batch based on the set of samples associated with the particular batch in the first sequence 1102 and the warping path 1150. For example, for each sample of the reference batch in the second sequence 1104, the batch analytic system 900 may determine one or more samples of the particular batch in the first sequence 1102 that are mapped to the sample of the reference batch in the second sequence 1104 by one or more points in the warping path 1150. For simplification, in the two following paragraphs, the one or more samples of the particular batch in the first sequence 1102 may be referred to as the first sample(s) of the particular batch, and the sample of the reference batch in the second sequence 1104 may be referred to as the second sample of the reference batch.

In some embodiments, the second sample of the reference batch may be mapped to one first sample of the particular batch by the warping path 1150 and the second sample of the reference batch may correspond to a sample point k. In this case, the batch analytic system 900 may generate a representation sample that is the same as the first sample of the particular batch, and determine the sample corresponding to the sample point k in the batch representation of the particular batch to be the representation sample. Thus, the representation sample may be the same as the first sample of the particular batch and may correspond to the respective sample point (e.g., the sample point k) associated with the second sample of the reference batch. Accordingly, the representation sample may have the relative position within the batch representation of the particular batch matching the relative position of the second sample within the second sequence 1104 representing the reference batch.

In some embodiments, the second sample of the reference batch may be mapped to a plurality of first samples of the particular batch by the warping path 1150 and the second sample of the reference batch may correspond to a sample point k. In this case, the batch analytic system 900 may generate a representation sample based on the first samples of the particular batch. For example, for each process variable of the industrial process, the batch analytic system 900 may obtain the values of the process variable in the first samples of the particular batch, and compute an average value of these values of the process variable. The batch analytic system 900 may then determine the value of the process variable in the representation sample to be the computed average value. Thus, in this case, the representation sample may be an average sample of the first samples in the particular batch. In some embodiments, the batch analytic system 900 may determine the sample corresponding to the sample point k in the batch representation of the particular batch to be the representation sample. Thus, the representation sample may be the average sample of the plurality of first samples in the particular batch and may correspond to the respective sample point (e.g., the sample point k) associated with the second sample of the reference batch. Accordingly, the representation sample may have the relative position within the batch representation of the particular batch matching the relative position of the second sample within the second sequence 1104 representing the reference batch.

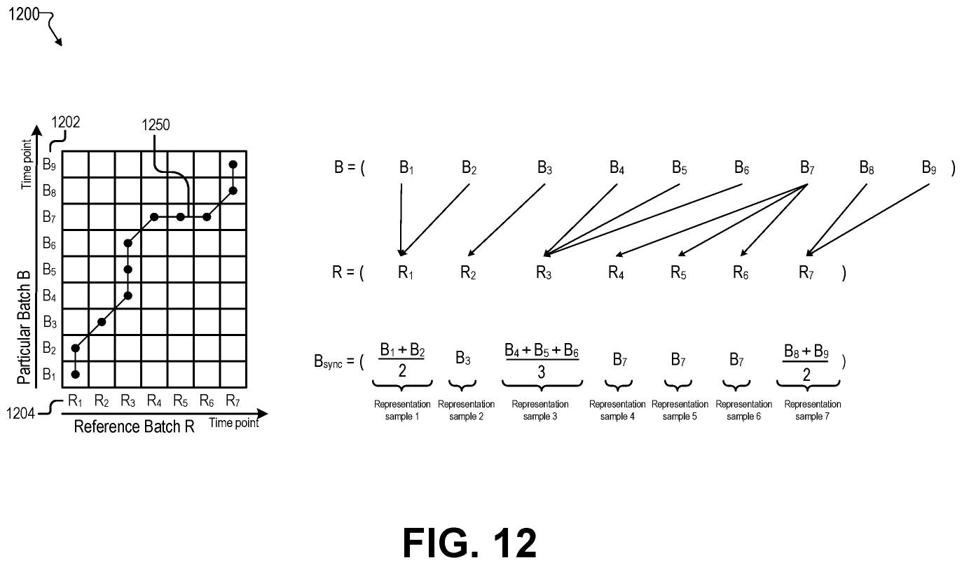

An example of determining the batch representation of the particular batch is illustrated in diagram 1200 of FIG. 12. As depicted in FIG. 12, the particular batch represented by a first sequence 1202 may include 9 samples (e.g., a sample Bᵢ to a sample B₉), and the reference batch represented by a second sequence 1204 may include 7 samples (e.g., a sample R₁ to a sample R₇). As depicted in FIG. 12, the batch representation B_{sync} of the particular batch may include 7 samples (e.g., a representation sample 1 to a representation sample 7) in which each representation sample in the batch representation B_{sync} of the particular batch corresponds to a respective sample point associated with a sample in the reference batch and therefore corresponds to that sample in the reference batch. Accordingly, the batch representation B_{sync} of the particular batch may have the same number of samples and the same batch length as the reference batch.

As depicted in FIG. 12, each representation sample among 7 representation samples that form the batch representation B_{sync} of the particular batch may be computed based on the samples of the particular batch using a warping path 1250. For example, as depicted in FIG. 12, the warping path 1250 may map the sample R₁ of the reference batch to the samples B₁ and B₂ of the particular batch. Accordingly, the batch analytic system 900 may determine the representation sample 1 in the batch representation B_{sync} of the particular batch to be an average sample of the samples B₁ and B₂ in the particular batch. The representation sample 1 in the batch representation B_{sync} of the particular batch may correspond to a respective sample point associated with sample R₁ of the reference batch and therefore correspond to the sample R₁ of the reference batch as depicted in FIG. 12.

As another example, the warping path 1250 may map the sample R₂ of the reference batch to the samples B₃ of the particular batch as depicted in FIG. 12. Accordingly, the batch analytic system 900 may determine the representation sample 2 in the batch representation B_{sync} of the particular batch to be the same as the sample B₃ of the particular batch. The representation sample 2 in the batch representation B_{sync} of the particular batch may correspond to a respective sample point associated with the sample R₂ of the reference batch and therefore correspond to the sample R₂ of the reference batch as depicted in FIG. 12.

As another example, the warping path 1250 may map the samples R₄, R₅, R₆ of the reference batch to the samples B₇ of the particular batch as depicted in FIG. 12. Accordingly, the batch analytic system 900 may determine the representation sample 4, the representation sample 5, the representation sample 6 in the batch representation B_{sync} of the particular batch to be the same as the sample B₇ of the particular batch. The representation sample 4 in the batch representation B_{sync} of the particular batch may correspond to a respective sample point associated with the sample R₄ of the reference batch and therefore correspond to the sample R₄ of the reference batch as depicted in FIG. 12. Similarly, the representation sample 5 in the batch representation B_{sync} of the particular batch may correspond to a respective sample point associated with the sample Rₛ of the reference batch and therefore correspond to the sample R₅ of the reference batch as depicted in FIG. 12. The representation sample 6 in the batch representation B_{sync} of the particular batch may correspond to a respective sample point associated with the sample R₆ of the reference batch and therefore correspond to the sample R₆ of the reference batch as depicted in FIG. 12.

Thus, as described above, for each sample corresponding to a particular sample point in the reference batch, the batch analytic system 900 may determine a representation sample corresponding to the particular sample point and include the representation sample corresponding to the particular sample point in the batch representation of the particular batch. Thus, as the reference batch includes M samples corresponding to M sample points, the batch representation of the particular batch may also include M representation samples corresponding to M sample points. Accordingly, the batch representation of the particular batch may include the same number of samples (e.g., M samples) and have the same second batch length as the reference batch.

In addition, as described above, the representation samples that form the batch representation of the particular batch may be determined from the samples of the particular batch based on the warping path 1150. As described herein, the warping path 1150 may map the samples of the particular batch in the first sequence 1102 to the samples of the reference batch in the second sequence 1104 with the lowest total distance and the optimal alignment between the samples of the particular batch and the samples of the reference batch. As a result, the batch representation of the particular batch may align with the reference batch.

In some embodiments, the batch representation of the particular batch may be generated in the form of a batch vector. For example, the batch analytic system 900 may aggregate M representation samples corresponding to M sample points in the batch representation of the particular batch in a chronological order of their sample points to form one row of the batch vector. As described above, each representation sample in the batch representation of the particular batch may be the same as a sample of the particular batch or may be an average sample of multiple samples in the particular batch. As described herein, each sample of the particular batch may include J values corresponding to J process variables of the industrial process. Accordingly, each representation sample in the batch representation of the particular batch may also include J values corresponding to J process variables of the industrial process. Thus, as the batch representation of the particular batch includes M representation samples and each representation sample includes J values corresponding to J process variables, the batch representation of the particular batch may be the batch vector that has the following dimensions:

### Batch Representation∈M_{1×(MJ)}

In some embodiments, the batch analytic system 900 may perform the batch synchronization operation described above to synchronize one or more batches generated by the industrial process with the reference batch, thereby generating a batch representation for each batch in which the batch representation of each batch may include the same number of samples (e.g., M samples) and have the same batch length as the reference batch. The batch representation of each batch may also align with the reference batch as described above. In some embodiments, the batch analytic system 900 may perform an operation using the batch representations of the one or more batches.

As an example, the batch analytic system 900 may synchronize I non-anomalous batches generated by the industrial process that are complete or finished with the reference batch. These I non-anomalous batches may or may not include one or more non-anomalous batches among the plurality of non-anomalous batches that are used to determine the reference batch as described herein. As a result of the batch synchronization operation, the batch analytic system 900 may obtain a batch representation of each non-anomalous batch in which the batch representation of each non-anomalous batch may include the same number of samples (e.g., M samples) and have the same batch length as the reference batch as described above. The batch representation of each non-anomalous batch may also align with the reference batch. The batch analytic system 900 may then provide the batch representations of I non-anomalous batches to the anomaly detection system 200. In some embodiments, the anomaly detection system 200 may generate one or more PCA models of the industrial process (e.g., the PCA model corresponding to entire batch, the PCA model corresponding to sample point k, etc.) using the batch representations of I non-anomalous batches as described herein. Additionally or alternatively, the batch analytic system 900 may perform the operations of the anomaly detection system 200 described herein to generate the PCA models of the industrial process using the batch representations of I non-anomalous batches.

As another example, the batch analytic system 900 may synchronize a batch generated by the industrial process that is complete or finished with the reference batch, thereby obtaining a batch representation of the batch that includes the same number of samples (e.g., M samples) and has the same batch length as the reference batch. The batch representation of the batch may also align with the reference batch. As the batch representation of the batch has the same batch length as the reference batch and align with the reference batch, the batch representation of the batch may also have the same batch length as and also align with I non-anomalous batches being used to generate the PCA models of the industrial process. The batch analytic system 900 may then provide the batch representation of the batch to the anomaly detection system 200. In some embodiments, the anomaly detection system 200 may determine the anomaly metric of the batch using the batch representation of the batch and the PCA model corresponding to entire batch, and determine whether the batch is anomalous based on the anomaly metric of the batch as described herein. Additionally or alternatively, the batch analytic system 900 may perform the operations of the anomaly detection system 200 described herein to determine the anomaly metric of the batch using the batch representation of the batch and the PCA model corresponding to entire batch, and determine whether the batch is anomalous based on the anomaly metric of the batch.

As another example, the batch analytic system 900 may synchronize a plurality of batches generated by the industrial process with the reference batch, thereby obtaining a plurality of batch representations of the plurality of batches in which the batch representation of each batch includes the same number of samples (e.g., M samples) and has the same batch length as the reference batch. The batch analytic system 900 may then use the batch representations of the plurality of batches in training a machine learning model to perform batch analytic operations such as anomaly detection operations. Once the training of the machine learning model is completed, the machine learning model may be used to perform batch analytic operations for one or more batches generated by the industrial process. For example, for a batch generated by the industrial process that is complete or finished, the batch analytic system 900 may synchronize the batch with the reference batch, thereby obtaining a batch representation of the batch that includes the same number of samples (e.g., M samples) and has the same batch length as the reference batch. As the batch representation of the batch has the same batch length as the reference batch, the batch representation of the batch may have the same batch length as the plurality of batches being used to train the machine learning model. The batch analytic system 900 may then provide the batch representation of the batch to the machine learning model as an input to generate an analytic result for the batch using the machine learning model. Other use cases of the batch representations of the batches are also possible and contemplated.

In some embodiments, the batch analytic system 900 may not only apply the DTW technique to generate a batch representation for a batch that is already complete or finished, but also apply the DTW technique to generate a batch representation for a particular batch that is ongoing and not yet finished. As the particular batch is not yet finished, the total number of samples included in the particular batch is an unknown value. In some embodiments, for the particular batch that is ongoing and not yet finished, the batch analytic system 900 may generate a batch representation that represents the particular batch at a sample point k during the particular batch. The batch representation that represents the particular batch at the sample point k during the particular batch may be referred to herein as the batch representation corresponding to sample point k of the particular batch, the batch representation at sample point k of the particular batch, or the batch representation of the particular batch at sample point k.

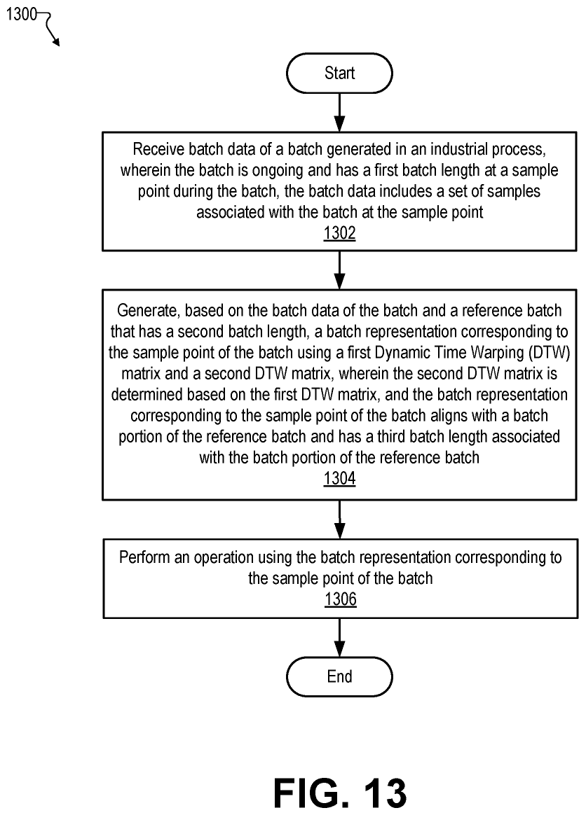

FIG. 13 illustrates an example batch synchronization method 1300 (e.g., the method 1300) for performing batch synchronization using the DTW technique to generate a batch representation corresponding to a sample point for a particular batch that is ongoing and not yet finished. While FIG. 13 shows illustrative operations according to one embodiment, other embodiments may omit, add to, reorder, and/or modify any of the operations shown in FIG. 13. In some examples, multiple operations shown in FIG. 13 or described in relation to FIG. 13 may be performed concurrently (e.g., in parallel) with one another, rather than being performed sequentially as illustrated and/or described. One or more of the operations shown in FIG. 13 may be performed by a batch analytic system such as the batch analytic system 900 and/or any implementation thereof.

At operation 1302, the batch analytic system 900 may receive batch data of a particular batch generated in an industrial process. The particular batch may be ongoing and the batch data may include a set of samples associated with the particular batch at a sample point k during the particular batch. In some embodiments, the set of samples associated with the particular batch at the sample point k may include one or more samples that are collected during the particular batch from the start point of the particular batch up to the sample point k during the particular batch. In some embodiments, the particular batch may have a first batch length at the sample point k during the particular batch. The first batch length may equal to a number of samples (e.g., k samples) in the set of samples associated with the particular batch at the sample point k. In some embodiments, the particular batch at the sample point k may be referred to herein as the particular batch corresponding to sample point k or the particular batch at sample point k.

At operation 1304, the batch analytic system 900 may generate a batch representation corresponding to sample point k of the particular batch based on the batch data of the particular batch and the reference batch. As described herein, the reference batch may be determined based on the plurality of non-anomalous batches generated in the industrial process and may have the second batch length. In some embodiments, to generate the batch representation corresponding to sample point k of the particular batch, the batch analytic system 900 may use a first DTW matrix and a second DTW matrix in which the second DTW matrix is determined based on the first DTW matrix. For example, the batch analytic system 900 may determine the first DTW matrix between a first sequence including the set of samples associated with the particular batch at sample point k and a second sequence including the set of samples associated with the reference batch. The batch analytic system 900 may also determine the second DTW matrix between the first sequence including the set of samples associated with the particular batch at sample point k and a third sequence including a set of samples associated with a batch portion of the reference batch. The second DTW matrix may be a portion of the first DTW matrix.

In some embodiments, after the second DTW matrix is determined, the batch analytic system 900 may determine the batch representation corresponding to sample point k of the particular batch based on the second DTW matrix in which the batch representation corresponding to sample point k of the particular batch may align with the batch portion of the reference batch and may have a third batch length associated with the batch portion of the reference batch. In some embodiments, the batch representation corresponding to sample point k of the particular batch may include the same number of samples (e.g., x samples) as the batch portion of the reference batch, and therefore the batch representation corresponding to sample point k of the particular batch may have the same third batch length as the batch portion of the reference batch. In some embodiments, the third batch length of the batch portion of the reference batch may equal to the number of samples (e.g., x samples) in the batch portion of the reference batch and may be lower than the second batch length of the reference batch.

In some embodiments, the batch representation corresponding to sample point k of the particular batch may not only have the same batch length as the batch portion of the reference batch but also align with the batch portion of the reference batch. The batch representation corresponding to sample point k of the particular batch may be considered aligning with the batch portion of the reference batch when the shape of each variable trajectory corresponding to each process variable of the particular batch at sample point k is substantially preserved (e.g., the shape of a variable trajectory of a process variable generated based on the samples collected during the particular batch up to the sample point k and the shape of a variable trajectory of the process variable generated based on the samples in the batch representation corresponding to sample point k of the particular batch are substantially similar) and the landmarks (e.g., the local maximum points, the local minimum points, the trend reverse points, etc.) in each variable trajectory generated based on the samples in the batch representation corresponding to sample point k of the particular batch coincide or align with the corresponding landmarks in a corresponding variable trajectory generated based on the samples in the batch portion of the reference batch.

At operation 1306, the batch analytic system 900 may perform an operation using the batch representation corresponding to sample point k of the particular batch. For example, the batch analytic system 900 may determine an anomaly metric corresponding to sample point k of the particular batch using the batch representation corresponding to sample point k of the particular batch and a PCA model of the industrial process. The batch analytic system 900 may also use the batch representation corresponding to sample point k of the particular batch to perform other operations.

Thus, as described above, the batch analytic system 900 may generate the batch representation corresponding to sample point k of the particular batch based on the batch data of the particular batch at the sample point k and the reference batch. As described herein, the particular batch at sample point k may include k samples collected at k sample points from the start point of the particular batch up to the sample point k during the particular batch and may have the first batch length. As described herein, the reference batch may be determined based on the plurality of non-anomalous batches generated by the industrial process. The reference batch may include M samples corresponding to M sample points and have the second batch length. As described herein, each sample in the particular batch and each sample in the reference batch may include J values corresponding to J process variables of the industrial process.

In some embodiments, to generate the batch representation corresponding to sample point k of the particular batch, the batch analytic system 900 may determine a batch portion of the reference batch that corresponds to a reference sample point during the reference batch in which the particular batch at sample point k has the lowest distance or the lowest level of difference with the reference batch at the reference sample point as compared to the reference batch at other sample points during the reference batch. The batch portion of the reference batch may include x samples corresponding to x sample points and may have a third batch length. In some embodiments, the batch analytic system 900 may synchronize the particular batch at the sample point k and the batch portion of the reference batch, thereby generating the batch representation corresponding to sample point k of the particular batch that includes x samples corresponding to x sample points and has the third batch length associated with the batch portion of the reference batch. The batch representation corresponding to sample point k of the particular batch may also align with the batch portion of the reference batch.

To illustrate, when generating the batch representation corresponding to sample point k of the particular batch, the batch analytic system 900 may perform a scaling operation on the particular batch at sample point k and the reference batch. For example, similar to the scaling operation being performed when generating a batch representation for a batch that is complete or finished, for each sample included in the particular batch at sample point k and for each sample in the reference batch, the batch analytic system 900 may divide the value of each process variable in the sample by the corresponding average length of value range associated with the process variable as described herein. Due to this scaling operation, the batch analytic system 900 may eliminate different variable units of the process variables and also eliminate impacts caused by different value ranges of the process variables on DTW operations.

In some embodiments, after the particular batch at sample point k and the reference batch are subjected to the scaling operation, the batch analytic system 900 may perform a first DTW operation for the particular batch at sample point k and the reference batch. For example, similar to performing the DTW operation for a batch that is complete and the reference batch described herein, the batch analytic system 900 may generate a first sequence including the set of samples associated with the particular batch at the sample point k. Thus, the first sequence may represent the particular batch at sample point k and may include k samples that are collected from the start point of the particular batch up to the sample point k during the particular batch. The samples in the set of samples associated with the particular batch at sample point k may be arranged in a chronological order of their sample points to form the first sequence. In addition, the batch analytic system 900 may generate a second sequence including the set of samples associated with the reference batch. Thus, the second sequence may represent the reference batch and may include M samples of the reference batch. The samples in the set of samples associated with the reference batch may be arranged in a chronological order of their sample points to form the second sequence. Accordingly, the first sequence may have the first batch length of the particular batch at sample point k (e.g., k samples) and the second sequence may have the second batch length of the reference batch (e.g., M samples).

In some embodiments, the batch analytic system 900 may determine a first DTW matrix D1 between the first sequence associated with the particular batch at sample point k and the second sequence associated with the reference batch. The first DTW matrix D1 may also be referred to as the DTW matrix between the particular batch at sample point k and the reference batch. In some embodiments, to determine the first DTW matrix D1, the batch analytic system 900 may compute the elements of the first DTW matrix D1 based on the samples included in the set of samples associated with the particular batch at sample point k in the first sequence and the samples included in the set of samples associated with the reference batch in the second sequence using Equations 22 and 23 as described herein. In some embodiments, as the first DTW matrix D1 is generated based on the first sequence that has the first batch length of the particular batch at sample point k (e.g., k samples) and the second sequence that has the second batch length of the reference batch (e.g., M samples), the first DTW matrix D1 may have the following dimensions:

$$D 1 ∈ {M}_{k \times M}$$

In some embodiments, instead of or in addition to determining the first DTW matrix D1 based on the set of samples associated with the particular batch at sample point k in the first sequence and the set of samples associated with the reference batch in the second sequence using Equations 22 and 23 as described above, the batch analytic system 900 may determine the first DTW matrix D1 between the particular batch at sample point k and the reference batch based on a DTW matrix between the particular batch at a sample point prior to the sample point k (such as a sample point (k−1)) and the reference batch. For example, the batch analytic system 900 may determine the first DTW matrix D1 in a manner similar to the manner in which a different DTW matrix between the particular batch at a sample point subsequent to the sample point k (such as a sample point (k+1)) and the reference batch is determined based on the first DTW matrix D1 between the particular batch at sample point k and the reference batch described below.

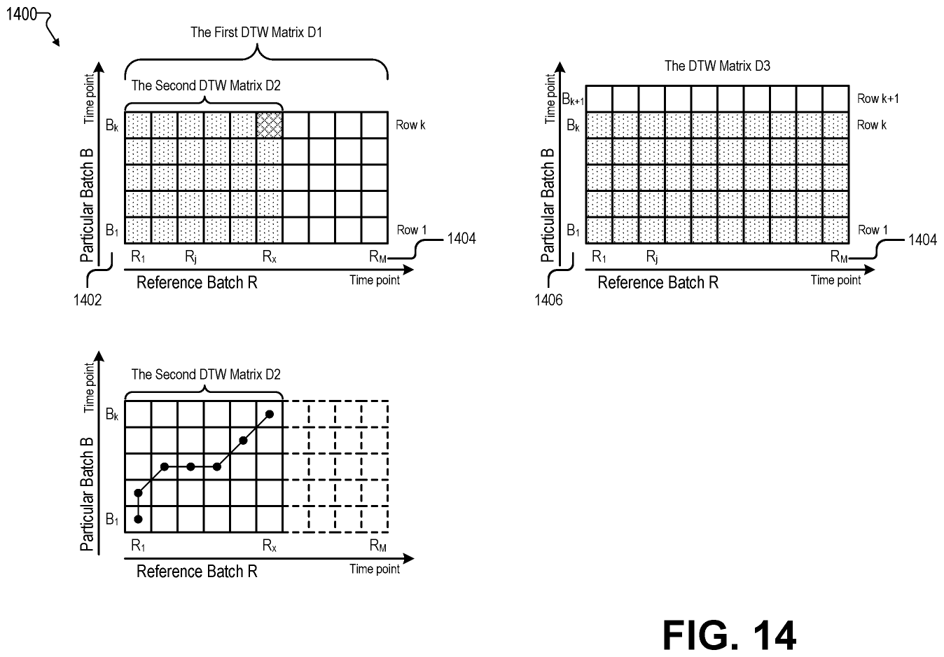

In some embodiments, the batch analytic system 900 may store the first DTW matrix D1 in a data storage (e.g., a local data storage and/or the cloud storage system 140). At a later point, the batch analytic system 900 may use the first DTW matrix D1 in determining the different DTW matrix between the particular batch at the different sample point subsequent to the sample point k (such as the sample point (k+1)) and the reference batch. For example, the batch analytic system 900 may use the first DTW matrix D1 to determine a DTW matrix D3 between a different sequence associated with the particular batch at sample point (k+1) and the second sequence associated with the reference batch. An example of the first DTW matrix D1 and the DTW matrix D3 is illustrated in diagram 1400 of FIG. 14.

As depicted in FIG. 14, the first DTW matrix D1 may be a DTW matrix between a first sequence 1402 associated with the particular batch at sample point k and a second sequence 1404 associated with the reference batch. The first sequence 1402 may include the set of samples associated with the particular batch at sample point k. Thus, the first sequence 1402 may represent the particular batch at sample point k and may include k samples (e.g., the sample Bᵢ to the sample Bₖ) of the particular batch that are collected during the particular batch up to the sample point k. The samples in the set of samples associated with the particular batch at sample point k may be arranged in a chronological order of their sample points to form the first sequence 1402 as depicted in FIG. 14. On the other hand, the second sequence 1404 may include the set of samples associated with the reference batch. Thus, the second sequence 1404 may represent the reference batch and may include M samples (e.g., the sample R₁ to the sample R_{M}) of the reference batch. The samples in the set of samples associated with the reference batch may be arranged in a chronological order of their sample points to form the second sequence 1404 as depicted in FIG. 14.

Similarly, the DTW matrix D3 may be a DTW matrix between a different sequence 1406 associated with the particular batch at sample point (k+1) and the second sequence 1404 associated with the reference batch. The different sequence 1406 may include the set of samples associated with the particular batch at sample point (k+1). Thus, the different sequence 1406 may represent the particular batch at sample point (k+1) and may include (k+1) samples (e.g., the sample B₁ to the sample Bₖ₊₁) of the particular batch that are collected during the particular batch up to the sample point (k+1). The samples in the set of samples associated with the particular batch at sample point (k+1) may be arranged in a chronological order of their sample points to form the different sequence 1406 as depicted in FIG. 14. Accordingly, the different sequence 1406 may include the entire first sequence 1402 and additionally include the sample Bₖ+1 of the particular batch that is collected at the sample point (k+1) during the particular batch.

As described herein, an element D_{i,j} of a DTW matrix may correspond to a sample Bᵢ of the particular batch and a sample Rⱼ of the reference batch and may be computed based on the sample Bᵢ of the particular batch and the sample Rⱼ of the reference batch using Equations 22 and 23. As a result, the element D1_{i,j} of the first DTW matrix D1, which may be computed based on the sample Bᵢ of the particular batch in the first sequence 1402 and the sample Rⱼ of the reference batch in the second sequence 1404, may be equal to the element D_{3i,j} of the DTW matrix D3, which may be computed based on the same sample Bᵢ of the particular batch in the different sequence 1406 and the same sample Rⱼ of the reference batch in the second sequence 1404. Accordingly, all elements of the first DTW matrix D1 may be equal to the corresponding elements of the DTW matrix D3, and therefore these elements may not be re-computed when the DTW matrix D3 is determined.

In some embodiments, to determine the DTW matrix D3, the batch analytic system 900 may include the first DTW matrix D1 as a portion of the DTW matrix D3. The portion of the DTW matrix D3 that matches the first DTW matrix D1 may include k rows (e.g., row 1 to row k) of the DTW matrix D3, which correspond to k samples (e.g., the sample Bᵢ to the sample Bₖ) of the particular batch that are included in both the first sequence 1402 and the different sequence 1406 as depicted in FIG. 14. The batch analytic system 900 may then compute the elements of the DTW matrix D3 that correspond to the sample Bₖ₊₁ collected at the sample point (k+1) of the particular batch, which is not included in the first sequence 1402 associated with the particular batch at sample point k but is included in the different sequence 1406 associated with the particular batch at sample point (k+1). For example, for an element D3_{(k+1),j} of the DTW matrix D3 that corresponds to the sample Bₖ₊₁ of the particular batch in the different sequence 1406 and the sample Rⱼ of the reference batch in the second sequence 1404, the batch analytic system 900 may compute the element D3_{(k+1),j} of the DTW matrix D3 based on the sample Bₖ₊₁ of the particular batch in the different sequence 1406, the sample Rⱼ of the reference batch in the second sequence 1404, and the portion of the DTW matrix D3 that matches the first DTW matrix D1 using Equations 22 and 23. The batch analytic system 900 may then update the DTW matrix D3 to include the element D3_{(k+1),j} in the DTW matrix D3.

Accordingly, instead of computing all elements of the DTW matrix D3 using Equations 22 and 23, the batch analytic system 900 may include the first DTW matrix D1 in the DTW matrix D3 to form k rows (e.g., row 1 to row k) of the DTW matrix D3, and compute only elements in row (k+1) of the DTW matrix D3 using Equations 22 and 23 as depicted in FIG. 14. As a result, the amount of computation may be significantly reduced, and the efficiency in determining the DTW matrix D3 between the particular batch at sample point (k+1) and the reference batch may be improved.

In some embodiments, in addition to or instead of the sample point (k+1), the first DTW matrix D1 may be used to determine a different DTW matrix D between the particular batch at a different sample point subsequent to the sample point k (e.g., a sample point (k+Δ)) and the reference batch in a similar manner. For example, to determine the different DTW matrix D, the batch analytic system 900 may include the first DTW matrix D1 in the different DTW matrix D as a portion of the different DTW matrix D. The portion of the different DTW matrix D that matches the first DTW matrix D1 may include k rows (e.g., row 1 to row k) of the different DTW matrix D.

In some embodiments, the batch analytic system 900 may identify one or more samples that are not included in the set of samples associated with the particular batch at the sample point k, but are included in the set of samples associated with the particular batch at the different sample point (e.g., the sample point (k+Δ)) subsequent to the sample point k. For each identified sample of the particular batch, the batch analytic system 900 may compute one or more elements of the different DTW matrix D that correspond to the identified sample of the particular batch based on the identified sample of the particular batch, the set of samples associated with the reference batch, and the portion of the different DTW matrix D that matches the first DTW matrix D1 using Equations 22 and 23.

In some embodiments, the batch analytic system 900 may update the different DTW matrix D to include the one or more elements corresponding to the identified sample of the particular batch in the different DTW matrix D. These elements may form a row in the different DTW matrix D that corresponds to the identified sample of the particular batch. In some embodiments, the batch analytic system 900 may use the different DTW matrix D between the particular batch at the different sample point subsequent to the sample point k and the reference batch to generate a batch representation corresponding to the different sample point (e.g., the sample point (k+Δ)) of the particular batch.

In some embodiments, the batch analytic system 900 may determine the first DTW matrix D1 in a manner similar to the manner in which the different DTW matrix D is determined as described above. For example, the batch analytic system 900 may determine the first DTW matrix D1 between the particular batch at sample point k and the reference batch using a given DTW matrix between the particular batch at a given sample point prior to the sample point k and the reference batch. The given DTW matrix may be determined by the batch analytic system 900 previously and may be stored in the data storage. In some embodiments, the batch analytic system 900 may include the given DTW matrix in the first DTW matrix D1 as a portion of the first DTW matrix D1. In some embodiments, the batch analytic system 900 may identify one or more samples that are not included in the set of samples associated with the particular batch at the given sample point prior to the sample point k but are included in the set of samples associated with the particular batch at the sample point k. For each identified sample of the particular batch, the batch analytic system 900 may compute one or more elements of the first DTW matrix D1 that correspond to the identified sample of the particular batch based on the identified sample of the particular batch, the set of samples associated with the reference batch, and the portion of the first DTW matrix D1 that matches the given DTW matrix using Equations 22 and 23. In some embodiments, the batch analytic system 900 may update the first DTW matrix D1 to include the one or more elements corresponding to the identified sample of the particular batch in the first DTW matrix D1. These elements may form a row in the first DTW matrix D1 that corresponds to the identified sample of the particular batch.

Thus, as described above, the batch analytic system 900 may determine a DTW matrix between the particular batch at a particular sample point and the reference batch based on a given DTW matrix between the particular batch at a previous sample point prior to the particular sample point and the reference batch. The given DTW matrix may be determined by the batch analytic system 900 previously and may be stored in the data storage. In this implementation, the batch analytic system 900 may only compute the elements of the DTW matrix that correspond to the samples of the particular batch being collected after the previous sample point, and may not re-compute other elements of the DTW matrix that are equal to the elements of the given DTW matrix. As a result, the amount of computation may be significantly reduced, and the efficiency in determining the DTW matrix between the particular batch at the particular sample point and the reference batch may be improved.

In some embodiments, after the first DTW matrix D1 between the particular batch at sample point k and the reference batch is determined, the batch analytic system 900 may determine a reference sample point based on the first DTW matrix D1. In some embodiments, the reference sample point may be a sample point during the reference batch in which the particular batch at sample point k has the lowest distance or the lowest level of difference with the reference batch at the reference sample point as compared to the reference batch at other sample points during the reference batch. As described herein, the particular batch at sample point k may include k samples that are collected during the particular batch from the start point of the particular batch up to the sample point k during the particular batch. Thus, the particular batch at sample point k may include k samples (e.g., the sample B₁ to the sample Bₖ) corresponding to k sample points from the start point of the particular batch up to the sample point k during the particular batch. Similarly, the reference batch at a sample point j during the reference batch may include j samples (e.g., the sample R₁ to the sample Rⱼ) corresponding to j sample points from the start point of the reference batch up to the sample point j during the reference batch. The reference batch at the sample point j may be referred to herein as the reference batch at sample point j.

In some embodiments, to determine the reference sample point, the batch analytic system 900 may identify one or more elements of the first DTW matrix D1 that correspond to the sample Bₖ associated with the sample point k in the particular batch. As described herein, the sample Bₖ associated with the sample point k in the particular batch may be collected at the sample point k during the particular batch. In some embodiments, the elements of the first DTW matrix D1 that correspond to the sample Bₖ of the particular batch may be the elements in row k of the first DTW matrix D1. As depicted in FIG. 14, an element D_{i,j} in row k of the first DTW matrix D1 may correspond to the sample Bₖ of the particular batch and the sample Rⱼ of the reference batch, and can be computed based on the sample Bₖ of the particular batch and the sample Rⱼ of the reference batch using Equations 22 and 23 as described herein.

As described herein with reference to Equations 22 and 23, the element D_{i,j} may indicate the cumulative distance between B_{[1:k]}, which includes k samples of the particular batch at the sample point k and represents the particular batch at sample point k, and R_{[1:j]}, which includes j samples of the reference batch at the sample point j and represents the reference batch at the sample point j, with the highest level of alignment between B_{[1:j]} and R_{[1:j]}. Thus, the element D_{i,j} of the first DTW matrix D1 may indicate the cumulative distance between the particular batch at sample point k and the reference batch at sample point j with the highest level of alignment therebetween. Accordingly, the element D1_{k,j} of the first DTW matrix D1 may indicate the distance or the difference between the particular batch at sample point k and the reference batch at sample point j.

In some embodiments, among the elements in row k of the first DTW matrix D1 that correspond to the sample Bₖ of the particular batch, the batch analytic system 900 may identify an element that has the lowest value. For example, the batch analytic system 900 may determine that an element D1_{k,x} that corresponds to a sample R, associated with a sample point x during the reference batch has the lowest value among the elements in row k of the first DTW matrix D1. Accordingly, the batch analytic system 900 may determine that the particular batch at sample point k has the lowest distance or the lowest level of difference with the reference batch at the sample point x as compared to the reference batch at other sample points during the reference batch. In other words, the batch analytic system 900 may determine that the particular batch at sample point k has the highest level of similarity with the reference batch at the sample point x as compared to the reference batch at other sample points during the reference batch.

In some embodiments, in response to such determination, the batch analytic system 900 may determine the sample point x during the reference batch that corresponds to the element D1_{k,x}, to be the reference sample point. In some embodiments, the batch analytic system 900 may determine a batch portion of the reference batch based on the reference sample point x. For example, the batch analytic system 900 may determine the batch portion of the reference batch to be the reference batch at the reference sample point x, which includes x samples (e.g., the sample R₁ to the sample R,) corresponding to x sample points from the start point of the reference batch up to the reference sample point x during the reference batch. Thus, the batch portion of the reference batch may include the set of samples associated with the reference batch at the reference sample point x and may have a third batch length that is equal to the number of samples (e.g., x samples) in the reference batch at the reference sample point x. The reference batch at the reference sample point x may be referred to herein as the reference batch at reference sample point x or the reference batch at sample point x and may also be referred to herein as the batch portion of the reference batch interchangeably.

In some embodiments, after the reference sample point and the batch portion of the reference batch are determined, the batch analytic system 900 may perform a batch synchronization operation to synchronize the particular batch at sample point k with the batch portion of the reference batch. As described above, the reference sample point may be the sample point x during the reference batch, the batch portion of the reference batch may be the reference batch at sample point x, and the particular batch at sample point k may have the highest level of similarity with the reference batch at sample point x as compared to the reference batch at other sample points during the reference batch. As described herein, the particular batch at sample point k may include k samples corresponding to k sample points and may have the first batch length (e.g., k samples), while the batch portion of the reference batch may include x samples corresponding to x sample points and may have the third batch length (e.g., x samples). As a result of the batch synchronization operation, the batch analytic system 900 may generate a batch representation corresponding to sample point k of the particular batch based on the set of samples associated with the particular batch at sample point k, in which the batch representation corresponding to sample point k of the particular batch may include x samples corresponding to x sample points and have the third batch length associated with the batch portion of the reference batch. The batch representation corresponding to sample point k of the particular batch may also align with the batch portion of the reference batch.

In some embodiments, to synchronize the particular batch at sample point k with the batch portion of the reference batch, the batch analytic system 900 may perform a second DTW operation for the particular batch at sample point k and the batch portion of the reference batch. For example, similar to performing the DTW operation for a batch that is complete and the reference batch described herein, the batch analytic system 900 may generate a first sequence including the set of samples associated with the particular batch at the sample point k. Thus, the first sequence may represent the particular batch at sample point k and may include k samples corresponding to k sample points from the start point of the particular batch up to the sample point k during the particular batch. The samples in the set of samples associated with the particular batch at sample point k may be arranged in a chronological order of their sample points to form the first sequence. In addition, the batch analytic system 900 may generate a third sequence including the batch portion of the reference batch. As described herein, the batch portion of the reference batch may be the reference batch at the reference sample point x, and therefore the third sequence may represent the reference batch at sample point x and may include x samples corresponding to x sample points from the start point of the reference batch up to the sample point x during the reference batch. The samples in the set of samples associated with the reference batch at sample point x may be arranged in a chronological order of their sample points to form the third sequence. Accordingly, the first sequence may have the first batch length of the particular batch at sample point k (e.g., k samples) and the third sequence may have the third batch length of the reference batch at sample point x (e.g., x samples).

In some embodiments, the batch analytic system 900 may determine a second DTW matrix D2 between the first sequence associated with the particular batch at sample point k and the third sequence associated with the reference batch at sample point x. The second DTW matrix D2 may also be referred to as the DTW matrix between the particular batch at sample point k and the reference batch at sample point x. In some embodiments, to determine the second DTW matrix D2, the batch analytic system 900 may compute the elements of the second DTW matrix D2 based on the samples included in the set of samples associated with the particular batch at sample point k in the first sequence and the samples included in the set of samples associated with the reference batch at sample point x in the third sequence using Equations 22 and 23 as described herein. In some embodiments, as the second DTW matrix D2 is generated based on the first sequence that has the first batch length of the particular batch at sample point k (e.g., k samples) and the third sequence that has the third batch length of the reference batch at sample point x (e.g., x samples), the second DTW matrix D2 may have the following dimensions:

$$D 2 ∈ {M}_{k \times x}$$

In some embodiments, the second DTW matrix D2 may be a portion of the first DTW matrix D1. As described herein, the first DTW matrix D1 may be the DTW matrix between the first sequence associated with the particular batch at sample point k and the second sequence associated with the reference batch. The first sequence may include k samples in the set of samples associated with the particular batch at sample point k, and the second sequence may include M samples in the set of samples associated with the reference batch. On the other hand, the second DTW matrix D2 may be the DTW matrix between the first sequence associated with the particular batch at sample point k and the third sequence associated with the reference batch at sample point x. The first sequence may include k samples in the set of samples associated with the particular batch at sample point k, and the third sequence may include x samples in the set of samples associated with the reference batch at sample point x. Accordingly, the third sequence that includes x samples in the set of samples associated with the reference batch at sample point x may be a portion of the second sequence that includes M samples in the set of samples associated with the reference batch as depicted in FIG. 14.

As described herein, an element D_{i,j} of a DTW matrix may correspond to a sample B; of the particular batch and a sample Rⱼ of the reference batch and may be computed based on the sample Bᵢ of the particular batch and the sample Rⱼ of the reference batch using Equations 22 and 23. As a result, the element D2_{i,j} of the second DTW matrix D2, which may be computed based on the sample Bᵢ of the particular batch in the first sequence and the sample Rⱼ of the reference batch in the third sequence, may be equal to the element D1_{i,j} of the first DTW matrix D1, which may be computed based on the same sample B; of the particular batch in the first sequence and the same sample Rⱼ of the reference batch in the second sequence. Accordingly, all elements of the second DTW matrix D2 may be equal to the corresponding elements of the first DTW matrix D1, and therefore these elements of the second DTW matrix D2 may not be re-computed when the second DTW matrix D2 is determined.

In some embodiments, to determine the second DTW matrix D2, the batch analytic system 900 may identify a portion of the first DTW matrix D1 that have the elements therein equal to the elements of the second DTW matrix D2. As described above, the first DTW matrix D1 may correspond to the first sequence and the second sequence, in which the second sequence may include M samples in the set of samples associated with the reference batch. As described above, the second DTW matrix D2 may correspond to the first sequence and the third sequence, in which the third sequence may include x samples in the set of samples associated with the reference batch at sample point x. Accordingly, the batch analytic system 900 may identify a portion of the first DTW matrix D1 that corresponds to the reference sample point x, which includes x columns (e.g., column 1 to column x) of the first DTW matrix D1, to be the second DTW matrix D2. Thus, x columns (e.g., column 1 to column x) of the first DTW matrix D1 that correspond to x samples (e.g., sample R₁ to sample R,) associated with x sample points from the start point of the reference batch up to the reference sample point x during the reference batch may form the second DTW matrix D2 as depicted in FIG. 14. Accordingly, the batch analytic system 900 may determine the second DTW matrix D2 without re-computing any element of the second DTW matrix D2 from the samples in the set of samples associated with the particular batch at sample point k in the first sequence and the samples in the set of samples associated with the reference batch at sample point x in the third sequence using Equations 22 and 23.

In some embodiments, after the second DTW matrix D2 is determined, the batch analytic system 900 may determine a warping path between the first sequence that includes the set of samples associated with the particular batch at sample point k and the third sequence that includes the set of samples associated with the reference batch at sample point x based on the second DTW matrix D2. In some embodiments, the warping path may map each sample in the set of samples associated with the particular batch at sample point k in the first sequence to one or more samples in the set of samples associated with the reference batch at sample point x in the third sequence, and map each sample in the set of samples associated with the reference batch at sample point x in the third sequence to one or more samples in the set of samples associated with the particular batch at sample point k in the first sequence. As described herein, the reference batch at sample point x may be the batch portion of the reference batch, in which the batch portion of the reference batch may be determined based on the reference sample point x during the reference batch as described herein.

In some embodiments, after the warping path is determined, the batch analytic system 900 may determine one or more representation samples based on the samples in the set of samples associated with the particular batch at sample point k in the first sequence and the warping path. For example, for each sample in the set of samples associated with the reference batch at sample point x in the third sequence, the batch analytic system 900 may identify one or more samples in the set of samples associated with the particular batch at sample point k in the first sequence that are mapped to the sample by the warping path. The batch analytic system 900 may then determine a representation sample that corresponds to a particular sample point associated with the sample based on the one or more identified samples of the particular batch at sample point k. In some embodiments, the batch analytic system 900 may include the representation sample corresponding to the particular sample point in the batch representation corresponding to sample point k of the particular batch. In some embodiments, the warping path and the batch representation corresponding to sample point k of the particular batch may be determined based on the second DTW matrix D2 in a manner similar to the manner in which the warping path and the batch representation of a complete batch are determined based on the DTW matrix D as described herein with reference to FIGS. 11-12. These descriptions therefore are not repeated for brevity.

Thus, as described above, the batch analytic system 900 may synchronize the particular batch at sample point k with the reference batch at sample point x. As described herein, the sample point x may be the reference sample point during the reference batch in which the particular batch at sample point k has the lowest distance or the lowest level of difference with the reference batch at sample point x as compared to the reference batch at other sample points during the reference batch. As a result of this batch synchronization, the batch analytic system 900 may generate the batch representation corresponding to sample point k of the particular batch that includes x representation samples corresponding to x sample points from the start point of the reference batch up to the sample point x during the reference batch. Thus, the batch representation corresponding to sample point k of the particular batch may include the same number of samples (e.g., x samples) and have the same third batch length as the reference batch at sample point x.

In addition, as described above, the representation samples that form the batch representation corresponding to sample point k of the particular batch may be determined from the samples in the set of samples associated with the particular batch at sample point k based on the warping path. Similar to the warping path being used to determine the batch representation of the complete batch as described herein with reference to FIGS. 11-12, the warping path being used to determine the batch representation corresponding to sample point k of the particular batch may map the samples in the set of samples associated with the particular batch at sample point k in the first sequence to the samples in the set of samples associated with the reference batch at sample point x in the third sequence with the lowest total distance and the optimal alignment between these samples. As a result, the batch representation corresponding to sample point k of the particular batch may align with the reference batch at sample point x.

In some embodiments, the batch representation corresponding to sample point k of the particular batch may be generated in the form of a batch vector. For example, the batch analytic system 900 may aggregate x representation samples corresponding to x sample points in the batch representation corresponding to sample point k of the particular batch in a chronological order of their sample points to form one row of the batch vector. As described herein, each representation sample in the batch representation corresponding to sample point k of the particular batch may be determined based on the samples in the set of samples associated with the particular batch at sample point k and the warping path in a manner similar to the representation samples in the batch representation of the complete batch described herein with reference to FIGS. 11-12. Accordingly, similar to the representation samples in the batch representation of the complete batch, each representation sample in the batch representation corresponding to sample point k of the particular batch may include J values corresponding to J process variables of the industrial process. Thus, as the batch representation corresponding to sample point k of the particular batch includes x representation samples and each representation sample includes J values corresponding to J process variables, the batch representation corresponding to sample point k of the particular batch may be the batch vector that has the following dimensions:

Batch Representation Corresponding to Sample Point k∈M_{1×(xJ)}

In some embodiments, the batch analytic system 900 may use the batch representation corresponding to sample point k of the particular batch to perform an anomaly detection operation. For example, the batch analytic system 900 may provide the batch representation corresponding to sample point k of the particular batch to the anomaly detection system 200 as an input. The anomaly detection system 200 may use the batch representation corresponding to sample point k of the particular batch to compute an anomaly metric corresponding to sample point k for the particular batch using a PCA model associated with the industrial process as described herein.

As described herein, the non-anomalous batches (e.g., I non-anomalous batches) being used to generate the PCA models associated with industrial process (e.g., the PCA model corresponding to entire batch, the PCA model corresponding to sample point k, the PCA model corresponding to sample point x, etc.) may be synchronized with the reference batch. Therefore, these non-anomalous batches may include the same number of samples (e.g., M samples) as the reference batch and may align with the reference batch. On the other hand, the batch representation corresponding to sample point k of the particular batch may include the same number of samples (e.g., x samples) as the reference batch at sample point x and may align with the reference batch at sample point x, in which the sample point x is the reference sample point where the particular batch at sample point k is the most similar to the reference batch at sample point x as compared to the reference batch at other sample points during the reference batch. Accordingly, to determine the anomaly metric corresponding to sample point k for the particular batch, the anomaly detection system 200 may use the batch representation corresponding to sample point k of the particular batch, which has the same number of samples and aligns with the reference batch at sample point x, and the PCA model corresponding to the reference sample point x. The anomaly detection system 200 may then determine whether the particular batch at sample point k is anomalous based on the anomaly metric as described herein.

In some embodiments, instead of or in addition to providing the batch representation corresponding to sample point k of the particular batch to the anomaly detection system 200 as an input, the batch analytic system 900 may perform the operations of the anomaly detection system 200 described herein to determine the anomaly metric corresponding to sample point k of the particular batch and determine whether the particular batch at sample point k is anomalous based on the anomaly metric. Other use cases of the batch representation corresponding to sample point k of the particular batch are also possible and contemplated.

In some embodiments, instead of or in addition to the DTW technique described above, the batch analytic system 900 may use other techniques to generate a plurality of batch representations for a plurality of batches such that the batch representations of the batches may have the same size even though the plurality of batches may include one or more batches that have different number of samples in each batch. For example, the batch analytic system 900 may use one or more feature functions (also referred to herein as functions) to generate the batch representations of the batches.

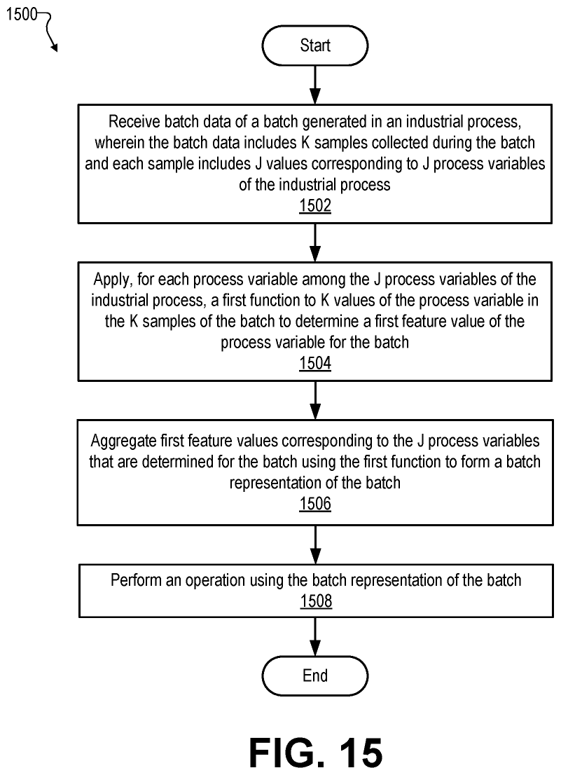

FIG. 15 illustrates an example batch synchronization method 1500 (e.g., the method 1500) for performing batch synchronization using one or more feature functions to generate a batch representation for a particular batch. The method 1500 may be used to generate a batch representation for a particular batch that is already complete or finished. While FIG. 15 shows illustrative operations according to one embodiment, other embodiments may omit, add to, reorder, and/or modify any of the operations shown in FIG. 15. In some examples, multiple operations shown in FIG. 15 or described in relation to FIG. 15 may be performed concurrently (e.g., in parallel) with one another, rather than being performed sequentially as illustrated and/or described. One or more of the operations shown in FIG. 15 may be performed by a batch analytic system such as the batch analytic system 900 and/or any implementation thereof.

At operation 1502, the batch analytic system 900 may receive batch data of a particular batch generated in an industrial process. The particular batch may be complete or finished, and the batch data may include K samples collected during the batch. In some embodiments, each sample of the particular batch may include J values corresponding to J process variables of the industrial process.

At operation 1504, for each process variable among the J process variables of the industrial process, the batch analytic system 900 may apply a first function (e.g., a mean function) to K values of the process variable in K samples of the particular batch to determine a first feature value (e.g., a mean value) of the process variable for the particular batch. Thus, the batch analytic system 900 may determine a total of J first feature values (e.g., J mean values) corresponding to J process variables for the particular batch using the first function.

At operation 1506, the batch analytic system 900 may aggregate the first feature values corresponding to J process variables that are determined for the particular batch using the first function to form a batch representation of the particular batch. In some embodiments, the batch representation of the particular batch may be generated in the form of a batch vector. For example, the batch analytic system 900 may aggregate the first feature values corresponding to J process variables based on the order in which the values of J process variables are included in each sample of each batch, thereby generating the batch vector representing the particular batch.

At operation 1508, the batch analytic system 900 may perform an operation using the batch representation of the particular batch. For example, the batch analytic system 900 may generate one or more PCA models of the industrial process using the batch representation of the particular batch and/or train one or more machine learning models using the batch representation of the particular batch as a training example. Additionally or alternatively, the batch analytic system 900 may determine an anomaly metric of the particular batch using the batch representation of the particular batch and a PCA model of the industrial process and/or provide the batch representation of the particular batch to a machine learning model as an input. The batch analytic system 900 may also use the batch representation of the particular batch to perform other operations.

Thus, as described above, the batch analytic system 900 may apply the first function to the samples of the particular batch to determine a feature value for each process variable based on the samples of the particular batch using the first function. The batch analytic system 900 may then aggregate the feature values corresponding to various process variables that are determined for the particular batch using the first function to form the batch representation of the particular batch. In some embodiments, the batch analytic system 900 may determine one or more batch representations for one or more batches generated in the industrial process using one or more functions in a similar manner.

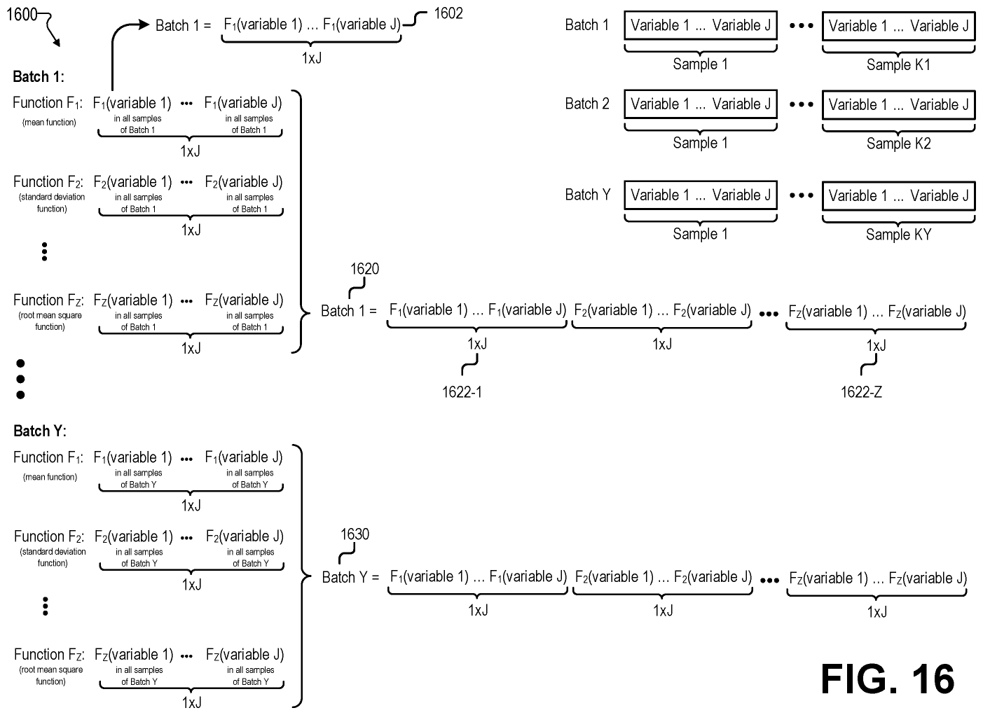

To illustrate, the batch analytic system 900 may generate Y batch representations for Y batches (e.g., batch 1 to batch Y). These batches may already be complete and the number of samples in each batch may or may not be the same. An example of Y batches is illustrated in diagram 1600 of FIG. 16. As depicted in FIG. 16, even though the number of samples in each batch may vary, each sample in these batches may include one value for each process variable among J process variables associated with the industrial process, and therefore each sample may include a total of J values corresponding to J process variables.

In some embodiments, the batch analytic system 900 may generate a batch representation for a particular batch among Y batches. The particular batch may be complete and may include K samples in the entire particular batch. As described above, each sample of the particular batch may include J values corresponding to J process variables. In some embodiments, the batch analytic system 900 may generate the batch representation of the particular batch using a first function. In particular, for each process variable among J process variables, the batch analytic system 900 may obtain K values of the process variable in all K samples of the particular batch, and apply the first function to these values to determine a first feature value of the process variable for the particular batch as described above.

As an example, the first function may be a mean function and the process variable may be “temperature.” In this case, the batch analytic system 900 may apply the mean function to all K values of the process variable “temperature” in K samples of the particular batch to obtain a mean value of the process variable “temperature” in the particular batch. Similarly, for a different process variable such as “pressure,” the batch analytic system 900 may apply the mean function to all K values of the process variable “pressure” in K samples of the particular batch to obtain a mean value of the process variable “pressure” in the particular batch.

Thus, regardless of the number of samples in the particular batch, the values of a process variable in all samples of the particular batch may be used to determine one feature value of that process variable for the particular batch using the first function. Accordingly, all values of the process variable in the particular batch may contribute to the feature value of the process variable determined for the particular batch using the first function, and therefore may be reflected by the feature value of the process variable determined for the particular batch using the first function. In some embodiments, for J process variables of the industrial process, the batch analytic system 900 may determine J feature values corresponding to J process variables for the particular batch using the first function as described above.

In some embodiments, the batch analytic system 900 may aggregate J feature values corresponding to J process variables that are determined for the particular batch with the first function into the batch representation of the particular batch. For example, the batch analytic system 900 may aggregate the mean value of the process variable “temperature,” the mean value of the process variable “pressure,” and the mean value of other process variables that are determined for the particular batch using the mean function into the batch representation of the particular batch in the example described above. In some embodiments, the batch analytic system 900 may arrange the feature values of J process variables within the batch representation of the particular batch in the same order as the order in which the values of J process variables are included in each sample of the particular batch. As an example of the batch representation of the particular batch that is determined using the first function, a batch representation 1602 of Batch 1 is depicted in FIG. 16. As the batch representation of the particular batch includes J feature values corresponding to J process variables that are determined for the particular batch with the first function, the batch representation of the particular batch may be a batch vector that has the following dimensions:

### Batch Representation∈M_{1×J}

Thus, regardless of the number of samples in the particular batch, the particular batch may be represented by the batch vector that includes 1 row and J columns in which J is the number of process variables associated with the industrial process and equals to the number of values in each sample. Accordingly, the batch representations generated for different batches may have the same size (e.g., M_{1×J}) even though the different batches may include one or more batches that have a different number of samples in each batch.

In some embodiments, the batch analytic system 900 may generate the batch representation of the particular batch using multiple functions. For each function, the batch analytic system 900 may determine J feature values corresponding to J process variables for the particular batch using the function as described above. In some embodiments, J feature values corresponding to J process variables that are determined for the particular batch using the function may form a set of feature values associated with the function for the particular batch. The batch analytic system 900 may aggregate these sets of feature values that are associated with different functions to form the batch representation of the particular batch.

As an example, the batch analytic system 900 may generate the batch representation of the particular batch using a first function and a second function. The second function may be different from the first function. To generate the batch representation of the particular batch, for each process variable among J process variables, the batch analytic system 900 may obtain K values of the process variable in all K samples of the particular batch. The batch analytic system 900 may apply the first function to K values of the process variable in K samples of the particular batch to determine a first feature value of the process variable for the particular batch. Accordingly, the batch analytic system 900 may obtain a set of first feature values including J first feature values corresponding to J process variables that are determined for the particular batch using the first function. The first feature values corresponding to J process variables may be arranged within the set of first feature values in the same order as the order in which the values of J process variables are included in each sample of the particular batch.

Similarly, the batch analytic system 900 may apply the second function to K values of the process variable in K samples of the particular batch to determine a second feature value of the process variable for the particular batch. Accordingly, the batch analytic system 900 may obtain a set of second feature values including J second feature values corresponding to J process variables that are determined for the particular batch using the second function. The second feature values corresponding to J process variables may be arranged within the set of second feature values in the same order as the order in which the values of J process variables are included in each sample of the particular batch.

In some embodiments, the batch analytic system 900 may aggregate the set of first feature values including J first feature values corresponding to J process variables that are determined for the particular batch using the first function and the set of second feature values including J second feature values corresponding to J process variables that are determined for the particular batch using the second function to form the batch representation of the particular batch. Accordingly, the batch representation of the particular batch may be a batch vector that has the following dimensions:

### Batch Representation∈M_{1×2J}

Another example is depicted in FIG. 16. As depicted in FIG. 16, the batch analytic system 900 may generate the batch representation of the particular batch using Z functions in which Z functions may be different from one another.

For example, the first function F₁ may be a mean function. For each process variable among J process variables, the batch analytic system 900 may apply the first function F₁ to K values of the process variable in K samples of the particular batch to determine the mean value of the process variable for the particular batch as described above. Accordingly, the batch analytic system 900 may obtain a set of mean values associated with the first function F₁ for the particular batch. The set of mean values may include J mean values corresponding to J process variables that are determined for the particular batch using the first function F₁. The mean values corresponding to J process variables may be arranged within in the set of mean values associated with the first function F₁ in the same order as the order in which the values of J process variables are included in each sample of the particular batch.

Similarly, the second function F₂ may be a standard deviation function. For each process variable among J process variables, the batch analytic system 900 may apply the second function F₂ to K values of the process variable in K samples of the particular batch to determine the standard deviation value of the process variable for the particular batch as described above. Accordingly, the batch analytic system 900 may obtain a set of standard deviation values associated with the second function F₂ for the particular batch. The set of standard deviation values may include J standard deviation values corresponding to J process variables that are determined for the particular batch using the second function F₂. The standard deviation values corresponding to J process variables may be arranged within the set of standard deviation values associated with the second function F₂ in the same order as the order in which the values of J process variables are included in each sample of the particular batch.

Similarly, the function F_{Z} may be a root mean square function. For each process variable among J process variables, the batch analytic system 900 may apply the function F_{Z} to K values of the process variable in K samples of the particular batch to determine the root mean square value of the process variable for the particular batch as described above. Accordingly, the batch analytic system 900 may obtain a set of root mean square values associated with the function F_{Z} for the particular batch. The set of root mean square values may include J root mean square values corresponding to J process variables that are determined for the particular batch using the function F_{Z}. The root mean square values corresponding to J process variables may be arranged within the set of root mean square values associated with the function F_{Z} in the same order as the order in which the values of J process variables are included in each sample of the particular batch.

As depicted in FIG. 16, the batch analytic system 900 may aggregate the set of mean values associated with the first function F₁, the set of standard deviation values associated with the second function F₂, and the sets of other feature values associated with other functions up to the set of root mean square values associated with the function F_{Z} that are determined for the particular batch to form the batch representation of the particular batch. For example, the batch analytic system 900 may sequentially append the set of mean values associated with the first function F₁, the set of standard deviation values associated with the second function F₂, and the sets of other feature values associated with other functions up to the set of root mean square values associated with the function F_{Z} to form the batch representation of the particular batch. As two examples of the batch representation of the particular batch that is determined using Z functions, a batch representation 1620 of Batch 1 and a batch representation 1630 of Batch Y are depicted in FIG. 16. Accordingly, the batch representation of the particular batch may include Z sets of feature values (e.g., set of feature values 1622-1 to set of feature values 1622-Z in the batch representation 1620 of Batch 1) that are respectively determined for the particular batch using Z functions. Each set of feature values may include J feature values corresponding to J process variables that are determined for the particular batch using a given function as described above. As a result, the batch representation of the particular batch may be a batch vector that has the following dimensions:

### Batch Representation∈M_{1×ZJ}

Thus, regardless of the number of samples in the particular batch, the particular batch may be represented by the batch vector that includes 1 row and Z*J columns, in which Z is the number of functions being used to determine different feature values of each process variable for the particular batch, and J is the number of process variables associated with the industrial process and equals to the number of values in each sample. Accordingly, the batch representations generated for different batches may have the same size (e.g., M_{1×ZJ}) even though the different batches may include one or more batches that have a different number of samples in each batch.

In some embodiments, the batch analytic system 900 may use the batch representations of the different batches that have the same size to perform various operations. As an example, the batch analytic system 900 may determine batch representations for I non-anomalous batches generated by the industrial process that are complete or finished using Z functions. Accordingly, the batch analytic system 900 may obtain I batch representations of I non-anomalous batches that have the same size (e.g., M_{1×ZJ}) as described above. The batch analytic system 900 may then provide the batch representations of I non-anomalous batches to the anomaly detection system 200. In some embodiments, the anomaly detection system 200 may generate one or more PCA models of the industrial process (e.g., the PCA model corresponding to entire batch, etc.) using the batch representations of I non-anomalous batches as described herein. Additionally or alternatively, the batch analytic system 900 may perform the operations of the anomaly detection system 200 described herein to generate the PCA models of the industrial process using the batch representations of I non-anomalous batches.

As another example, the batch analytic system 900 may determine a batch representation for a batch generated by the industrial process that is complete or finished using Z functions. Accordingly, the batch analytic system 900 may obtain a batch representation of the batch that has the same size (e.g., M_{1×ZJ}) as I non-anomalous batches being used to generate the PCA models of the industrial process. The batch analytic system 900 may then provide the batch representation of the batch to the anomaly detection system 200. In some embodiments, the anomaly detection system 200 may determine the anomaly metric of the batch using the batch representation of the batch and the PCA model corresponding to entire batch, and determine whether the batch is anomalous based on the anomaly metric of the batch as described herein. Additionally or alternatively, the batch analytic system 900 may perform the operations of the anomaly detection system 200 described herein to determine the anomaly metric of the batch using the batch representation of the batch and the PCA model corresponding to entire batch, and determine whether the batch is anomalous based on the anomaly metric of the batch.

As another example, the batch analytic system 900 may determine a plurality of batch representation for a plurality of batches generated by the industrial process that are complete or finished using Z functions. Accordingly, the batch analytic system 900 may obtain the plurality of batch representations of the plurality of batches that have the same size (e.g., M_{1×ZJ}). The batch analytic system 900 may then use the batch representations of the plurality of batches in training a machine learning model to perform batch analytic operations such as anomaly detection operations. Once the training of the machine learning model is completed, the machine learning model may be used to perform batch analytic operations for one or more batches generated by the industrial process. For example, for a batch generated by the industrial process that is complete or finished, the batch analytic system 900 may determine a batch representation of the batch using Z functions. Accordingly, the batch analytic system 900 may obtain the batch representation of the batch that has the same size (e.g., M_{1×ZJ}) as the plurality of batch representations of the plurality of batches being used to train the machine learning model. The batch analytic system 900 may then provide the batch representation of the batch to the machine learning model as an input to generate an analytic result for the batch using the machine learning model. Other use cases of the batch representations of the batches are also possible and contemplated.

Thus, as described above, the batch analytic system 900 may use one or more functions to determine one or more feature values of each process variable for the particular batch. The feature values (e.g., the mean value, the standard deviation value, the root mean square value, etc.) of a process variable may provide insightful information to evaluate the process variable throughout the particular batch. Non-limiting examples of a feature value determined by a function include, but are not limited to, a mean value, a standard deviation value, a root mean square value, a median value, a length value, a frequency value, a maximum value, a minimum value, a variation coefficient value, a variance value, a skewness value, a kurtosis value, an absolute sum of changes, a longest strike below mean, a longest strike above mean, or a count above mean, etc. Other feature values are also possible and contemplated.

In some embodiments, the batch analytic system 900 may select one or more particular functions to be included in Z functions being used to generate a batch representation of a batch. The one or more functions may be selected based on nature of a process variable (e.g., the process variable “temperature,” the process variable “pressure,” the process variable “motor speed,” etc.) in the industrial process.

For example, to select the one or more functions, the batch analytic system 900 may analyze a plurality of batches generated by the industrial process that are complete or finish, in which the plurality of batches may have a different number of samples in each batch and therefore have different batch lengths. In some embodiments, the batch analytic system 900 may determine a plurality of variable trajectories of a particular process variable in the plurality of batches. For example, for each batch in the plurality of batches, the batch analytic system 900 may determine a variable trajectory of the particular process variable in the batch based on the values of the particular process variable in the samples collected during the batch. This variable trajectory may be generated in the form of a line graph and may indicate the pattern or the course in which the values of the process variable change over time during the batch.

In some embodiments, the batch analytic system 900 may determine that the plurality of variable trajectories of the particular process variable in the plurality of batches have the same shape. Accordingly, the batch analytic system 900 may determine a variable pattern of the particular process variable based on the same shape of the variable trajectories of the particular process variable. For example, the batch analytic system 900 may analyze the common shape that the variable trajectories of the particular process variable have in long batches and in short batches, and determine the variable pattern to which the particular process variable conforms. In some embodiments, a long batch may include a relatively large number of samples, and a short batch may include a relatively small number of samples.

As an example, the batch analytic system 900 may determine that the variable trajectories of the process variable “temperature” has a shape of Gaussian distribution both in the long batches and in the short batches. Accordingly, the batch analytic system 900 may determine that the variable trajectories of the process variable “temperature” follow the Gaussian distribution in the batches that have different batch lengths, and therefore determine that the variable pattern of the process variable “temperature” is the Gaussian distribution.

As another example, the batch analytic system 900 may determine that the variable trajectories of the process variable “motor speed” are sinusoidal both in the long batches and in the short batches. Accordingly, the batch analytic system 900 may determine that the variable trajectories of the process variable “motor speed” follow the sinusoidal pattern in the batches that have different batch lengths, and therefore determine that the variable pattern of the process variable “motor speed” is the sinusoidal pattern.

In some embodiments, when the particular process variable follows the variable pattern in the batches that have different batch lengths, the batch analytic system 900 may compare the attributes of the variable pattern that are associated with the variable trajectory of the particular process variable in a particular batch to the attributes of the variable pattern that are associated with the variable trajectories of the particular process variable in non-anomalous batches. Based on such comparison, the batch analytic system 900 may determine whether the variable trajectory of the particular process variable in the particular batch that follows the variable pattern is significantly different from the variable trajectories of the particular process variable in the non-anomalous batches that also follow the variable pattern, and therefore determine whether the particular batch is anomalous. In some embodiments, the batch analytic system 900 may select one or more particular functions that determine one or more attributes associated with the variable pattern of the particular process variable, and include these particular functions in Z functions that are applied to the samples of a batch to generate a batch representation for the batch. Thus, the batch analytic system 900 may apply these particular functions to the batch data of the batch when determining the batch representation of the batch using Z functions.

As an example, for the process variable “temperature” that follows the Gaussian distribution, the batch analytic system 900 may determine that the Gaussian distribution may be described with the mean value, the standard deviation value, the skewness value, and the kurtosis value. In this case, the batch analytic system 900 may select the mean function, the standard deviation function, the skewness function, and the kurtosis function to be included in Z functions that are applied to the samples of a batch to generate a batch representation of the batch. Other functions that determine other attributes of the Gaussian distribution are also possible and contemplated. In this example, Z functions may at least include the functions that determine the attributes of the Gaussian distribution and may include other functions as well.

As another example, for the process variable “motor speed” that follows the sinusoidal pattern, the batch analytic system 900 may determine that the sinusoidal pattern may be described with the frequency value and the maximum amplitude value. In this case, the batch analytic system 900 may select the frequency function and the maximum function to be included in Z functions that are applied to the samples of a batch to generate a batch representation of the batch. Other functions that determine other attributes of the sinusoidal pattern are also possible and contemplated. In this example, Z functions may at least include the functions that determine the attributes of the sinusoidal pattern and may include other functions as well.

Thus, as described above, a particular process variable of the industrial process may conform to a variable pattern in the batches that have different batch lengths. Non-limiting examples of the variable pattern of the particular process variable include, but are not limited to, a Gaussian distribution, an exponential distribution, a gamma distribution, a sinusoidal pattern, or a linear pattern, etc. Other types of variable patterns are also possible and contemplated. In some embodiments, when the particular process variable conforms to the variable pattern in the batches that have different batch lengths, the batch analytic system 900 may select one or more particular functions that determine one or more attributes associated with the variable pattern of the particular process variable, and include these particular functions in Z functions being used to determine a batch representation of a batch as described above.

In some embodiments, for the particular process variable that follows the variable pattern in the batches that have different batch lengths and for each particular function included in Z functions that determines an attribute associated with the variable pattern of the particular process variable, the batch analytic system 900 may identify an element in the batch representation of the particular batch that corresponds to the particular process variable and the particular function. The element corresponding to the particular process variable and the particular function in the batch representation of the particular batch may be a value in the batch vector of the particular batch that is obtained when the particular function is applied to K values of the particular process variable in K samples of the particular batch. For example, as depicted in FIG. 16, an element F₂(variable 1) in the batch representation 1620 of Batch 1 may correspond to the second function F₂ (e.g., the standard deviation function) and the process variable 1 (e.g., the process variable “temperature”) of the industrial process and may be obtained when the second function F₂ is applied to K values of the process variable 1 in K samples of Batch 1.

Thus, the batch analytic system 900 may identify one or more elements corresponding to the particular process variable and the one or more particular functions in the batch representation of the particular batch, in which the particular process variable may follow the variable pattern and the one or more particular functions may determine one or more attributes associated with the variable pattern as described above. Accordingly, these elements may indicate the attributes of the variable pattern that are associated with the variable trajectory of the particular process variable in the particular batch, in which the variable trajectory of the particular process variable conforms to the variable pattern. Thus, these elements may provide descriptive information about the variable trajectory of the particular process variable in the particular batch, which follows the variable pattern.

In some embodiments, the batch analytic system 900 may indicate or specify one or more elements corresponding to the particular process variable and the particular functions in the batch representation of the particular batch as one or more anomaly detection features associated with the particular process variable in the batch representation of the particular batch. Similarly, the batch analytic system 900 may indicate or specify one or more elements corresponding to the particular process variable and the particular functions in the batch representation of a different batch as one or more anomaly detection features associated with the particular process variable in the batch representation of the different batch. An anomaly detection feature in the batch representation of the particular batch and an anomaly detection feature in the batch representation of the different batch that correspond to the same process variable and the same particular function may be considered corresponding to one another and may have the same relative position within the batch representation of the respective batch. In some embodiments, for each anomaly detection feature associated with the particular process variable, the batch analytic system 900 may determine the relative position of the anomaly detection feature within a batch representation, and store the relative position of the anomaly detection feature in the data storage. As the relative position of the anomaly detection feature is the same in a batch representation of any batch, the batch analytic system 900 may obtain the relative position of the anomaly detection feature from the data storage, and quickly identify the anomaly detection feature in a batch representation of any given batch.

As an example, for the process variable “temperature” that follows the Gaussian distribution in the batches that have different batch lengths, the particular functions may be the mean function, the standard deviation function, the skewness function, and the kurtosis function as described above. In this case, the batch analytic system 900 may identify in the batch vector of the particular batch the elements corresponding to the process variable “temperature” in the set of mean values determined for the particular batch using the mean function, the set of standard deviation values determined for the particular batch using the standard deviation function, the set of skewness values determined for the particular batch using the skewness function, and the set of kurtosis values determined for the particular batch using the kurtosis function that are in the batch vector of the particular batch. The batch analytic system 900 may then indicate or specify these elements as anomaly indication features associated with the process variable “temperature” which follows the Gaussian distribution. The batch analytic system 900 may determine the relative positions of the anomaly detection features associated with the process variable “temperature” within a batch representation such as the batch vector of the particular batch, and store the relative positions of these anomaly detection features in the data storage.

As another example, for the process variable “motor speed” that follows the sinusoidal pattern in the batches that have different batch length, the particular functions may be the frequency function and the maximum function as described above. In this case, the batch analytic system 900 may identify in the batch vector of the particular batch the elements corresponding to the process variable “motor speed” in the set of frequency values determined for the particular batch using the frequency function, and the set of maximum values determined for the particular batch using the maximum function that are in the batch vector of the particular batch. The batch analytic system 900 may then indicate or specify these elements as anomaly indication features associated with the process variable “motor speed” which follows the sinusoidal pattern. The batch analytic system 900 may determine the relative positions of the anomaly detection features associated with the process variable “motor speed” within a batch representation such as the batch vector of the particular batch, and store the relative positions of these anomaly detection features in the data storage.

In some embodiments, the batch analytic system 900 may determine the anomaly of the particular batch based on the anomaly indication features associated with the particular process variable in the batch representation of the particular batch. To determine the anomaly of the particular batch, for each anomaly detection feature among the anomaly detection features associated with the particular process variable, the batch analytic system 900 may determine a difference value of the anomaly detection feature between the particular batch and one or more non-anomalous batches generated in the industrial process. For example, the batch analytic system 900 may obtain the values of the anomaly indication feature in the batch representations of the non-anomalous batches, and compute an average value of the anomaly indication feature in the batch representations of the non-anomalous batches. The batch analytic system 900 may then determine a difference between the value of the anomaly detection feature in the batch representation of the particular batch and the average value of the anomaly detection feature in the batch representations of the non-anomalous batches, and determine such difference to be the difference value of the anomaly detection feature between the particular batch and the non-anomalous batches.

In some embodiments, the batch analytic system 900 may determine a total difference value based on the difference values that are determined for the one or more anomaly detection features associated with the particular process variable as described above. For example, for each anomaly detection feature associated with the particular process variable, the batch analytic system 900 may obtain the difference value of the anomaly detection feature between the particular batch and the non-anomalous batches as determined above. The batch analytic system 900 may then compute a sum of these difference values to be the total difference value. Accordingly, the total difference value may indicate the total difference between the anomaly detection features associated with the particular process variable in the batch representation of the particular batch (which indicate the attributes of the variable pattern that are associated with the variable trajectory of the particular process variable in the particular batch) and the average anomaly detection features associated with the particular process variable in the batch representations of the non-anomalous batches (which indicate the average attributes of the variable pattern that are associated with the variable trajectories of the particular process variable in the non-anomalous batches). Accordingly, the total difference value may indicate the difference between the variable trajectory of the particular process variable in the particular batch and the variable trajectories of the particular process variable in the non-anomalous batches, which all follow the variable pattern of the particular process variable.

In some embodiments, the batch analytic system 900 may determine whether the total difference value satisfies a total difference value threshold. If the total difference value satisfies the total difference value threshold (e.g., the total difference value is larger than the total difference value threshold), the batch analytic system 900 may determine that the attributes of the variable pattern that are associated with the variable trajectory of the particular process variable in the particular batch are significantly different from the average attributes of the variable pattern that are associated with the variable trajectories of the particular process variable in the non-anomalous batches. Accordingly, the batch analytic system 900 may determine that even though the variable trajectories of the process variable in the particular batch and in the non-anomalous batches all follow the variable pattern of the particular process variable, the variable trajectory of the particular process variable in the particular batch that follows the variable pattern is significantly different from the variable trajectories of the particular process variable in the non-anomalous batches that also follow the variable pattern, and therefore determine that the particular batch is anomalous. In this case, the batch analytic system 900 may provide a notification indicating that the particular batch is anomalous to the process operator.

As an example, for the process variable “temperature” that follows the Gaussian distribution, the anomaly indication features associated with the process variable “temperature” in the batch representation of the particular batch may indicate the attributes (e.g., the mean value, the standard deviation value, the skewness value, the kurtosis value, etc.) associated with the variable trajectory of the process variable “temperature” in the particular batch that follows a Gaussian distribution. On the other hand, the average values of the anomaly indication features associated with the process variable “temperature” in the batch representations of the non-anomalous batches may indicate the average attributes (e.g., the average mean value, the average standard deviation value, the average skewness value, the average kurtosis value, etc.) associated with the variable trajectories of the process variable “temperature” in the non-anomalous batches that also follow Gaussian distributions. Thus, by evaluating the difference of the anomaly indication features associated with the process variable “temperature” between the particular batch and the non-anomalous batches, the batch analytic system 900 may evaluate the difference between the variable trajectory of the process variable “temperature” in the particular batch that follows a Gaussian distribution and the variable trajectories of the process variable “temperature” in the non-anomalous batches that also follow Gaussian distributions. In other words, the batch analytic system 900 may evaluate the difference between the Gaussian distribution of the process variable “temperature” in the particular batch and the Gaussian distributions of the process variable “temperature” in the non-anomalous batches, and determine whether the particular batch is anomalous accordingly.

As another example, for the process variable “motor speed” that follows the sinusoidal pattern, the anomaly indication features associated with the process variable “motor speed” in the batch representation of the particular batch may indicate the attributes (e.g., the frequency value, the maximum value, etc.) associated with the variable trajectory of the process variable “motor speed” in the particular batch that follows a sinusoidal pattern. On the other hand, the average values of the anomaly indication features associated with the process variable “motor speed” in the batch representations of the non-anomalous batches may indicate the average attributes (e.g., the average frequency value, the average maximum value, etc.) associated with the variable trajectories of the process variable “motor speed” in the non-anomalous batches that also follow sinusoidal patterns. Thus, by evaluating the difference of the anomaly indication features associated with the process variable “motor speed” between the particular batch and the non-anomalous batches, the batch analytic system 900 may evaluate the difference between the variable trajectory of the process variable “motor speed” in the particular batch that follows a sinusoidal pattern and the variable trajectories of the process variable “motor speed” in the non-anomalous batches that also follow sinusoidal patterns. In other words, the batch analytic system 900 may evaluate the difference between the sinusoidal pattern of the process variable “motor speed” in the particular batch and the sinusoidal patterns of the process variable “motor speed” in the non-anomalous batches, and determine whether the particular batch is anomalous accordingly.

Thus, as described above, the batch analytic system 900 may indicate or specify the elements that correspond to the particular process variable and the particular functions in a batch representation of any batch as anomaly detection features associated with the particular process variable in that batch representation. The particular functions may be selectively identified based on the characteristics of the particular process variable as described above. Additionally or alternatively, the batch analytic system 900 may configure a machine learning model based on these elements. For example, the batch analytic system 900 may implement a machine learning model to perform batch analytic operations such as anomaly detection operations for the batches generated in the industrial process. The machine learning model may be trained with the batch representations of the plurality of batches that are determined using Z functions as described herein. In some embodiments, the batch analytic system 900 may configure the machine learning model to assign higher weight values to the one or more elements that correspond to the particular process variable and the one or more particular functions as compared to other elements in a batch representation of each batch. Accordingly, when processing a batch representation of any batch, the machine learning model may consider the elements corresponding to the particular process variable and the one or more particular functions as anomaly detection features associated with the particular process variable in the batch representation. For example, the machine learning model may consider these elements with higher weight values as compared to other elements in the batch representation of the batch when determining whether the batch is anomalous, thereby improving the accuracy of the machine learning model in anomaly detection.

Embodiments, systems, and components described herein, as well as control systems and automation environments in which various aspects set forth in the present disclosure may be carried out, may include computer or network components such as servers, clients, programmable logic controllers (PLCs), automation controllers, communications modules, mobile computers, on-board computers for mobile vehicles, wireless components, control components and so forth which are capable of interacting across a network. Computers and servers may include one or more processors (e.g., electronic integrated circuits that perform logic operations using electric signals) configured to execute instructions stored in media such as random access memory (RAM), read only memory (ROM), hard drives, as well as removable memory devices (e.g., memory sticks, memory cards, flash drives, external hard drives, etc.).

Similarly, the term PLC or automation controller as used herein may include functionality that can be shared across multiple components, systems, and/or networks. As an example, one or more PLCs or automation controllers may communicate and cooperate with various network devices across the network. These network devices may include any type of control, communications module, computer, Input/Output (I/O) device, sensor, actuator, and human machine interface (HMI) that communicate via the network, which includes control, automation, and/or public networks. The PLC or automation controller may also communicate with and may control other devices such as standard or safety-rated I/O modules including analog, digital, programmed/intelligent I/O modules, other programmable controllers, communication modules, sensors, actuators, output devices, and the like.

The network may include public networks such as the Internet, intranets, and automation networks such as control and information protocol (CIP) networks including DeviceNet, ControlNet, safety networks, and Ethernet/IP. Other networks may include Ethernet, DH/DH+, Remote I/O, Fieldbus, Modbus, Profibus, CAN, wireless networks, serial protocols, etc. In addition, the network devices may include various possibilities (hardware and/or software components). The network devices may also include components such as switches with virtual local area network (VLAN) capability, LANs, WANs, proxies, gateways, routers, firewalls, virtual private network (VPN) devices, servers, clients, computers, configuration tools, monitoring tools, and/or other devices.

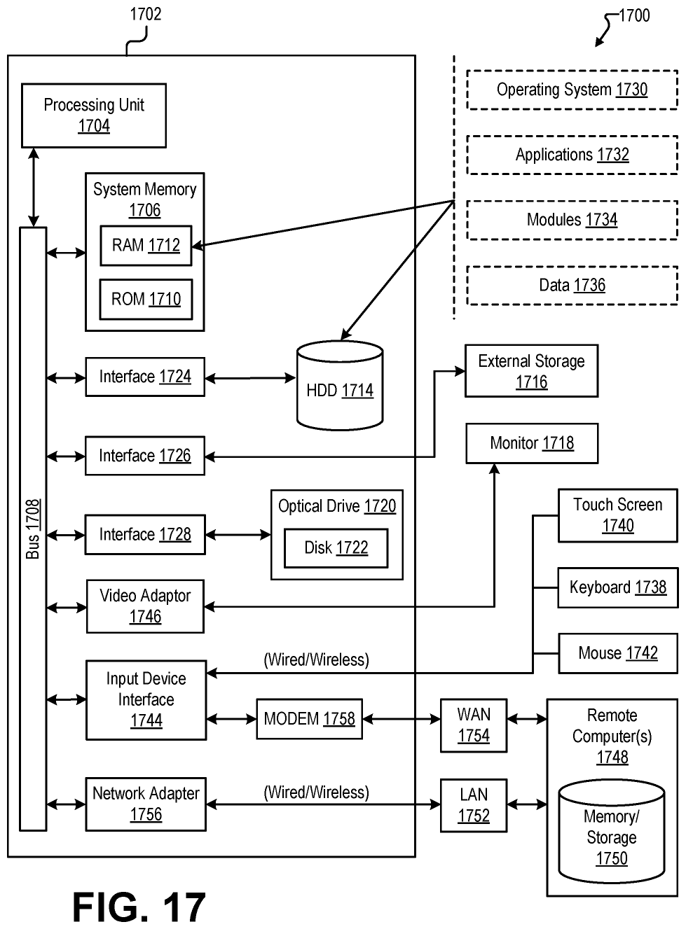

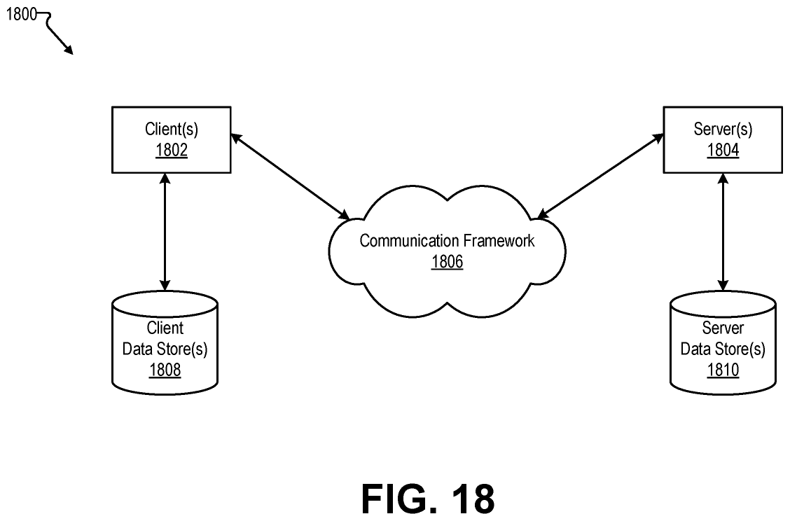

To provide a context for various aspects of the present disclosure, FIGS. 17 and 18 illustrate an exemplary environment in which various aspects of the present disclosure may be implemented. While the embodiments are described herein in the general context of computer-executable instructions that can be executed on one or more computers, it should be understood that the embodiments may also be implemented in combination with other program modules and/or implemented as a combination of hardware and software.

The program modules may include routines, programs, components, data structures, etc., that perform particular tasks or may implement particular abstract data types. Moreover, it should be understood that the methods described herein may be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which may be operatively coupled to one or more associated devices.

The exemplary embodiments described herein may also be practiced in distributed computing environments where certain tasks may be performed by remote processing devices that are linked through a communications network. In a distributed computing environment, program modules may be located in both local and remote memory storage devices.

Computing devices may include a variety of media, which may include computer-readable storage media, machine-readable storage media, and/or communications media. Computer-readable storage media or machine-readable storage media may be any available storage media that can be accessed by the computer and may include both volatile and nonvolatile media, removable and non-removable media. By way of example and not limitation, computer-readable storage media or machine-readable storage media may be implemented in connection with any method or technology for storage of information such as computer-readable or machine-readable instructions, program modules, structured data or unstructured data. Computer-readable storage media may be accessed by one or more local or remote computing devices (e.g., via access requests, queries, or other data retrieval protocols) for various operations with respect to the information stored in the computer-readable storage media.

Examples of computer-readable storage media may include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage, or other magnetic storage devices, or other solid state storage devices, or other tangible and/or non-transitory media, which may be used to store desired information. The terms “tangible” or “non-transitory” as applied to storage, memory or computer-readable media herein, should be understood to exclude only propagating transitory signals per se as modifiers and do not relinquish rights to all standard storage, memory, or computer-readable media that are not only propagating transitory signals per se.

Communications media may embody computer-readable instructions, data structures, program modules, or other structured or unstructured data in a data signal such as a modulated data signal (e.g., a carrier wave or other transport mechanism) and may include any information delivery or transport media. The term “modulated data signal” or signals refers to a signal that has one or more of its characteristics set or changed to encode information in one or more signals. By way of example and not limitation, communication media may include wired media (e.g., a wired network or direct-wired connection) and wireless media (e.g., acoustic, RF, infrared, etc.).

FIG. 17 illustrates an example environment 1700 for implementing various embodiments of the aspects described herein. For example, the environment 1700 may implement the system 100, the anomaly detection system 200, the training system 600, the batch analytic system 900, and/or other systems and their components described herein. As depicted in FIG. 17, the environment 1700 may include a computing device 1702. The computing device 1702 may include a processing unit 1704, a system memory 1706, and a system bus 1708. The system bus 1708 may couple various system components such as the system memory 1706 to the processing unit 1704. The processing unit 1704 may be any commercially available processor. Dual microprocessors and other multi-processor architectures may also be used as the processing unit 1704.

The system bus 1708 may be a bus structure that can further interconnect to a memory bus (with or without a memory controller), a peripheral bus, and/or a local bus using any commercially available bus architecture. The system memory 1706 may include ROM 1710 and RAM 1712. A basic input/output system (BIOS) may be stored in a non-volatile memory such as ROM, erasable programmable read only memory (EPROM), EEPROM, etc. BIOS may contain the basic routines for transferring information between elements in the computing device 1702, such as during startup. The RAM 1712 may also include a high-speed RAM such as static RAM for caching data.

The computing device 1702 may additionally include an internal hard disk drive (HDD) 1714 (e.g., EIDE, SATA), one or more external storage devices 1716 (e.g., a magnetic floppy disk drive (FDD), a memory stick or flash drive reader, a memory card reader, etc.), and an optical disk drive 1720 (which may read or write from a CD-ROM disc, a DVD, a BD, etc.). While the internal HDD 1714 is illustrated as located within the computing device 1702, the internal HDD 1714 may also be configured for external use in a suitable chassis (not shown). Additionally, while not shown in the environment 1700, a solid state drive (SSD) may be used in addition to, or in place of, the HDD 1714. The HDD 1714, external storage device(s) 1716, and optical disk drive 1720 may be connected to the system bus 1708 by an HDD interface 1724, an external storage interface 1726, and an optical drive interface 1728, respectively. The interface 1724 for external drive implementations may include at least one or both of Universal Serial Bus (USB) and Institute of Electrical and Electronics Engineers (IEEE) 1394 interface technologies. Other external drive connection technologies are also possible and contemplated.

The drives and their associated computer-readable storage media may provide nonvolatile storage of data, data structures, computer-executable instructions, etc. In the computing device 1702, the drives and storage media may accommodate the storage of any data in a suitable digital format. Although the description of computer-readable storage media above refers to respective types of storage devices, it should be understood that other types of storage media which are readable by a computer, whether presently existing or developed in the future, may also be used in the example operating environment 1700, and that any such storage media may contain computer-executable instructions for performing the methods described herein.

A number of program modules may be stored in the drives and RAM 1712, including an operating system 1730, one or more application programs 1732, other program modules 1734, and program data 1736. All or portions of the operating system 1730, the applications 1732, the modules 1734, and/or the data 1736 may also be cached in the RAM 1712. The systems and methods described herein may be implemented using various operating systems or combinations of operating systems that are commercially available.

The computing device 1702 may optionally include emulation technologies. For example, a hypervisor (not shown) or other intermediary may emulate a hardware environment for the operating system 1730, and the emulated hardware may optionally be different from the hardware illustrated in FIG. 17. In such an embodiment, the operating system 1730 may comprise one virtual machine (VM) of multiple VMs hosted on the computing device 1702. Furthermore, the operating system 1730 may provide runtime environments (e.g., the Java runtime environment or the .NET framework) for the application programs 1732. The runtime environments may be consistent execution environments that allow application programs 1732 to run on any operating system that includes the runtime environment. Similarly, the operating system 1730 may support containers, and application programs 1732 may be in the form of containers, which are lightweight, standalone, executable packages of software that include code, runtime, system tools, system libraries, settings, and/or other components for executing an application.

In addition, the computing device 1702 may be enable with a security module, such as a trusted processing module (TPM). For example, with a TPM, boot components may hash next-in-time boot components, and wait for a match of results to secured values, before loading a next boot component. This process may take place at any layer in the code execution stack of the computing device 1702 (e.g., applied at the application execution level or at the operating system (OS) kernel level) thereby enabling security at any level of code execution.

A user may enter commands and information into the computing device 1702 through one or more wired/wireless input devices (e.g., a keyboard 1738, a touch screen 1740, and a pointing device, such as a mouse 1742). Other input devices (not shown) may include a microphone, an infrared (IR) remote control, a radio frequency (RF) remote control, or other remote control, a joystick, a virtual reality controller and/or virtual reality headset, a game pad, a stylus pen, an image input device (e.g., one or more cameras), a gesture sensor input device, a vision movement sensor input device, an emotion or facial detection device, a biometric input device (e.g., fingerprint or iris scanner), etc. These input devices and other input devices may be connected to the processing unit 1704 through an input device interface 1744 that may be coupled to the system bus 1708, but may be connected by other interfaces, such as a parallel port, an IEEE 1394 serial port, a game port, a USB port, an IR interface, a BLUETOOTH® interface, etc.

A monitor 1718 or other type of display device may be also connected to the system bus 1708 via an interface, such as a video adapter 1746. In addition to the monitor 1718, the computing device 1702 may also include other peripheral output devices (not shown), such as speakers, printers, etc.

The computing device 1702 may operate in a networked environment using logical connections via wired and/or wireless communications to one or more remote computers, such as remote computer(s) 1748. The remote computer(s) 1748 may be a workstation, a server computer, a router, a personal computer, portable computer, microprocessor-based entertainment appliance, a peer device, or other common network node. The remote computer(s) 1748 may include many or all of the elements in the computing device 1702 although only a memory/storage device 1750 is illustrated for purposes of brevity. As depicted in FIG. 17, the logical connections of remote computer(s) 1748 may include wired/wireless connectivity to a local area network (LAN) 1752 and/or to larger networks such as a wide area network (WAN) 1754. Such LAN and WAN networking environments may be commonplace in offices and companies, and may facilitate enterprise-wide computer networks (e.g., intranets) all of which may connect to a global communications network (e.g., the Internet).

When used in a LAN networking environment, the computing device 1702 may be connected to the local network 1752 through a wired and/or wireless communication network interface or adapter 1756. The adapter 1756 may facilitate wired or wireless communication to the LAN 1752, which may also include a wireless access point (AP) disposed thereon for communicating with the adapter 1756 in a wireless mode.

When used in a WAN networking environment, the computing device 1702 may include a modem 1758 or may be connected to a communication server on the WAN 1754 via other means to establish communication over the WAN 1754, such as by way of the Internet. The modem 1758, which may be internal or external and a wired or wireless device, may be connected to the system bus 1708 via the input device interface 1744. In a networked environment, program modules that are depicted relative to the computing device 1702 or portions thereof, may be stored in the remote memory/storage device 1750. It should be understood that the network connections depicted in FIG. 17 are merely example and other implementations to establish a communication link between the computers/computing devices are also possible and contemplated.

When used in either a LAN or WAN networking environment, the computing device 1702 may access cloud storage systems or other network-based storage systems in addition to, or in place of, the external storage devices 1716 as described herein. In some embodiments, a connection between the computing device 1702 and a cloud storage system may be established over the LAN 1752 or WAN 1754 (e.g., by the adapter 1756 or the modem 1758, respectively). Upon connecting the computing device 1702 to an associated cloud storage system, the external storage interface 1726 may, with the aid of the adapter 1756 and/or the modem 1758, manage the storage provided by the cloud storage system as it would for other types of external storage. For example, the external storage interface 1726 may be configured to provide access to cloud storage resources as if those resources were physically connected to the computing device 1702.

The computing device 1702 may be operable to communicate with any wireless devices or entities operatively disposed in wireless communication such as a printer, scanner, desktop and/or portable computer, portable data assistant, communications satellite, any piece of equipment or location associated with a wirelessly detectable tag (e.g., a kiosk, news stand, store shelf, etc.), telephone, etc. This communication may use Wireless Fidelity (Wi-Fi) and BLUETOOTH® wireless technologies. Thus, the communication may be a predefined structure as in a conventional network or simply an ad hoc communication between at least two devices.

FIG. 18 illustrates an exemplary computing environment 1800 with which the embodiments described herein may be implemented. The computing environment 1800 may include one or more client(s) 1802. The client(s) 1802 may be hardware and/or software (e.g., threads, processes, computing devices). The computing environment 1800 may also include one or more server(s) 1804. The server(s) 1804 may also be hardware and/or software (e.g., threads, processes, computing devices). For example, the servers 1804 may house threads that implement one or more embodiments described herein. One possible communication between a client 1802 and servers 1804 may be in the form of a data packet adapted to be transmitted between two or more computer processes. The computing environment 1800 may include a communication framework 1806 that may facilitate communications between the client(s) 1802 and the server(s) 1804. The client(s) 1802 may be operably connected to one or more client data store(s) 1808 that may be used to store information local to the client(s) 1802. Similarly, the server(s) 1804 may be operably connected to one or more server data store(s) 1810 that may be used to store information local to the servers 1804.

The foregoing description has been presented for the purposes of illustration and description. It is not intended to be exhaustive or to limit the specification to the precise form disclosed. Many modifications and variations are possible in light of the above teaching. It is intended that the scope of the disclosure is not limited by this detailed description and the modifications and variations that fall within the spirit and scope of the appended claims are included. As will be understood by those familiar with the art, the specification may be embodied in other specific forms without departing from the spirit or essential characteristics thereof.

In particular and with regard to various functions performed by the above-described components, devices, circuits, systems, and/or the like, the terms (including a reference to a “means”) used to describe such components are intended to correspond, unless otherwise indicated, to any component which performs the specified function of the described component (e.g., a functional equivalent), even if such component may not be structurally equivalent to the described structure, which illustrates exemplary aspects of the present disclosure. In this regard, it should also be recognized that the present disclosure includes a system as well as a computer-readable medium having computer-executable instructions for performing the acts and/or events of various methods described herein.

In addition, while a particular feature of the present disclosure may have been disclosed with respect to only one of several implementations, such feature may be combined with one or more other features of the other implementations as may be desired and advantageous for a given application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Instead, the use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from a computer-readable device, carrier, or media. For example, computer readable media may include, but are not limited to, magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.).

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
receiving, by a batch analytic system, batch data of a batch generated in an industrial process, wherein the batch data includes a set of samples associated with the batch, the batch is complete and has a first batch length;
determining, by the batch analytic system, a reference batch based on a plurality of non-anomalous batches generated in the industrial process, wherein each non-anomalous batch has a same second batch length;
generating, by the batch analytic system, a batch representation of the batch based on the batch data of the batch and the reference batch, wherein the batch representation of the batch aligns with the reference batch and has the second batch length associated with the reference batch; and
performing, by the batch analytic system, an operation using the batch representation of the batch.

2. The method of claim 1, wherein:
each non-anomalous batch is verified as not including an anomaly throughout a batch duration of the non-anomalous batch; and
the reference batch includes one or more samples corresponding to one or more sample points at which one or more samples of the non-anomalous batch are respectively collected and the reference batch has the second batch length.

3. The method of claim 1, wherein determining the reference batch includes:
identifying, for each sample point, a plurality of samples corresponding to the sample point in the plurality of non-anomalous batches; and
determining a sample corresponding to the sample point for the reference batch based on the plurality of samples corresponding to the sample point in the plurality of non-anomalous batches.

4. The method of claim 3, wherein determining the sample corresponding to the sample point for the reference batch includes:
determining, for each process variable of the industrial process, an average value of the process variable in the plurality of samples corresponding to the sample point in the plurality of non-anomalous batches; and
determining a value of the process variable in the sample corresponding to the sample point in the reference batch to be the average value.

5. The method of claim 1, wherein determining the reference batch includes:
determining, for each non-anomalous batch among the plurality of non-anomalous batches, one or more batch parameters of the non-anomalous batch;
computing a batch score of the non-anomalous batch based on the one or more batch parameters of the non-anomalous batch and one or more weight values of the one or more batch parameters; and
selecting the reference batch from the plurality of non-anomalous batches based on batch scores of the plurality of non-anomalous batches.

6. The method of claim 5, wherein determining the one or more batch parameters of the non-anomalous batch includes one or more of:
determining an average value of a particular process variable in the non-anomalous batch; and
determining a production rate of the non-anomalous batch based on a total amount of products generated during the non-anomalous batch and a batch duration of the non-anomalous batch.

7. The method of claim 1, further comprising:
identifying one or more additional non-anomalous batches that are generated subsequent to the plurality of non-anomalous batches in the industrial process; and
re-determining the reference batch based at least on the one or more additional non-anomalous batches.

8. The method of claim 1, wherein generating the batch representation of the batch includes:
determining a Dynamic Time Warping (DTW) matrix between a first sequence including the set of samples associated with the batch and a second sequence including a set of samples associated with the reference batch, wherein the first sequence has the first batch length and the second sequence has the second batch length;
determining a warping path between the first sequence and the second sequence based on the DTW matrix, wherein the warping path maps each sample of the batch in the first sequence to one or more samples of the reference batch in the second sequence and maps each sample of the reference batch in the second sequence to one or more samples of the batch in the first sequence; and
determining one or more representation samples based on the set of samples associated with the batch in the first sequence and the warping path, wherein each representation sample corresponds to a respective sample point associated with a sample in the reference batch and the one or more representation samples form the batch representation of the batch.

9. The method of claim 1, wherein performing the operation using the batch representation of the batch includes one or more of:
generating one or more principal component analysis (PCA) models of the industrial process using the batch representation of the batch; or
training one or more machine learning models using the batch representation of the batch.

10. The method of claim 1, wherein performing the operation using the batch representation of the batch includes one or more of:
determining an anomaly metric of the batch using the batch representation of the batch and a PCA model of the industrial process; or
providing the batch representation of the batch to a machine learning model as an input.

11. A method comprising:
receiving, by a batch analytic system, batch data of a batch generated in an industrial process, wherein the batch is ongoing and has a first batch length at a sample point during the batch, the batch data includes a set of samples associated with the batch at the sample point;
generating, by the batch analytic system based on the batch data of the batch and a reference batch that has a second batch length, a batch representation corresponding to the sample point of the batch using a first Dynamic Time Warping (DTW) matrix and a second DTW matrix, wherein
the second DTW matrix is determined based on the first DTW matrix, and
the batch representation corresponding to the sample point of the batch aligns with a batch portion of the reference batch and has a third batch length associated with the batch portion of the reference batch; and
performing, by the batch analytic system, an operation using the batch representation corresponding to the sample point of the batch.

12. The method of claim 11, wherein generating the batch representation corresponding to the sample point of the batch includes:
determining the first DTW matrix between a first sequence including the set of samples associated with the batch at the sample point and a second sequence including a set of samples associated with the reference batch, wherein the first sequence has the first batch length and the second sequence has the second batch length;
identifying one or more elements of the first DTW matrix that correspond to a respective sample associated with the sample point in the batch;
identifying a particular element of the first DTW matrix that has a lowest value among the one or more elements of the first DTW matrix;
determining a reference sample point during the reference batch that corresponds to the particular element of the first DTW matrix; and
determining the batch portion of the reference batch based on the reference sample point.

13. The method of claim 12, wherein:
the batch portion of the reference batch includes a set of samples associated with the reference batch at the reference sample point and has the third batch length.

14. The method of claim 12, wherein generating the batch representation corresponding to the sample point of the batch includes:
identifying a portion of the first DTW matrix that corresponds to the reference sample point; and
determining the second DTW matrix to be the portion of the first DTW matrix.

15. The method of claim 11, wherein generating the batch representation corresponding to the sample point of the batch includes:
determining a warping path between a first sequence including the set of samples associated with the batch at the sample point and a third sequence including the batch portion of the reference batch based on the second DTW matrix, wherein the warping path maps each sample of the batch in the first sequence to one or more samples of the batch portion of the reference batch in the third sequence and maps each sample of the batch portion of the reference batch in the third sequence to one or more samples of the batch in the first sequence; and
determining one or more representation samples based on the set of samples associated with the batch at the sample point in the first sequence and the warping path, wherein each representation sample corresponds to a respective sample point associated with a sample in the batch portion of the reference batch and the one or more representation samples form the batch representation corresponding to the sample point of the batch.

16. The method of claim 11, further comprising:
determining, by the batch analytic system based on the first DTW matrix, a different DTW matrix between a different sequence including a set of samples associated with the batch at a different sample point subsequent to the sample point and a second sequence including a set of samples associated with the reference batch; and
generating, by the batch analytic system, a batch representation corresponding to the different sample point of the batch using the different DTW matrix.

17. The method of claim 16, wherein determining the different DTW matrix includes:
including the first DTW matrix as a portion of the different DTW matrix;
identifying a sample of the batch that is included in the set of samples associated with the batch at the different sample point and is not included in the set of samples associated with the batch at the sample point;
computing one or more elements of the different DTW matrix that correspond to the identified sample of the batch based on the identified sample of the batch, the set of samples associated with the reference batch, and the portion of the different DTW matrix; and
updating the different DTW matrix to include the one or more elements corresponding to the identified sample of the batch in the different DTW matrix.

18. The method of claim 11, wherein performing the operation using the batch representation corresponding to the sample point of the batch includes:
determining an anomaly metric corresponding to the sample point of the batch using the batch representation corresponding to the sample point of the batch and a PCA model of the industrial process corresponding to a reference sample point.

19. A system comprising:
a memory storing instructions; and
a processor communicatively coupled to the memory and configured to execute the instructions to:
receive batch data of a batch generated in an industrial process, wherein the batch data includes a set of samples associated with the batch, the batch is complete and has a first batch length;
determine a reference batch based on a plurality of non-anomalous batches generated in the industrial process, wherein each non-anomalous batch has a same second batch length;
generate a batch representation of the batch based on the batch data of the batch and the reference batch, wherein the batch representation of the batch aligns with the reference batch and has the second batch length associated with the reference batch; and
perform an operation using the batch representation of the batch.

20. The system of claim 19, wherein determining the reference batch includes:
identifying, for each sample point, a plurality of samples corresponding to the sample point in the plurality of non-anomalous batches; and
determining a sample corresponding to the sample point for the reference batch based on the plurality of samples corresponding to the sample point in the plurality of non-anomalous batches.
